(19) United States
(12) Patent Application Publication
(10) Pub. No.: US 2023/0177610 A1
(43) Pub. Date: Jun. 8, 2023

(54) SYSTEM AND METHOD FOR INVESTMENT DATA MANAGEMENT

(71) Applicant: Cryptorama, Sheridan, WY (US)

(72) Inventor: Christian Figueroa Rivera, Manassas, VA (US)

(21) Appl. No.: 18/062,710

(22) Filed: Dec. 7, 2022

Related U.S. Application Data
(60) Provisional application No. 63/286,724, filed on Dec. 7, 2021.

(51) Int. Cl. G06Q 40/06

(52) U.S. Cl. CPC G06Q 40/06

(57) ABSTRACT

A system is disclosed. The system has an investment data module, comprising computer-executable code stored in non-volatile memory, a processor, and a user device, which are configured to receive an asset data of a user, the asset data including an identification of an investment asset, receive a time data of the user, the time data including a time period, receive an asset prediction data of the user, the asset prediction data including an asset prediction of whether the investment asset will increase in value or decrease in value between a start of the time period and an end of the time period, and receive an actual asset data including a first actual asset value of the investment asset at the start of the time period and a second actual asset value of the investment asset at the end of the time period.

### CROSS-REFERENCE TO RELATED APPLICATIONS

This application claims priority to provisional application 63/286,724 filed Dec. 7, 2021, the entire disclosure of which is incorporated herein by reference.

### TECHNICAL FIELD

The present disclosure is directed to a system and method for data management, and more particularly, to a system and method for investment data management.

### BACKGROUND OF THE DISCLOSURE

The eTrade investment community, though large, is primarily decentralized. Information relevant to the entry and/or exit of financial decisions related to eTrade investments is spread out in various sources, or hidden or siloed within a variety of social networks, forums, news articles, and chat applications, making it extremely difficult to make investment decisions within a reasonable amount of time. Based on conventional techniques, retail investors use dozens of these sources and typically miss opportunities. Promising investors who have yet to invest are typically overwhelmed due to the massive amount of information of conventional systems, and are unable to manage the information.

The exemplary disclosed system and method of the present disclosure is directed to overcoming one or more of the shortcomings set forth above and/or other deficiencies in existing technology.

### SUMMARY OF THE DISCLOSURE

In one exemplary aspect, the present disclosure is directed to a system. The system includes an investment data module, comprising computer-executable code stored in non-volatile memory, a processor, and a user device. The investment data module, the processor, and the user device are configured to receive an asset data of a user, the asset data including an identification of an investment asset, receive a time data of the user, the time data including a time period, receive an asset prediction data of the user, the asset prediction data including an asset prediction of whether the investment asset will increase in value or decrease in value between a start of the time period and an end of the time period, receive an actual asset data including a first actual asset value of the investment asset at the start of the time period and a second actual asset value of the investment asset at the end of the time period, and determine and assign a performance data to the user based on comparing the asset prediction data and the actual asset data.

In another aspect, the present disclosure is directed to a method. The method includes receiving an asset data of a user, the asset data including an identification of an investment asset, receiving a time data of the user, the time data including a time period, receiving an asset prediction data of the user, the asset prediction data including an asset prediction of whether the investment asset will increase in value or decrease in value between a start of the time period and an end of the time period, receiving an actual asset data including a first actual asset value of the investment asset at the start of the time period and a second actual asset value of the investment asset at the end of the time period, and determining and assigning a performance data to the user based on comparing the asset prediction data and the actual asset data.

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still within the spirit of the disclosure as described herein.

FIG. 1A illustrates an exemplary system of at least some exemplary embodiments of the present disclosure;

FIG. 1B illustrates an exemplary system of at least some exemplary embodiments of the present disclosure;

FIG. 2 illustrates an exemplary system diagram of at least some exemplary embodiments of the present disclosure;

FIG. 3 illustrates an exemplary graphical user interface of at least some exemplary embodiments of the present disclosure;

FIG. 4 illustrates an exemplary graphical user interface of at least some exemplary embodiments of the present disclosure;

FIG. 5 illustrates an exemplary graphical user interface of at least some exemplary embodiments of the present disclosure;

FIG. 6 illustrates an exemplary graphical user interface of at least some exemplary embodiments of the present disclosure;

FIG. 7 illustrates an exemplary graphical user interface of at least some exemplary embodiments of the present disclosure;

FIG. 8 illustrates an exemplary graphical user interface of at least some exemplary embodiments of the present disclosure;

FIG. 9 illustrates an exemplary graphical user interface of at least some exemplary embodiments of the present disclosure;

FIG. 10 illustrates an exemplary graphical user interface of at least some exemplary embodiments of the present disclosure;

FIG. 11 illustrates schematic view of at least some exemplary embodiments of the present disclosure;

FIG. 12 illustrates an exemplary graphical user interface of at least some exemplary embodiments of the present disclosure;

FIG. 13 illustrates an exemplary graphical user interface of at least some exemplary embodiments of the present disclosure;

FIG. 14 illustrates an exemplary graphical user interface of at least some exemplary embodiments of the present disclosure;

FIG. 15 illustrates an exemplary graphical user interface of at least some exemplary embodiments of the present disclosure;

FIG. 16 illustrates an exemplary graphical user interface of at least some exemplary embodiments of the present disclosure;

FIG. 17 illustrates an exemplary graphical user interface of at least some exemplary embodiments of the present disclosure;

FIG. 18 illustrates an exemplary graphical user interface of at least some exemplary embodiments of the present disclosure;

FIG. 19 illustrates a schematic view of at least some exemplary embodiments of the present disclosure;

FIG. 20 illustrates a schematic view of at least some exemplary embodiments of the present disclosure;

FIG. 21 illustrates a schematic view of at least some exemplary embodiments of the present disclosure;

FIG. 22 illustrates a schematic view of at least some exemplary embodiments of the present disclosure;

FIG. 23 illustrates a schematic view of at least some exemplary embodiments of the present disclosure;

FIG. 24 illustrates a schematic view of at least some exemplary embodiments of the present disclosure;

FIG. 25 illustrates a schematic view of at least some exemplary embodiments of the present disclosure;

FIG. 26 illustrates a schematic view of at least some exemplary embodiments of the present disclosure;

FIG. 27 illustrates a schematic view of at least some exemplary embodiments of the present disclosure;

FIG. 28 illustrates a schematic view of at least some exemplary embodiments of the present disclosure;

FIG. 29 illustrates a schematic view of at least some exemplary embodiments of the present disclosure;

FIG. 30 illustrates an exemplary graphical user interface of at least some exemplary embodiments of the present disclosure;

FIG. 31 illustrates an exemplary graphical user interface of at least some exemplary embodiments of the present disclosure;

FIG. 32 illustrates an exemplary graphical user interface of at least some exemplary embodiments of the present disclosure;

FIG. 33 illustrates an exemplary graphical user interface of at least some exemplary embodiments of the present disclosure;

FIG. 34 illustrates an exemplary graphical user interface of at least some exemplary embodiments of the present disclosure;

FIG. 35 illustrates an exemplary graphical user interface of at least some exemplary embodiments of the present disclosure;

FIG. 36 illustrates an exemplary graphical user interface of at least some exemplary embodiments of the present disclosure;

FIG. 37 illustrates an exemplary graphical user interface of at least some exemplary embodiments of the present disclosure;

FIG. 38 illustrates an exemplary graphical user interface of at least some exemplary embodiments of the present disclosure;

FIG. 39 illustrates an exemplary graphical user interface of at least some exemplary embodiments of the present disclosure;

FIG. 40 illustrates an exemplary graphical user interface of at least some exemplary embodiments of the present disclosure;

FIG. 41 illustrates an exemplary graphical user interface of at least some exemplary embodiments of the present disclosure;

FIG. 42 illustrates an exemplary graphical user interface of at least some exemplary embodiments of the present disclosure;

FIG. 43 illustrates an exemplary graphical user interface of at least some exemplary embodiments of the present disclosure;

FIG. 44 illustrates an exemplary graphical user interface of at least some exemplary embodiments of the present disclosure;

FIG. 45 illustrates an exemplary graphical user interface of at least some exemplary embodiments of the present disclosure;

FIG. 46 illustrates an exemplary graphical user interface of at least some exemplary embodiments of the present disclosure;

FIG. 47 illustrates an exemplary graphical user interface of at least some exemplary embodiments of the present disclosure;

FIG. 48 illustrates an exemplary graphical user interface of at least some exemplary embodiments of the present disclosure;

FIG. 49 illustrates an exemplary graphical user interface of at least some exemplary embodiments of the present disclosure;

FIG. 50 illustrates an exemplary graphical user interface of at least some exemplary embodiments of the present disclosure;

FIG. 51 illustrates an exemplary graphical user interface of at least some exemplary embodiments of the present disclosure;

FIG. 52 illustrates an exemplary graphical user interface of at least some exemplary embodiments of the present disclosure;

FIG. 53 illustrates an exemplary graphical user interface of at least some exemplary embodiments of the present disclosure;

FIG. 54 illustrates an exemplary graphical user interface of at least some exemplary embodiments of the present disclosure;

FIG. 55 illustrates an exemplary graphical user interface of at least some exemplary embodiments of the present disclosure;

FIG. 56 illustrates an exemplary graphical user interface of at least some exemplary embodiments of the present disclosure;

FIG. 57 illustrates an exemplary graphical user interface of at least some exemplary embodiments of the present disclosure;

FIG. 58 illustrates an exemplary graphical user interface of at least some exemplary embodiments of the present disclosure;

FIG. 59 illustrates a schematic view of at least some exemplary embodiments of the present disclosure;

FIG. 60 illustrates a schematic view of at least some exemplary embodiments of the present disclosure;

FIG. 61 illustrates a schematic view of at least some exemplary embodiments of the present disclosure;

FIG. 62A illustrates an exemplary graphical user interface of at least some exemplary embodiments of the present disclosure;

FIG. 62B illustrates an exemplary graphical user interface of at least some exemplary embodiments of the present disclosure;

FIG. 63 illustrates a schematic view of at least some exemplary embodiments of the present disclosure;

FIG. 64 illustrates an exemplary graphical user interface of at least some exemplary embodiments of the present disclosure;

FIG. 65 illustrates an exemplary graphical user interface of at least some exemplary embodiments of the present disclosure;

FIG. 66 illustrates an exemplary graphical user interface of at least some exemplary embodiments of the present disclosure;

FIG. 67 illustrates an exemplary graphical user interface of at least some exemplary embodiments of the present disclosure;

FIG. 68 illustrates an exemplary graphical user interface of at least some exemplary embodiments of the present disclosure;

FIG. 69 illustrates an exemplary graphical user interface of at least some exemplary embodiments of the present disclosure;

FIG. 70A illustrates an exemplary graphical user interface of at least some exemplary embodiments of the present disclosure;

FIG. 70B illustrates an exemplary graphical user interface of at least some exemplary embodiments of the present disclosure;

FIG. 71 is a schematic illustration of an exemplary computing device, in accordance with at least some exemplary embodiments of the present disclosure;

FIG. 72 is a schematic illustration of an exemplary network, in accordance with at least some exemplary embodiments of the present disclosure; and

FIG. 73 is a schematic illustration of an exemplary network, in accordance with at least some exemplary embodiments of the present disclosure.

### DETAILED DESCRIPTION AND INDUSTRIAL APPLICABILITY

The exemplary disclosed system and method may include a Social Media Network (e.g., Cryptorama CryptoChat) that may be designed as a WebApp (e.g., Web/Android/iOS) that allows users (e.g., retail investors or those interested in investing) within an eTrade Market to share experiences. Sharing experiences may include increasing trending popularity of an eTrading investment of the user's choice while facilitating (e.g., off-platform) performed transitions of digital assets tied to the user's own social media functions (e.g., interactions). The exemplary disclosed system may, via these interactions and data collection, provide for feeding users content that may be relevant to a price and/or value of eTrade investments.

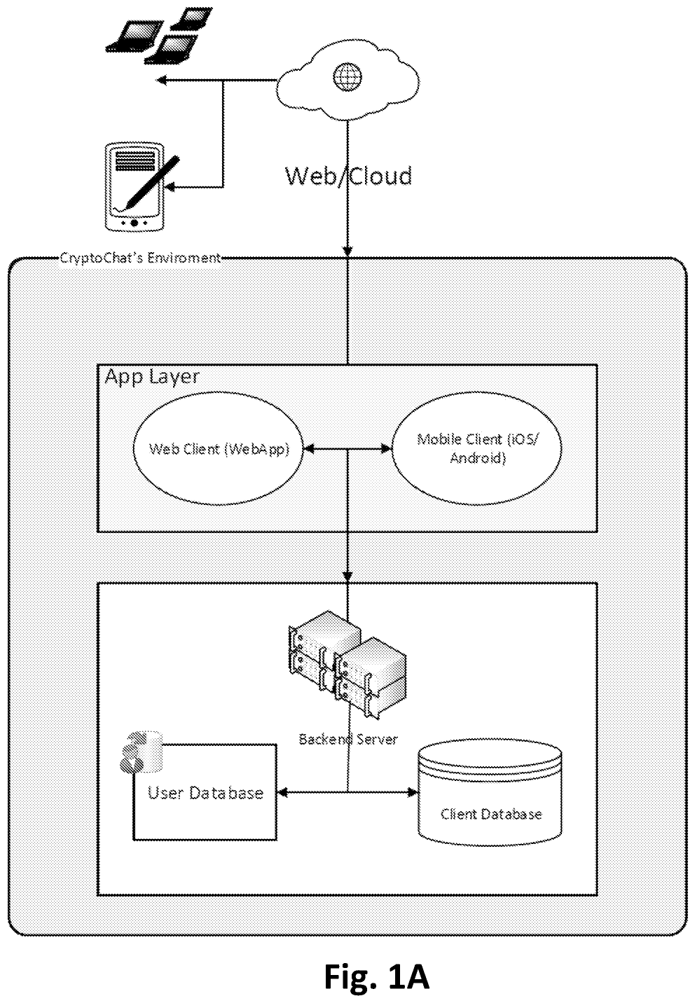

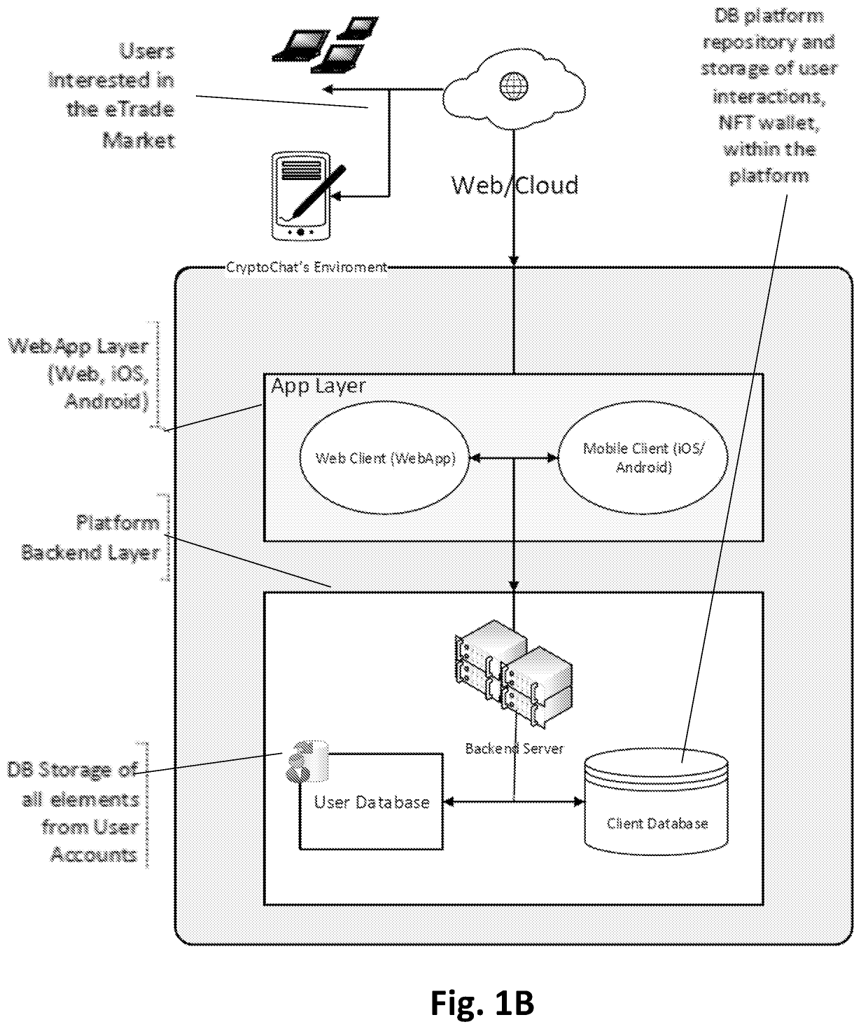

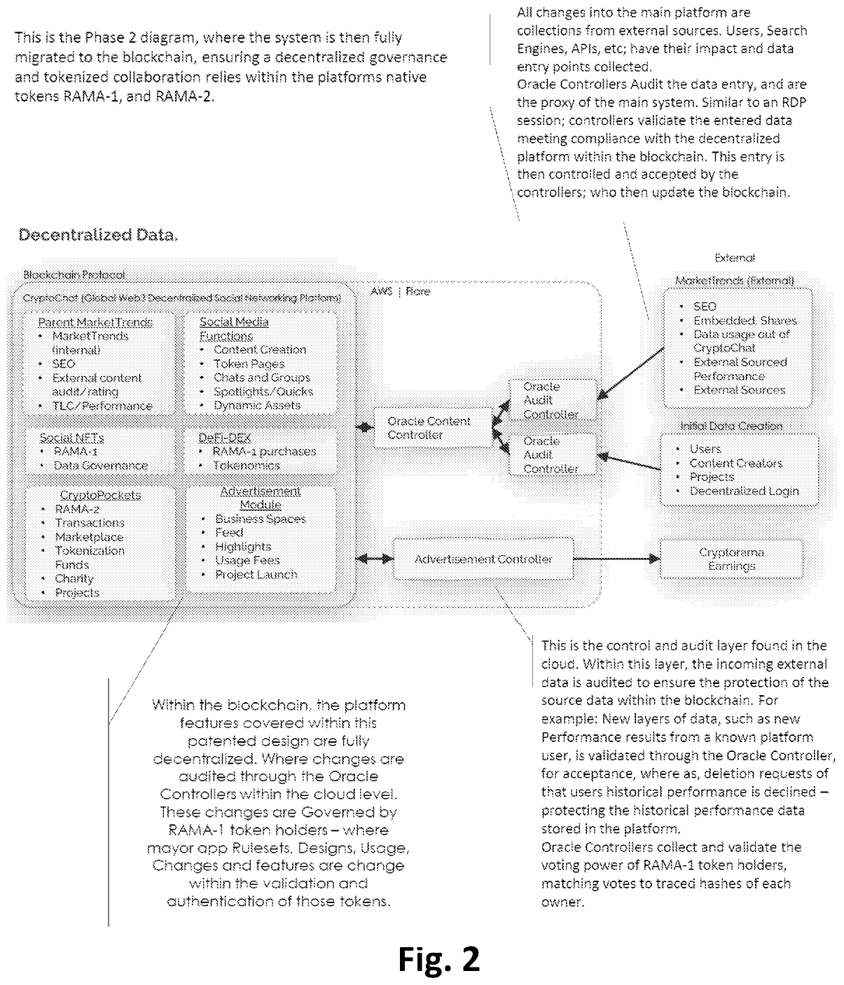

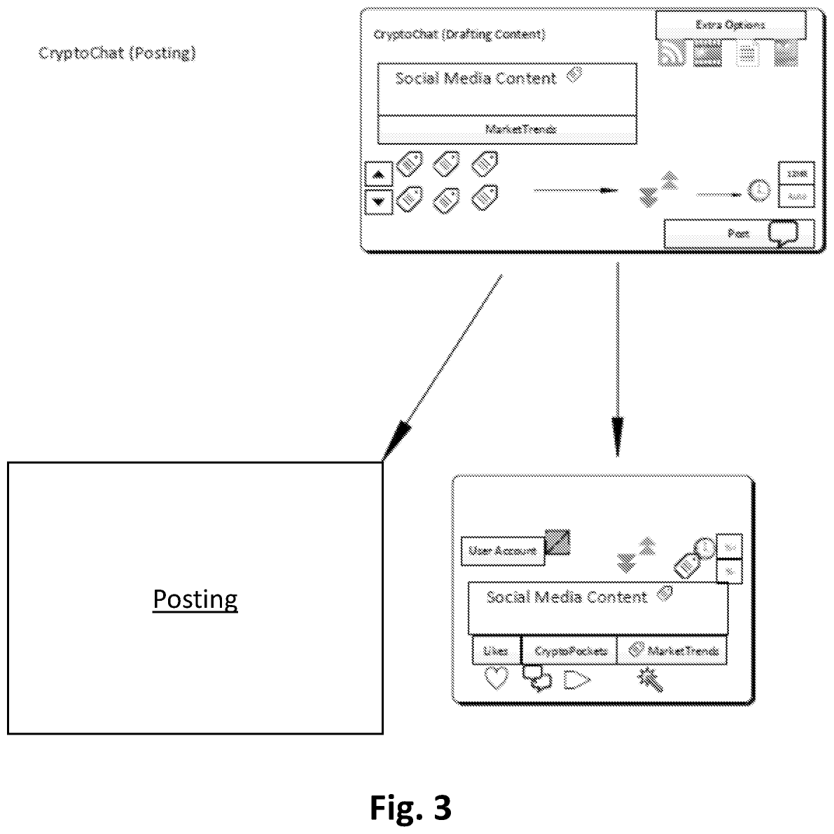

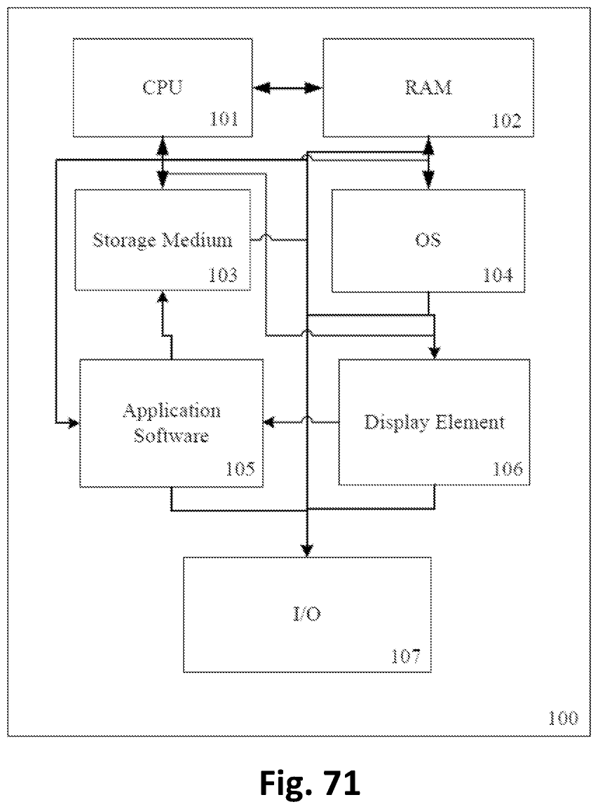

FIGS. 1A, 1B, 2, and 3 illustrate an exemplary system and graphical user interface of the exemplary disclosed system and method. The exemplary disclosed system and method may be operated using components similar to as described herein regarding FIGS. 71-73.

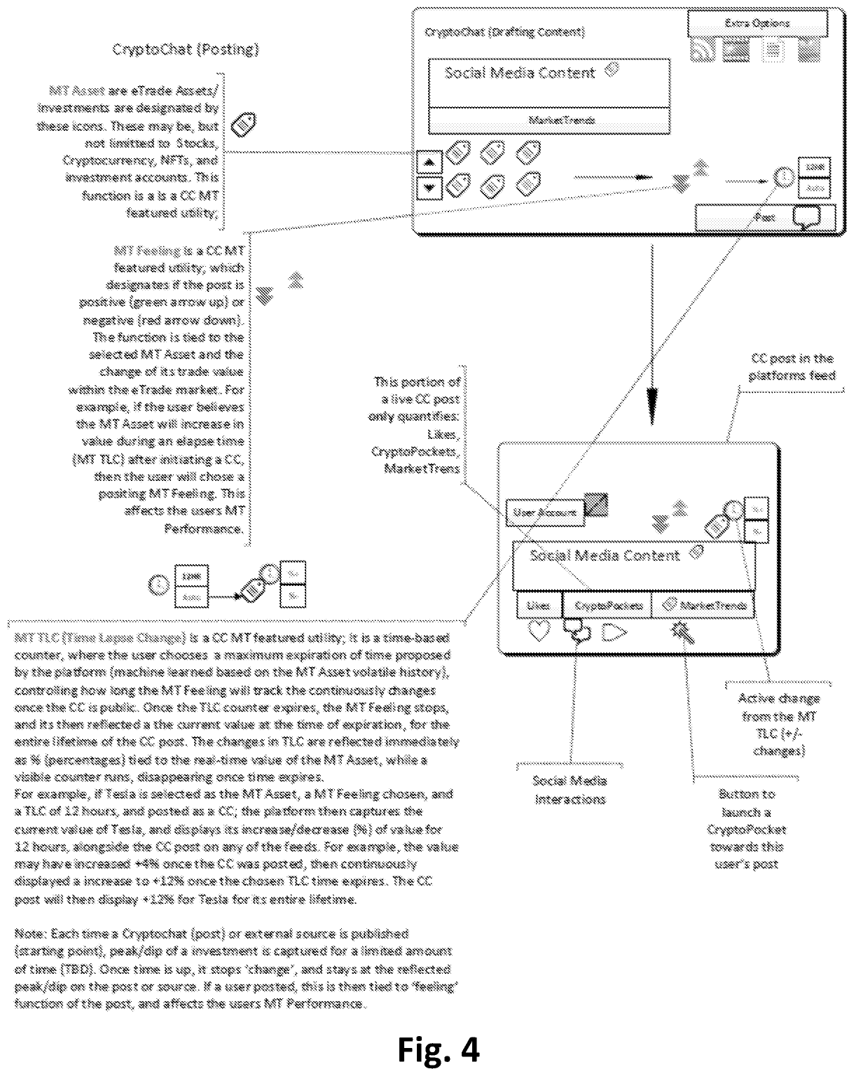

FIG. 4 illustrates an exemplary disclosed embodiment of the exemplary disclosed system and method. The exemplary disclosed embodiment may include a Time Lapse Change (TLC) feature (e.g., a CC MT featured utility, such as a CryptoChat MarketTrend featured utility). The feature may include a time-based counter, by which the user may choose a maximum expiration of time proposed by the platform (e.g., machine-learned based on the MT Asset volatile history), which may control how long the system (e.g., the TLC) may track the continuous changes once the system is publicly available. Once the TLC counter expires, the feature (e.g., the TLC) may stop, and may then be reflected as the current value at the time of expiration, for the entire lifetime of a post (e.g., a social media post). In at least some exemplary embodiments, MT TLC may provide an entire tracking function of the exemplary disclosed system, from both a time and price change perspective. For example, a user may provide a selection an asset data including an identification of an investment asset using the exemplary disclosed platform. A user may also provide a time period for example as described herein (e.g., associated with the exemplary disclosed TLC feature) using the exemplary disclosed platform. The user may also provide an asset prediction data including an asset prediction of whether the investment asset will increase in value or decrease in value between a start of the time period and an end of the time period using the exemplary disclosed platform. A user's choice of an MT Feeling may be tied to a result of the MT TLC, which may lead to a result in MT Performance. The changes in TLC may be reflected immediately as percentages tied to a real-time value of an asset (e.g., an MT Asset), while a visible counter runs (e.g., disappearing once time expires). For example, real-time or near real-time values of the assets may include actual asset data including a first actual asset value of an investment asset at a start of a time period and a second actual asset value of the investment asset at the end of the time period. For example, if given content is selected as the MT Asset, an MT Feeling may be chosen by the user and/or the system, and a TLC of 12 hours (e.g., or any other desired time period) may for example be selected (e.g., and posted). The platform may then capture the current value of the given content, and may display the content (e.g., its increase/decrease as a percentage of value for 12 hours, alongside a post on any suitable feed). For example, the value may increase +4% once the content was posted, then continuously display an increase to +12% (e.g., or any other suitable amount) once the chosen TLC time expires. The post may then display +12% (e.g., or any other suitable amount) for the given content for its entire lifetime. In at least some exemplary embodiments, each time a post (e.g., Cryptochat) or external source is published (e.g., as a starting point), a peak or dip of an investment tied to a TLC may be captured for a suitable amount of time. Once the time period ends, the reflected peak or dip may be maintained on the post or source. If a user posted, this may then be tied to the ‘feeling’ function of the post for example as illustrated in FIG. 4, and may affect the user's performance (e.g., MT Performance as illustrated in FIG. 4).

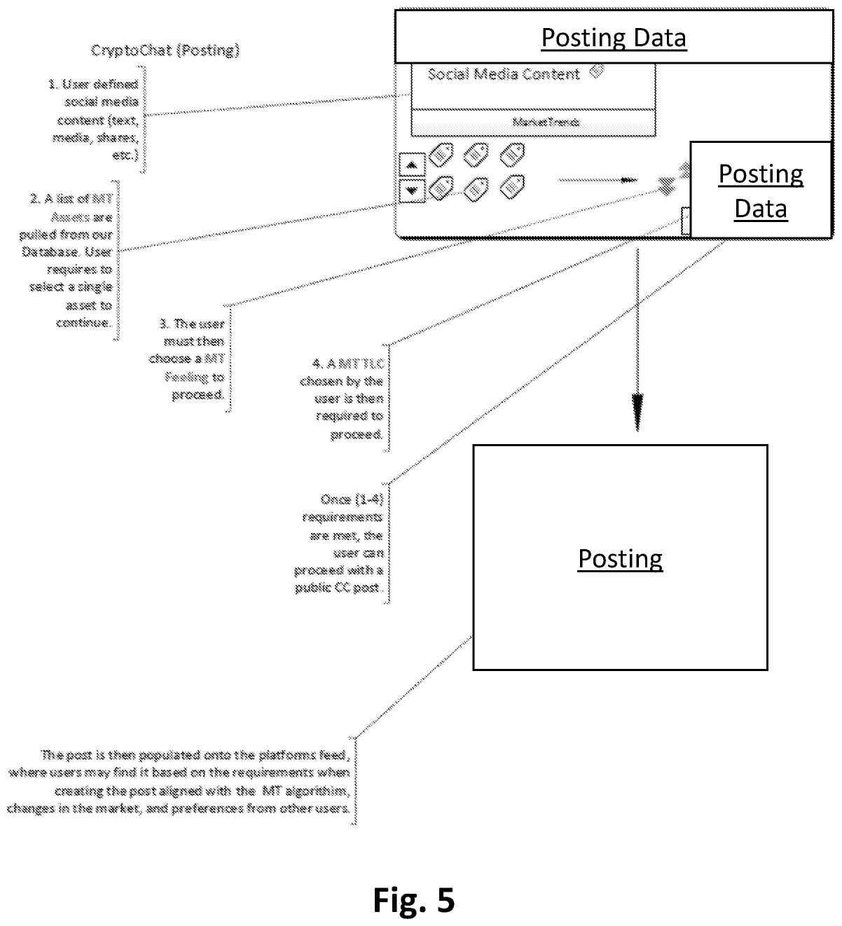

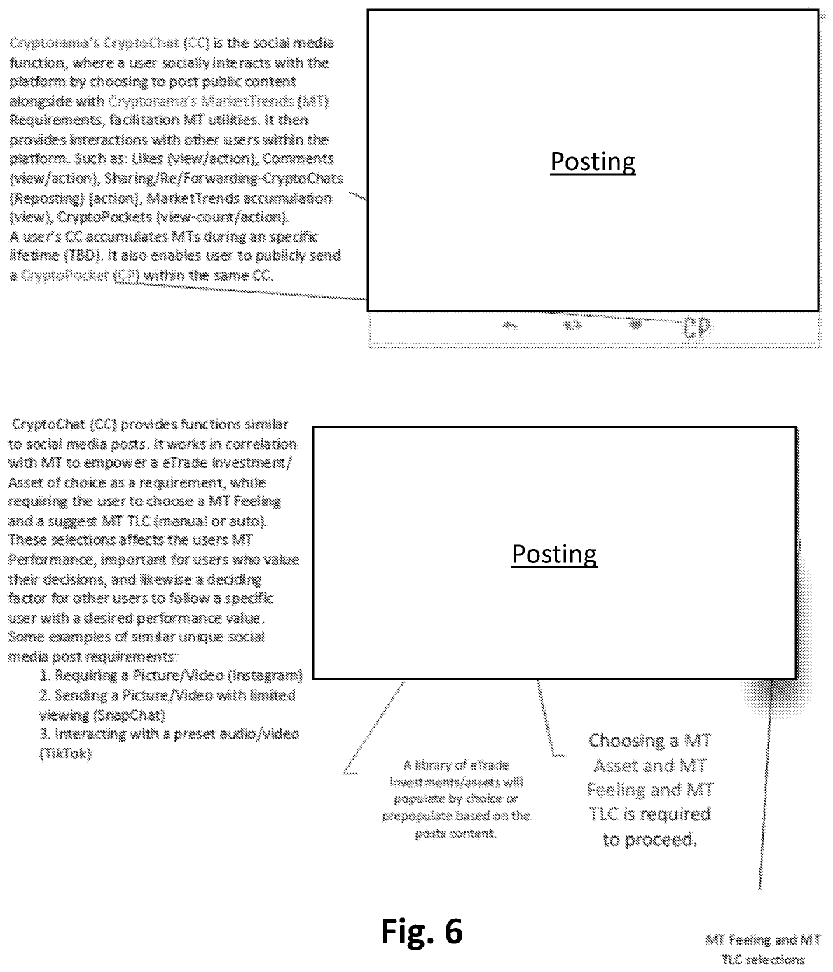

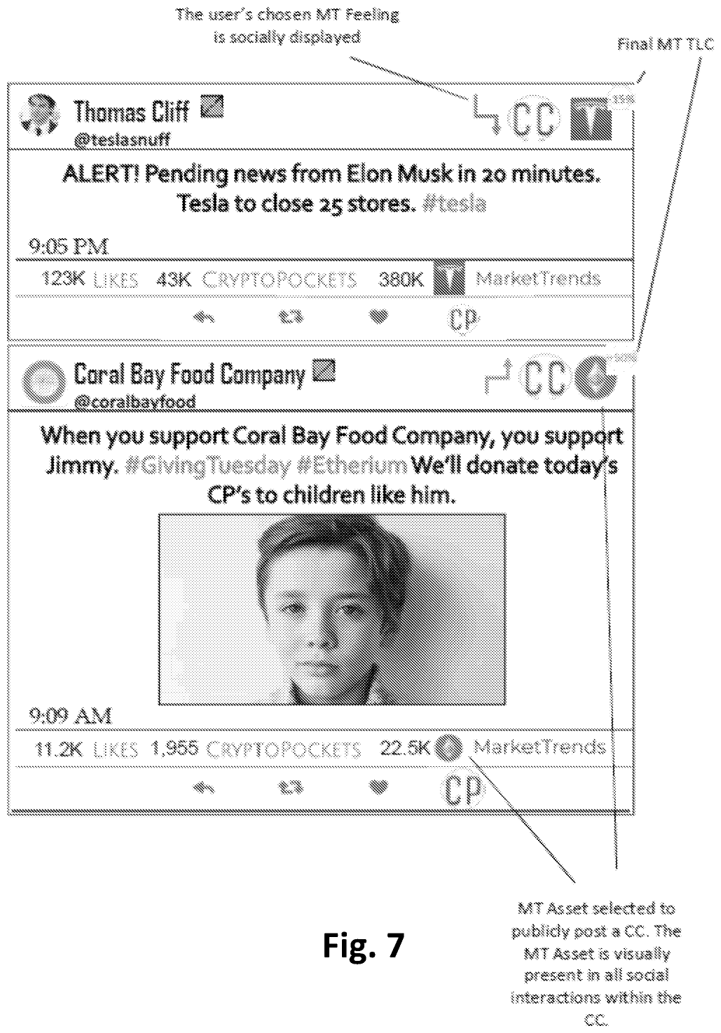

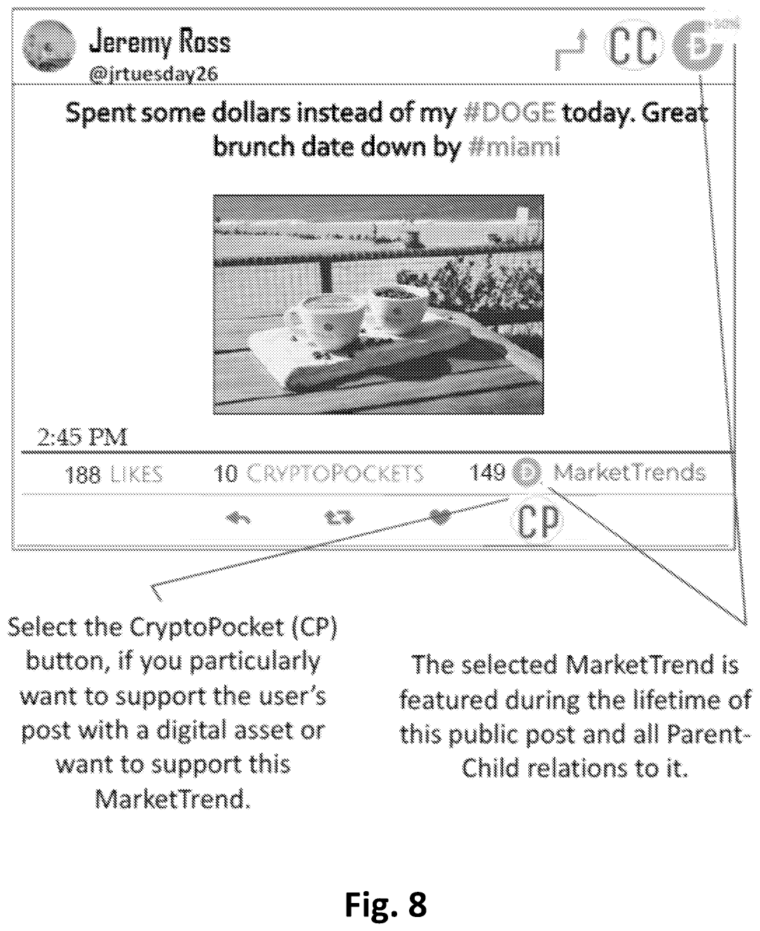

FIGS. 5-8 illustrate additional embodiments of the exemplary disclosed system and method including, for example, posting and market trend (e.g., CryptoPocket) features.

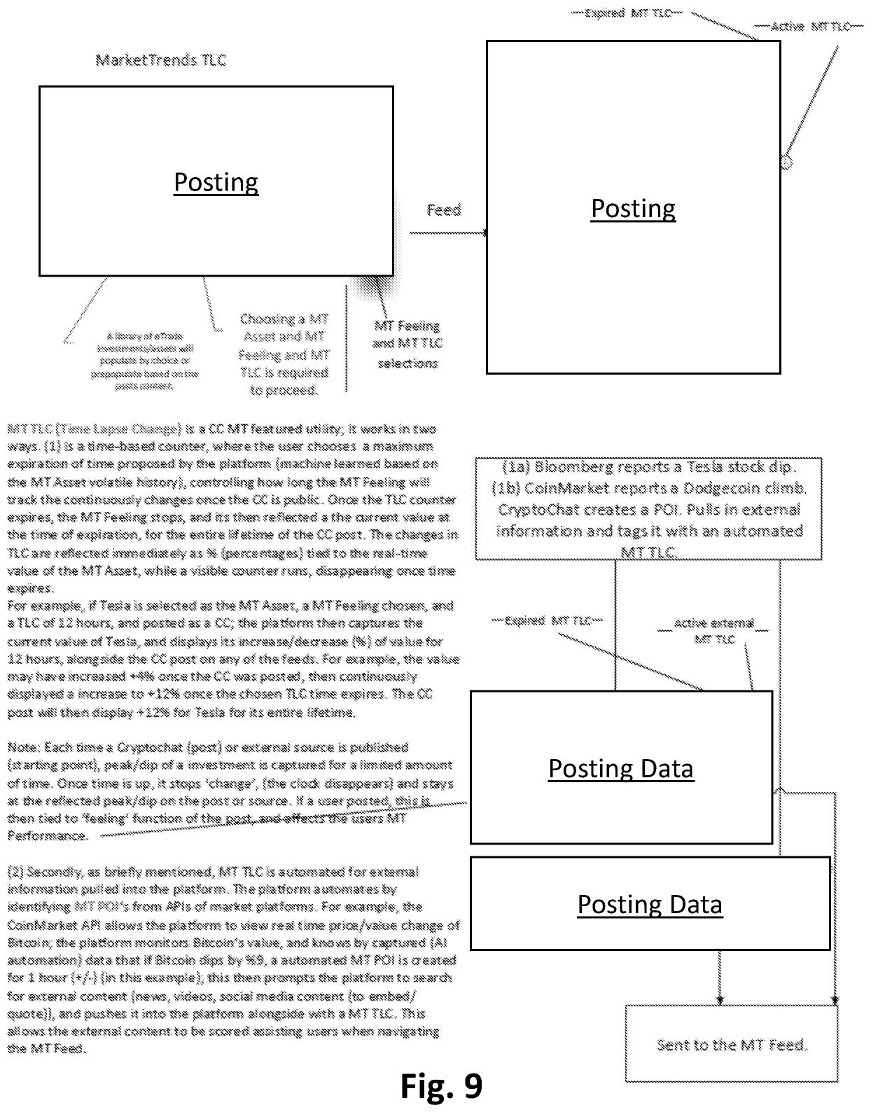

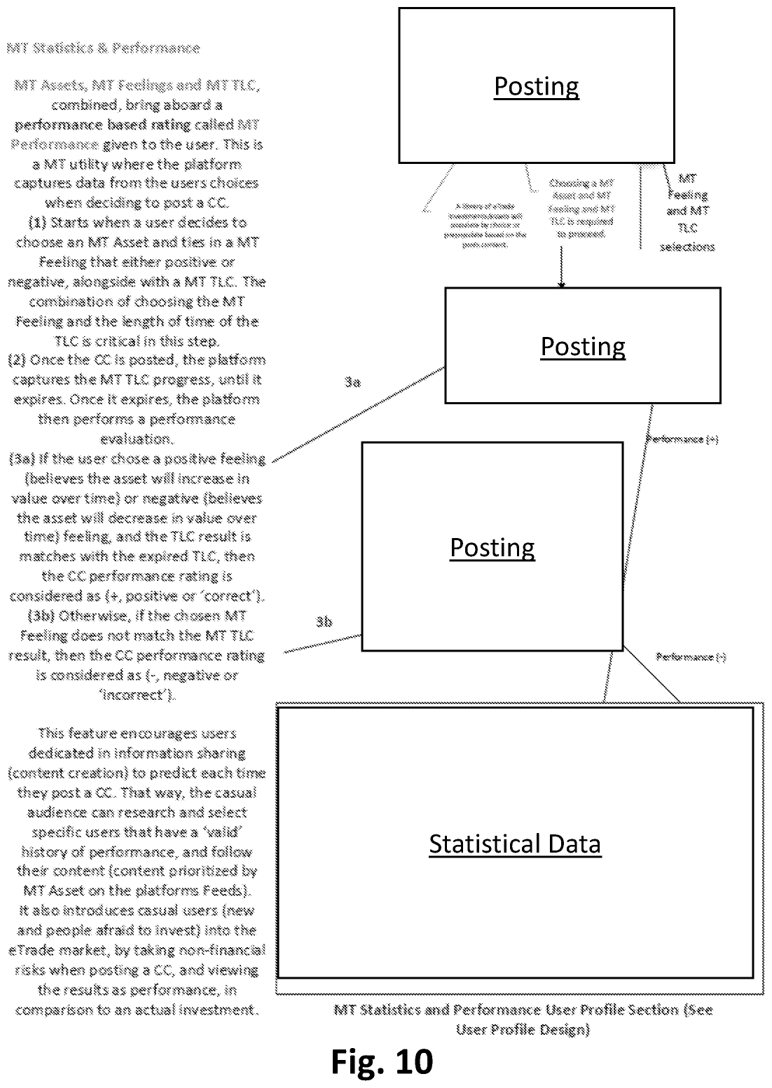

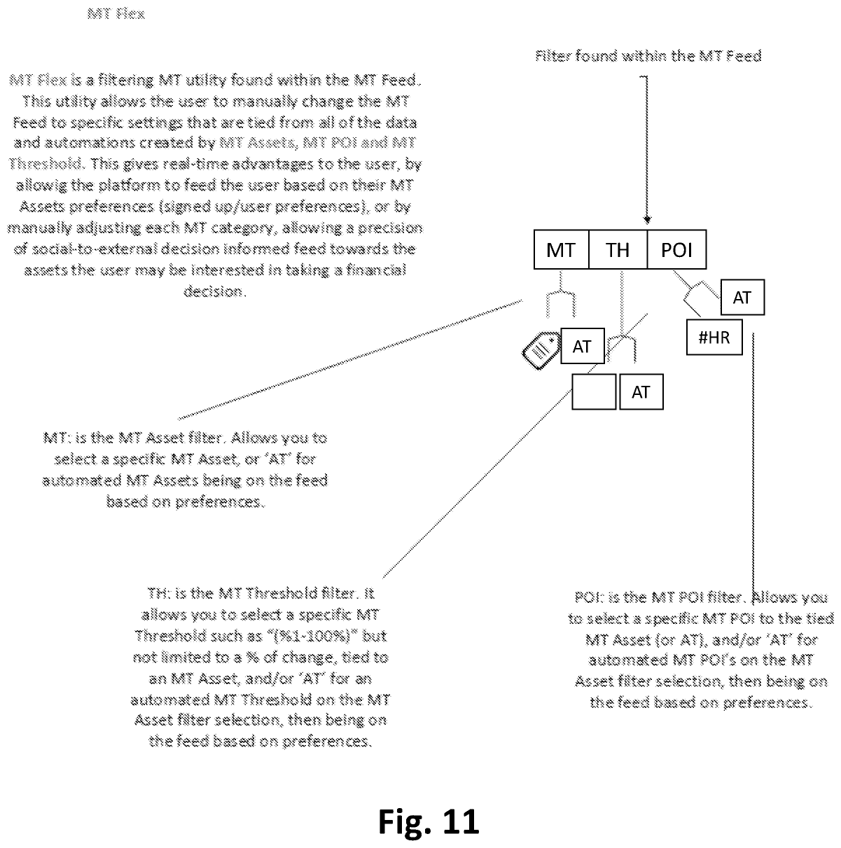

FIG. 9 illustrates another exemplary disclosed embodiment of the exemplary disclosed system and method. The exemplary disclosed time lapse change feature (e.g., MT TLC) may provide for external information to be pulled into the system. The system may identify MT POIs from APIs of market platforms. For example, a CoinMarketCap API may allow the system to receive data of real time price and value change of Bitcoin. For example, the system may monitor Bitcoin's value, and may determine by captured data (e.g., via AI and machine learning) that if Bitcoin dips by a certain threshold (e.g., 9% or any other suitable value) an MT POI may be created for any suitable time period (e.g., about an hour). The system may be prompted to search for external content (news, videos, and/or social media content, for example to embed or quote), and may push the content into the graphical user interface with a TLC. This process may allow the external content to be evaluated (e.g., scored), which may assist users when navigating the exemplary disclosed feed (e.g., MT Feed). FIGS. 10 and 11 illustrate additional exemplary embodiments regarding statistical performance and filtering.

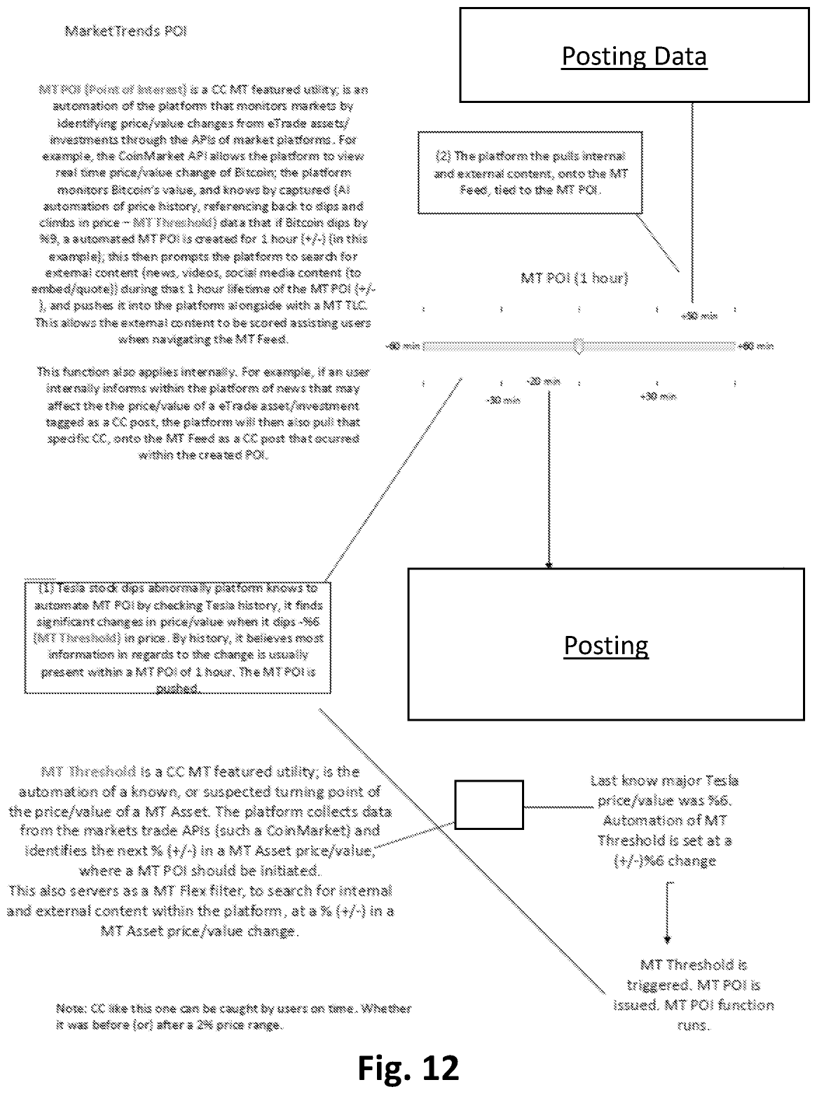

FIG. 12 illustrates another exemplary disclosed embodiment of the exemplary disclosed system and method. The exemplary disclosed embodiment may include a Point of Interest (POI) feature or utility. The exemplary disclosed system may monitor markets via the POI by identifying price and/or value changes from eTrade assets and/or investments through the APIs of market platforms. For example, the CoinMarketCap API may allow the system to view real time price and/or value change of Bitcoin for example as described herein. The exemplary disclosed function may also be applied internally to the system. For example, if a user internally informs within the system's platform of news that may affect the price and/or value of an eTrade asset and/or investment tagged as a post, the system may then also pull that specific post (e.g., onto the MT Feed as a CC post that occurred within the created POI).

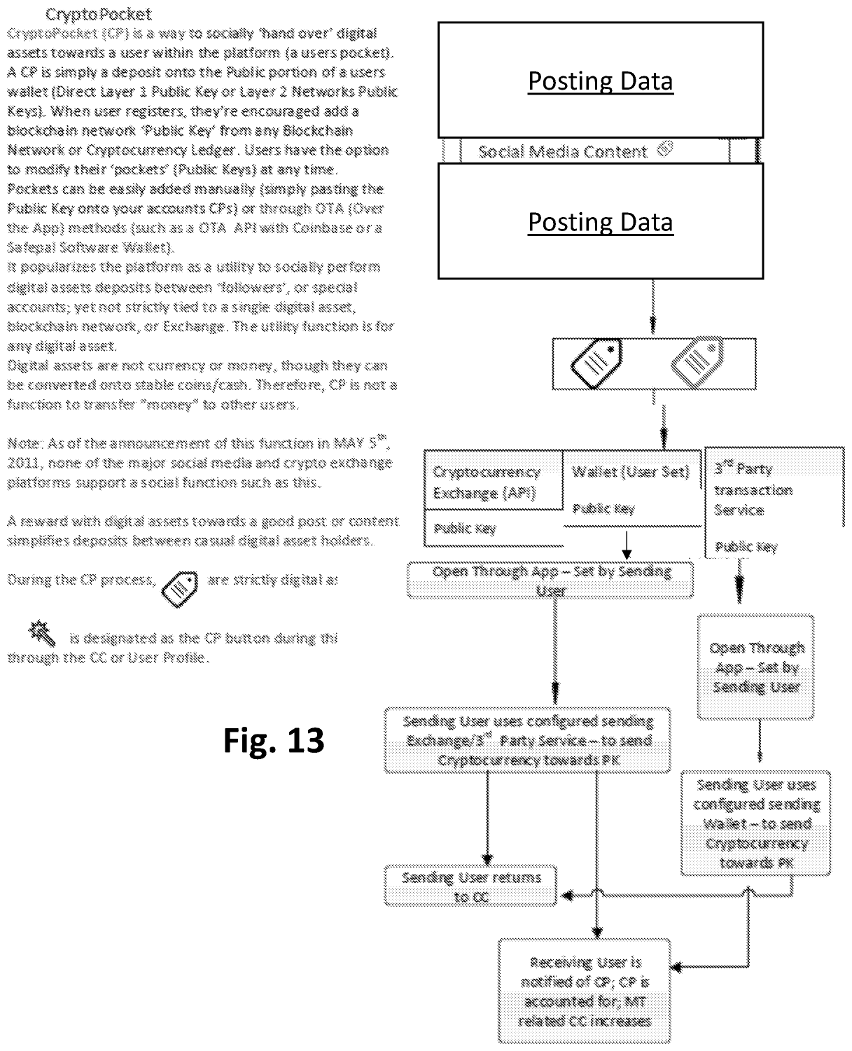

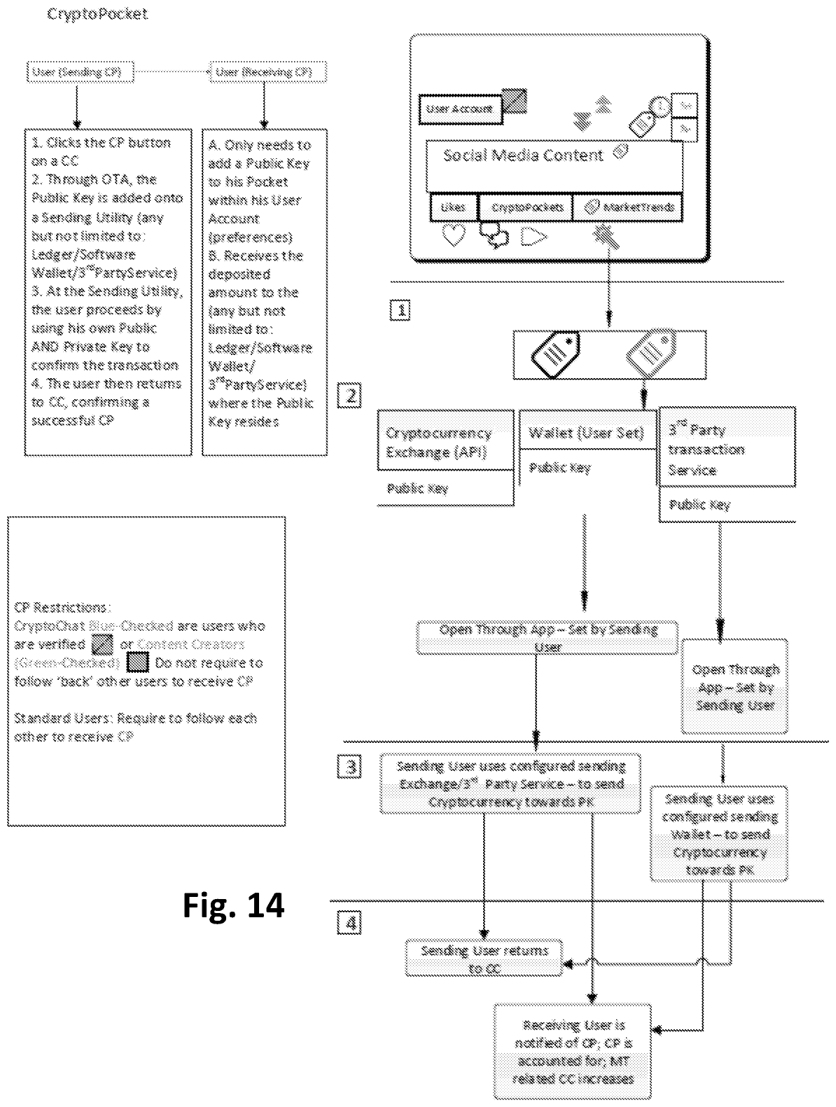

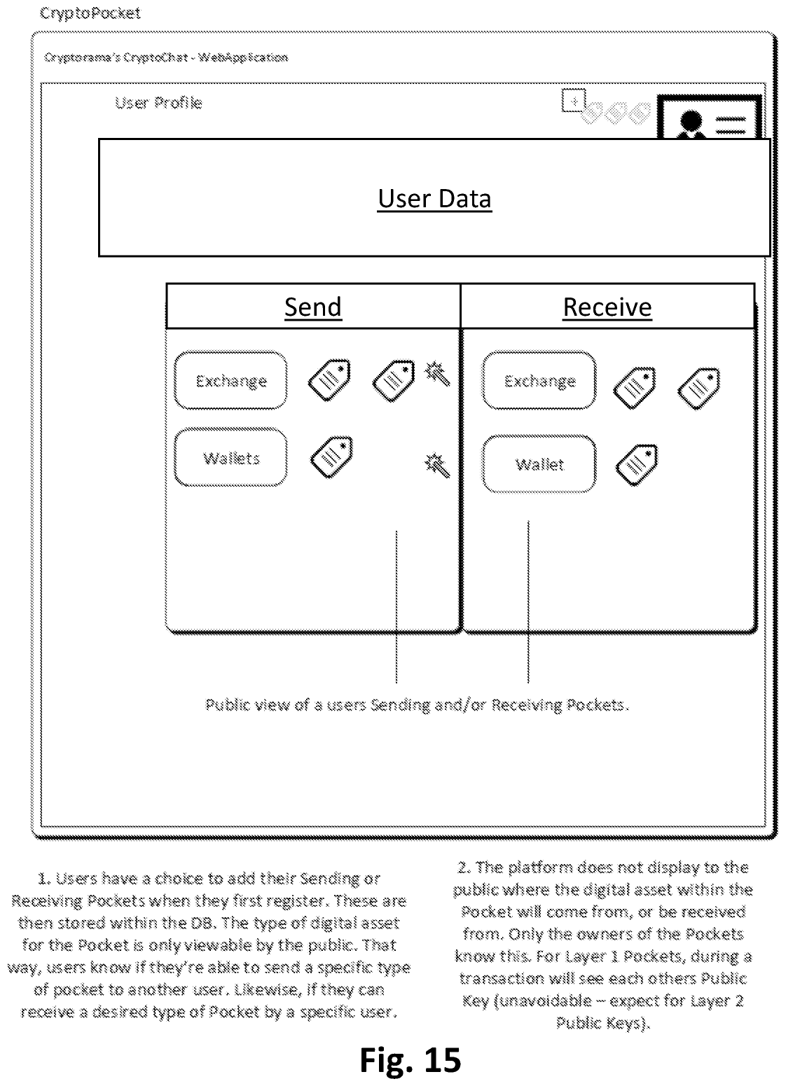

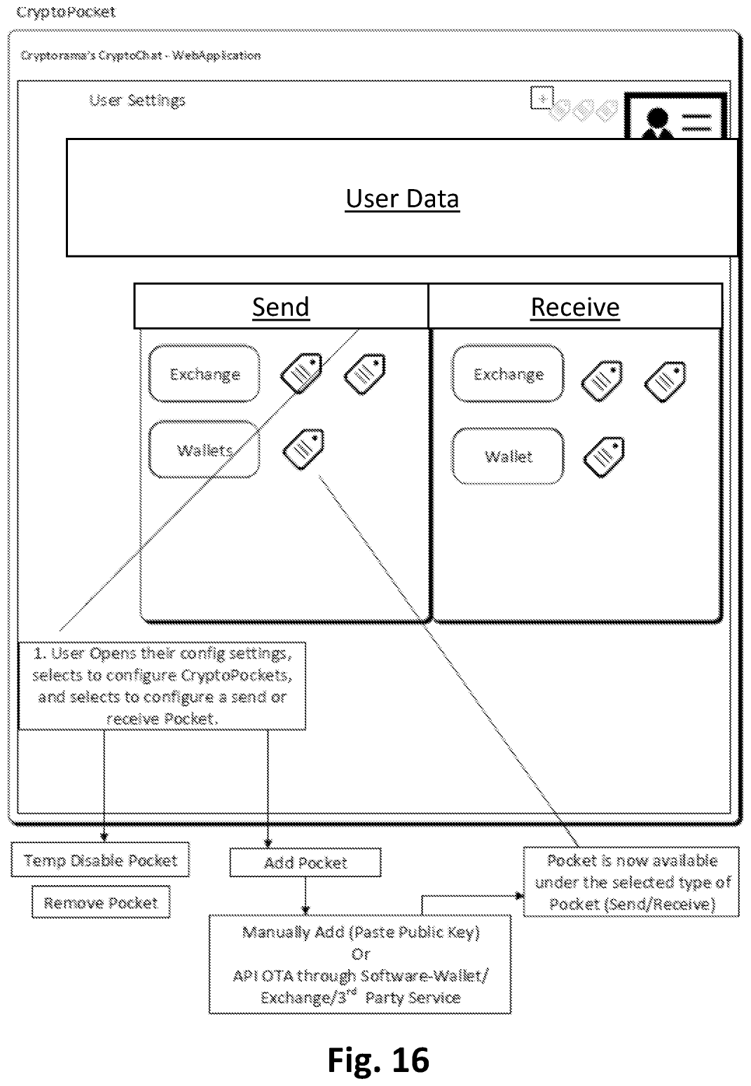

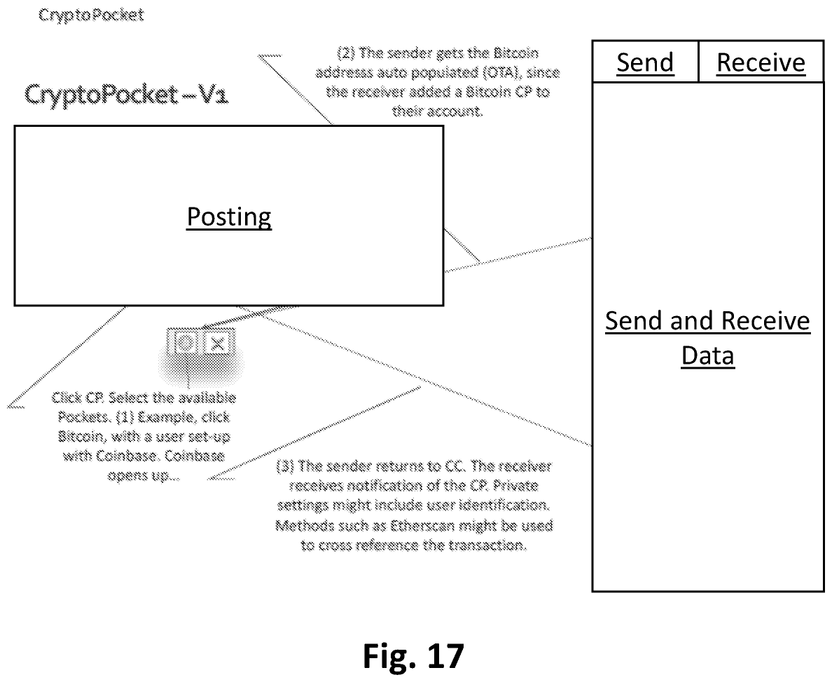

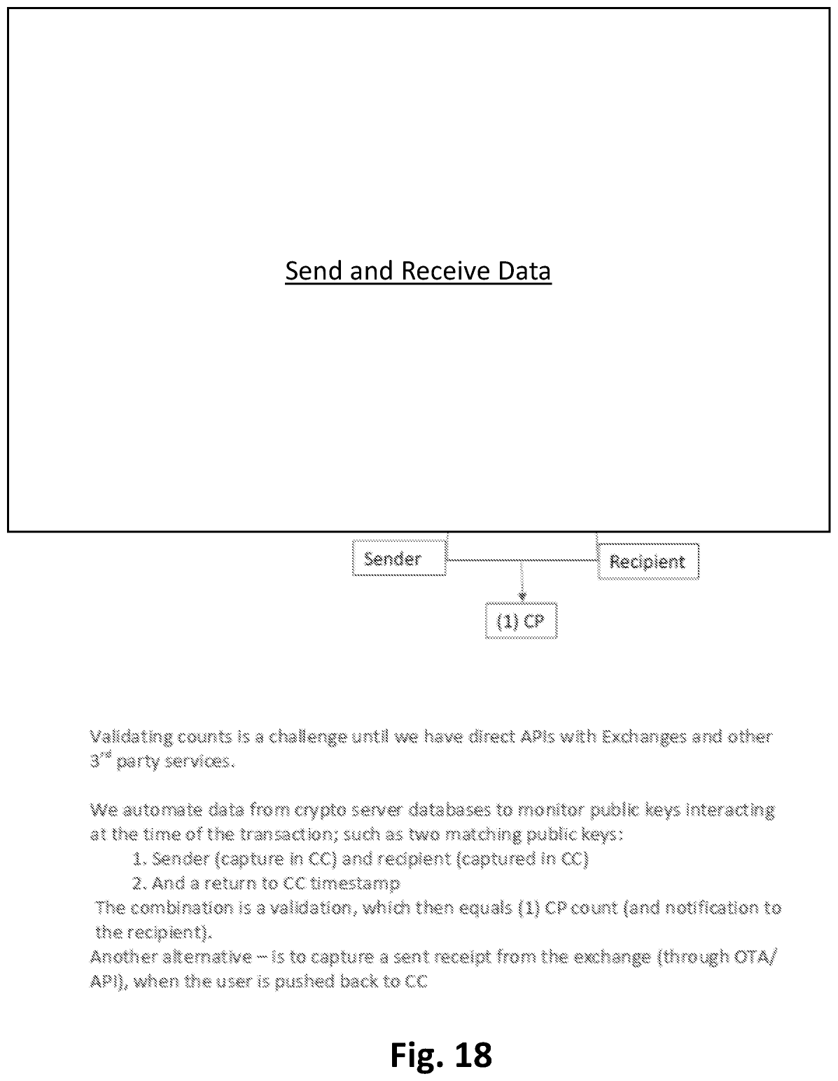

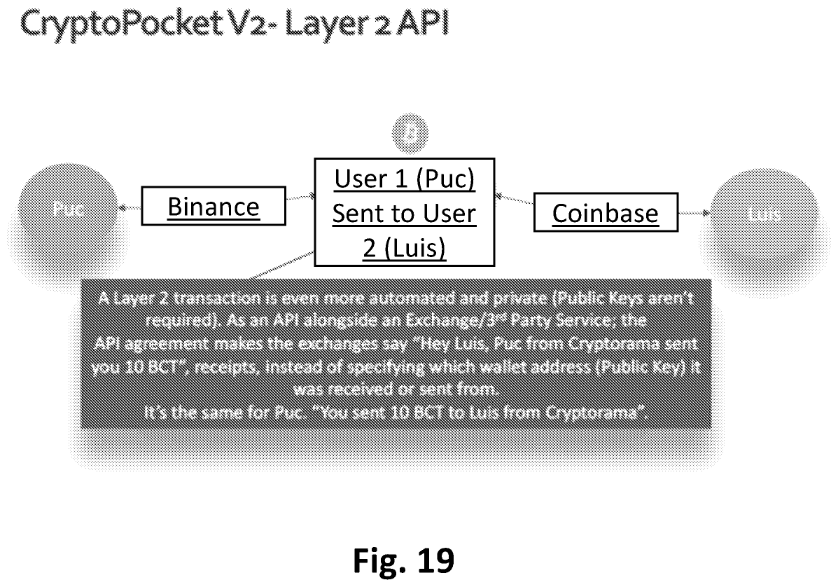

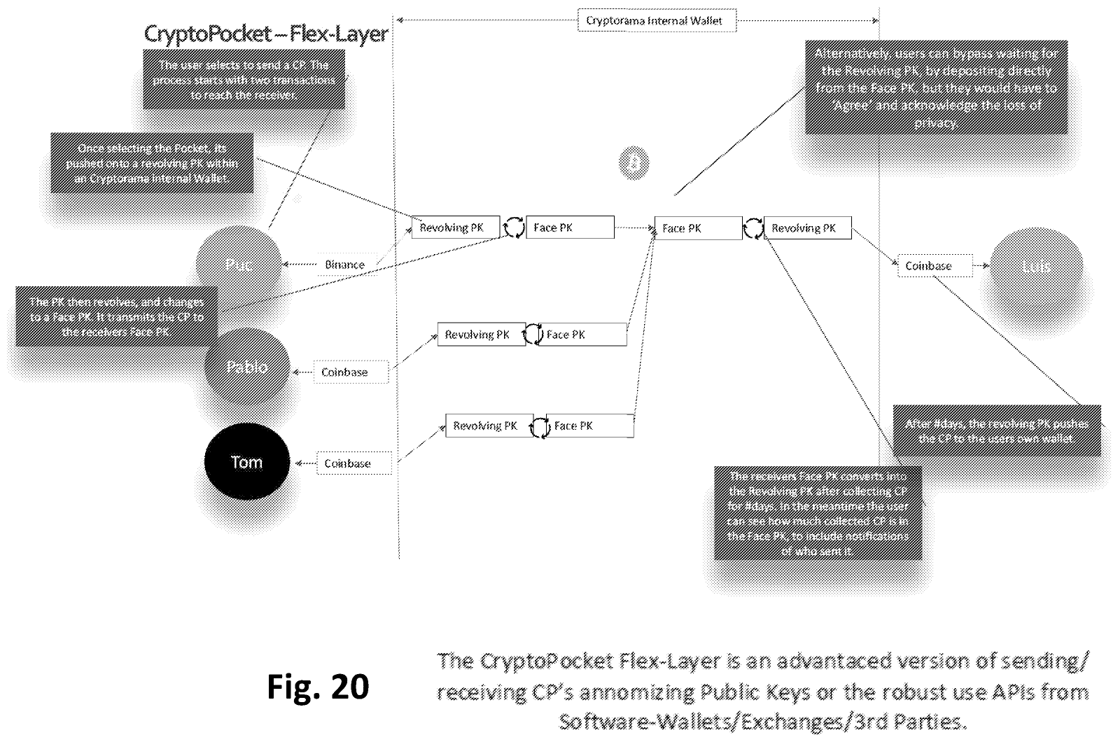

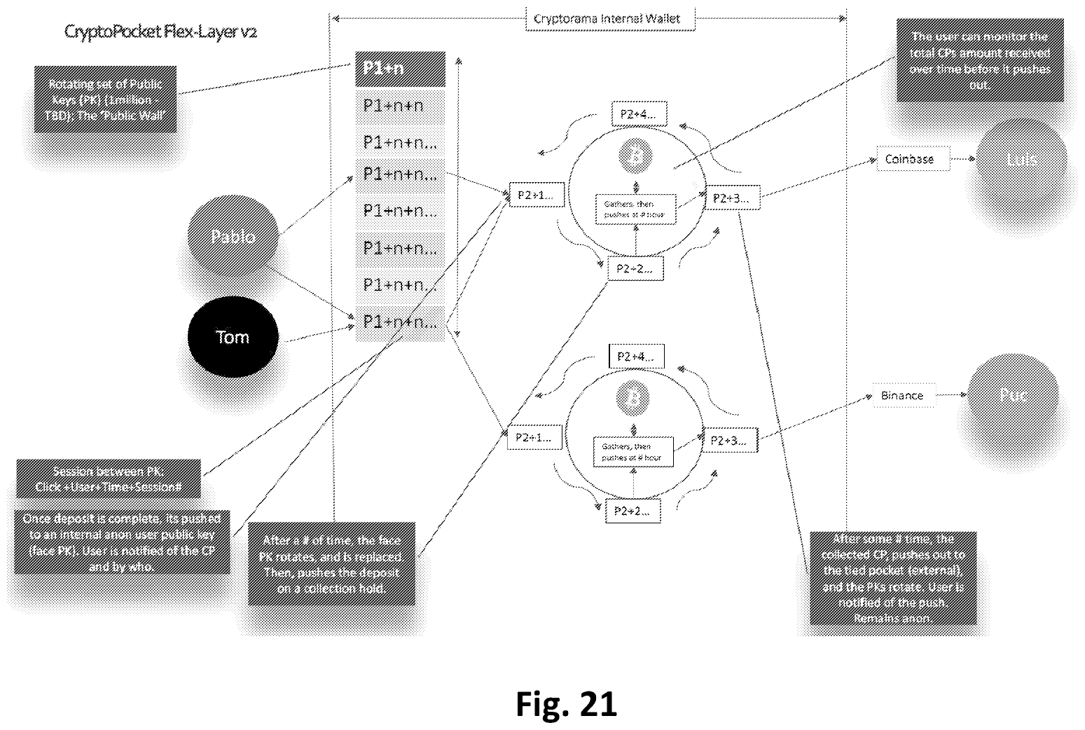

FIGS. 13 and 14 illustrate another exemplary disclosed embodiment of the exemplary disclosed system and method. The exemplary disclosed embodiment may include a CryptoPocket feature or utility that may socially “hand over” digital assets to a user within the system (e.g., to a users pocket). This may include a deposit made to the Public portion of a given user's wallet (e.g., Direct Layer 1 Public Key or Layer 2 Networks Public Keys). When the user registers, the system may prompt (e.g., encourage) the user to add a blockchain network ‘Public Key’ from any suitable Blockchain Network or Cryptocurrency Ledger. Users may modify their “pockets” (Public Keys) at any time. Pockets may be added manually (simply pasting the Public Key onto user accounts CPs) or through Over the App (OTA) methods (e.g., an OTA API with Coinbase or a Safepal Software Wallet). This may allow the system to serve as a utility to socially perform digital assets deposits between “followers,” or special accounts, while not being strictly tied to a single digital asset, blockchain network, and/or Exchange. The exemplary disclosed utility function may be for any suitable digital asset. Digital assets may be converted into stable coins and/or cash. The system may provide a reward with digital assets toward a desired post (e.g., good or popular post) or content and may simplify deposits between casual digital asset holders. FIGS. 15-19 illustrate exemplary embodiments of the exemplary disclosed graphical user interface and schematic illustrations of the system's operation. FIGS. 20-21 illustrate exemplary embodiments of the exemplary disclosed CryptoPocket feature or utility.

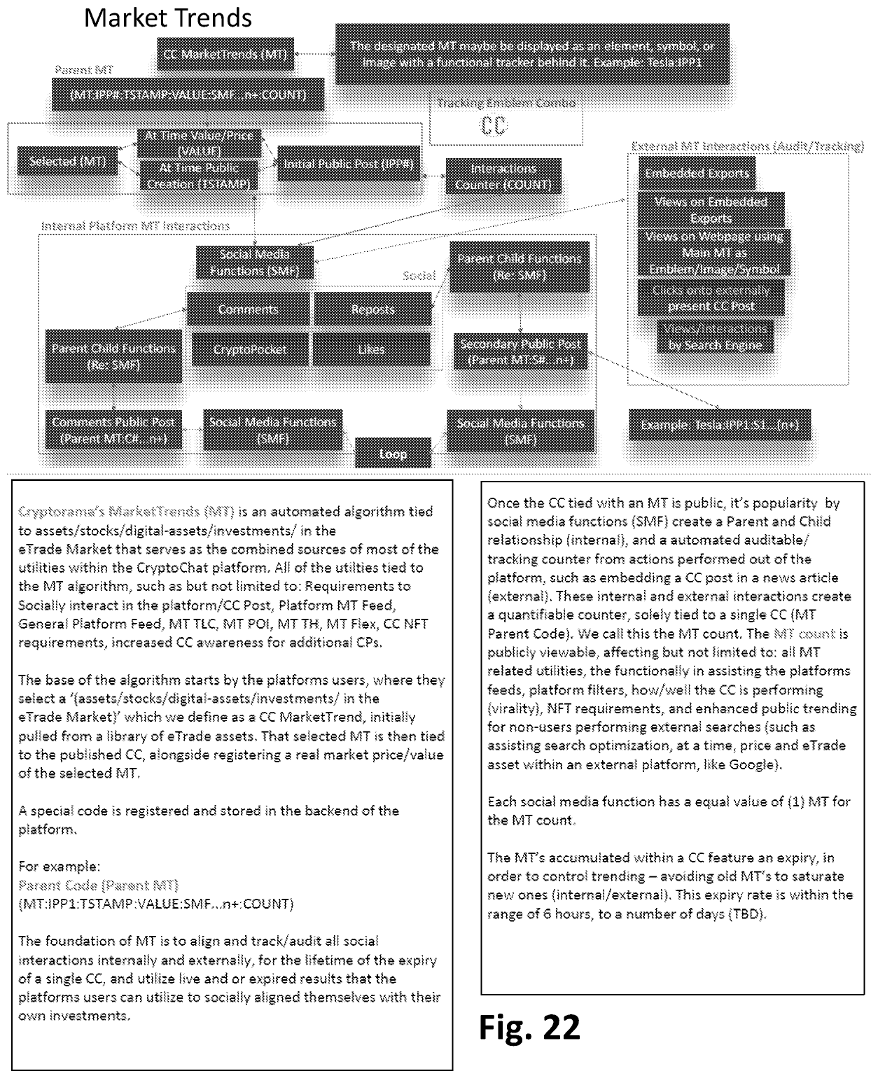

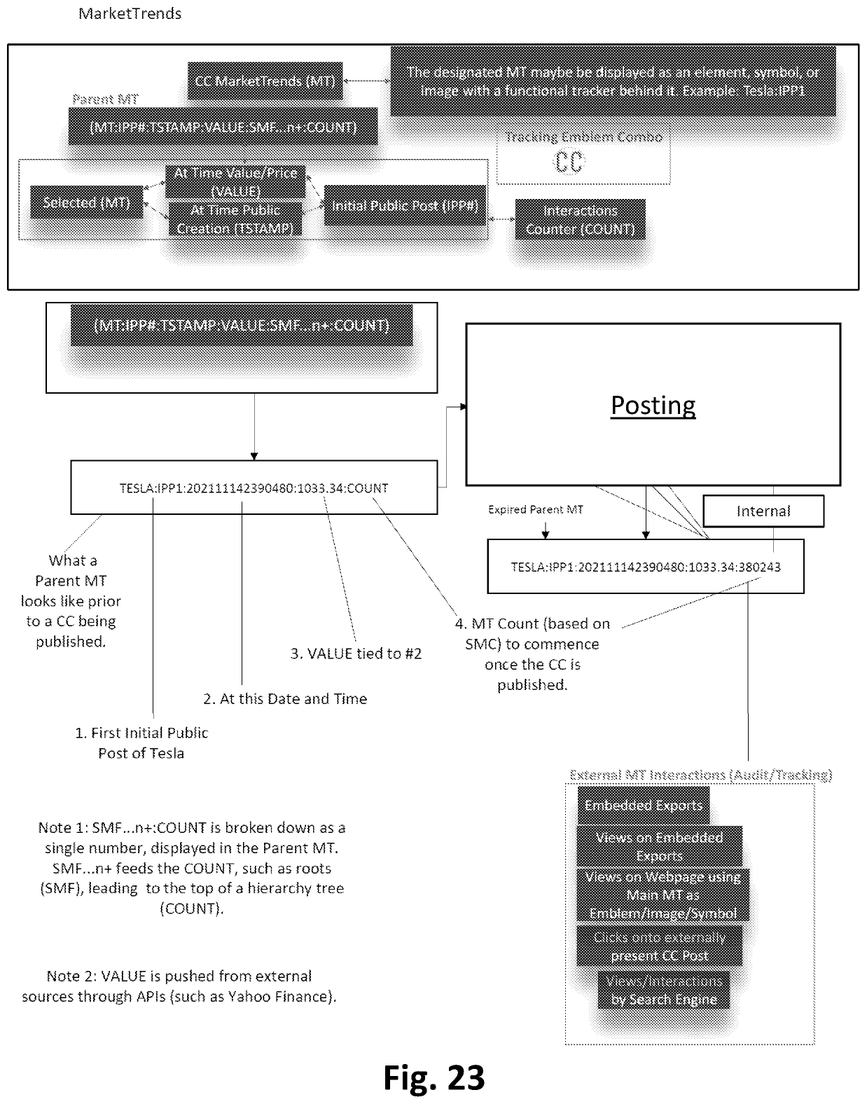

FIGS. 22 and 23 illustrate another exemplary disclosed embodiment of the exemplary disclosed system and method. The exemplary disclosed embodiment may include an algorithm (e.g., an automated algorithm such as Cryptorama's MarketTrends or MT) that may be tied to any suitable asset, stock, digital assets, investment, and/or any other suitable item having value to a user. The exemplary disclosed system and method may include an eTrade Market that may serve as a source or combined sources of some or most of the utilities within the system (e.g., CryptoChat platform). Some or all of the utilities tied to the MT algorithm may for example (e.g., as illustrated in FIGS. 22 and 23) include features for social interaction on the system such as CC Post, Platform MT Feed, General Platform Feed, MT TLC, MT POI, MT TH, MT Flex, CC NFT features, increased CC awareness for additional CPs, and/or any other suitable components, modules, or features. The base of the algorithm may be initiated by system users (e.g., the platforms users), in which the users select any suitable asset, stock, digital assets, investment, and/or any other suitable item having value of the eTrade Market (e.g., a CC MarketTrend initially pulled from a library of eTrade assets). The selected MT may then be tied to the published CC, for example alongside registering a real market price or value of the selected MT. A code (e.g., a special code) may be registered and stored by the system (e.g., in the backend of the platform). For example, a Parent Code (Parent MT) may be defined as (MT:IPP1:TSTAMP:VALUE:SMF . . . n+:COUNT).

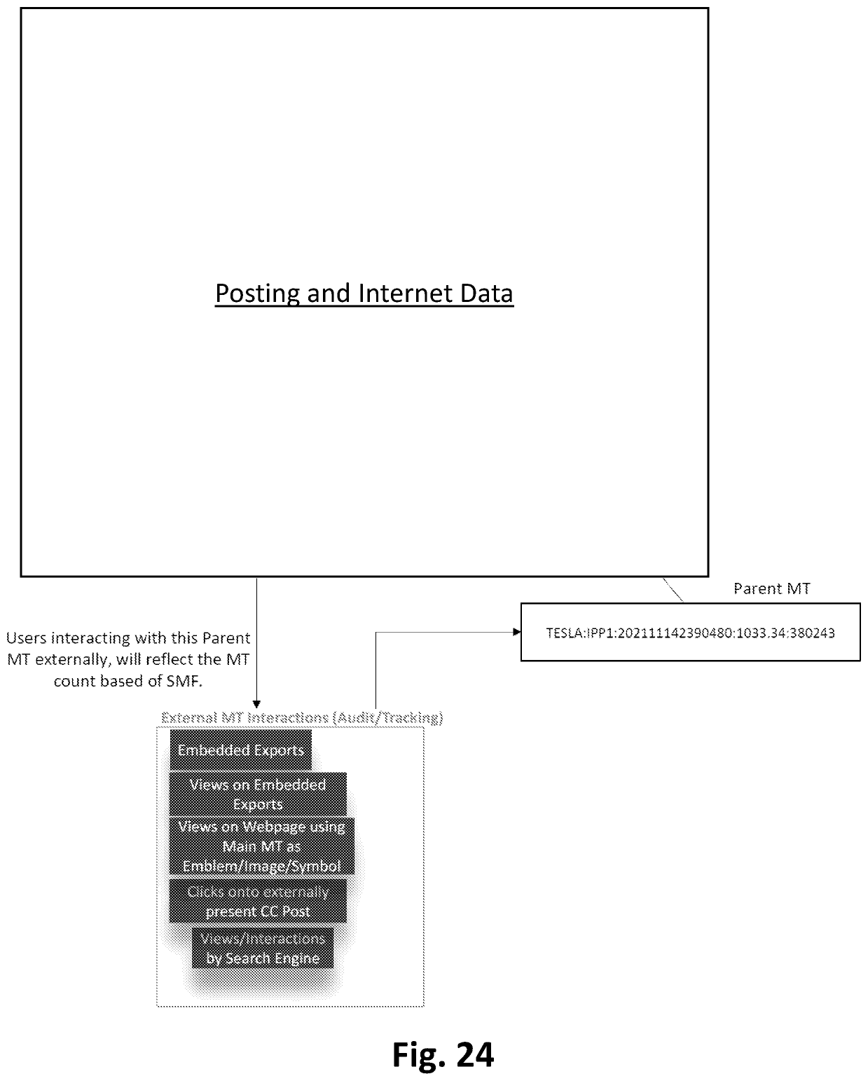

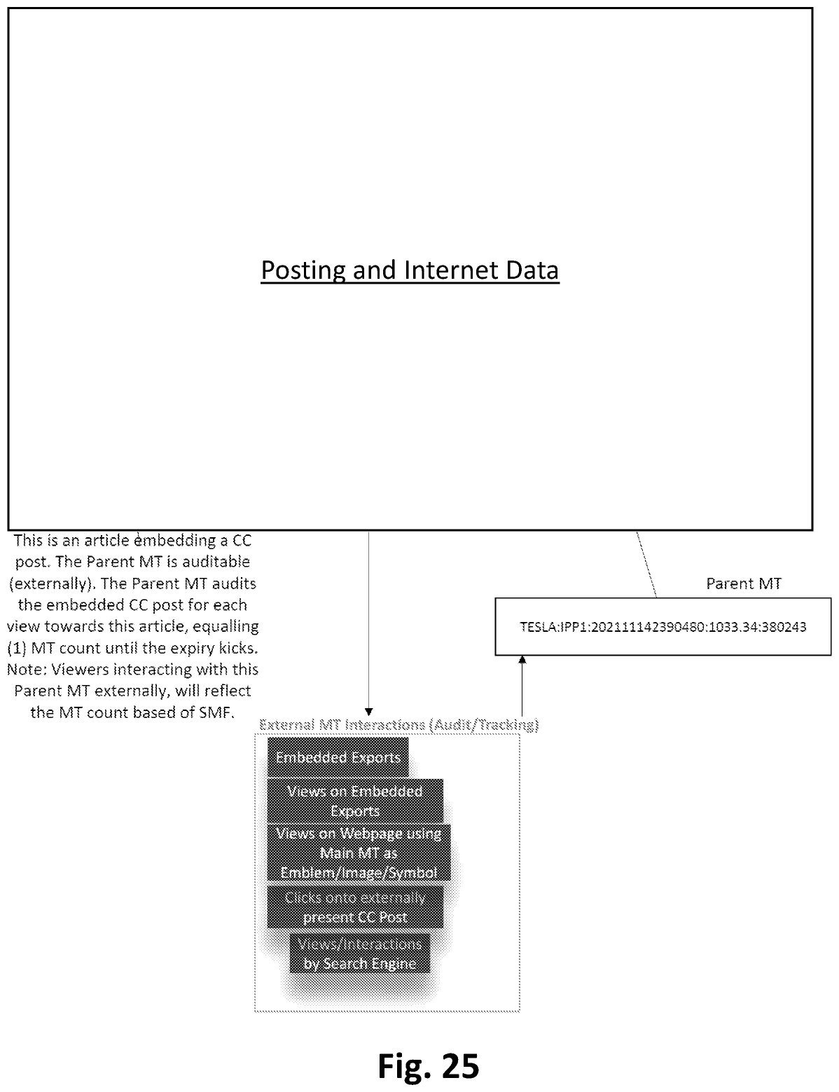

In at least some exemplary embodiments and as illustrated in FIGS. 22 and 23, the foundation of MT may be to align and track and/or audit some or substantially all social interactions internally and externally relative to the system, for some of or substantially an entire lifetime of the expiry of a single CC (e.g., CC post), and utilize live and/or expired results that users (e.g., the platform users) may utilize to socially align themselves with their own investments. Once a CC (e.g., CC Post) tied with an MT may be public, its popularity by social media functions (SMF) may create a Parent and Child relationship (e.g., an internal relationship), and a counter (e.g., an automated auditable tracking counter) from actions performed out of the platform, such as embedding a CC post in a news article (e.g., an external posting). These exemplary disclosed internal and external interactions may create a quantifiable counter, tied (e.g., solely tied) to a single CC (e.g., MT Parent Code) that may be an MT count. The MT count may be publicly viewable, e.g., affecting but not limited to: some or substantially all MT related utilities (e.g., functionally in assisting the platforms feeds), platform filters, evaluating how well the CC is performing (e.g., virality), NFT criteria, and/or enhanced public trending for non-users performing external searches (e.g., assisting search optimization at any suitable time, price, and/or eTrade asset within an external platform such as Google). For example, each social media function may have an equal value of (1) MT for the MT count (e.g., or any other suitable value). The MTs that may be accumulated within a CC may feature an expiry in order to control trending and may avoid relatively old MTs in order to saturate new ones (e.g., internal or external). This expiry rate may be within any suitable range such as, for example, 6 hours to a number of days. FIGS. 24 and 25 illustrate exemplary disclosed graphical user interfaces and schematic depictions of at least some exemplary disclosed embodiments.

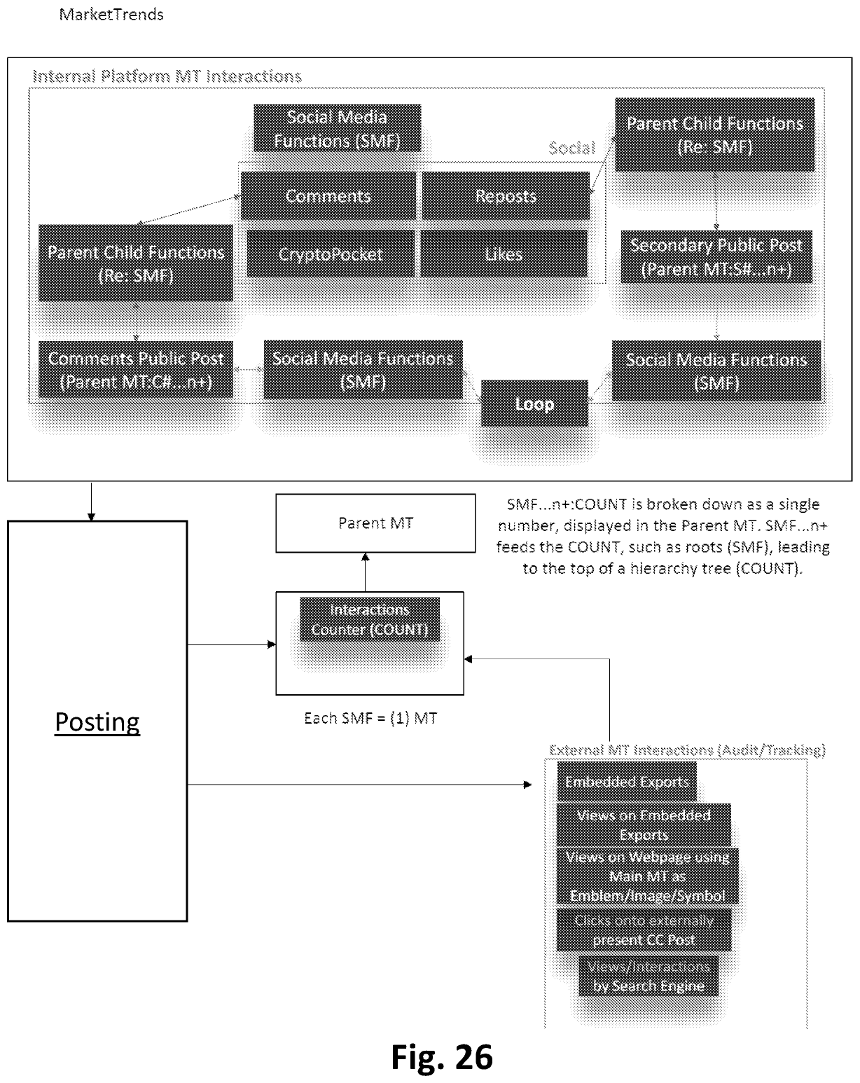

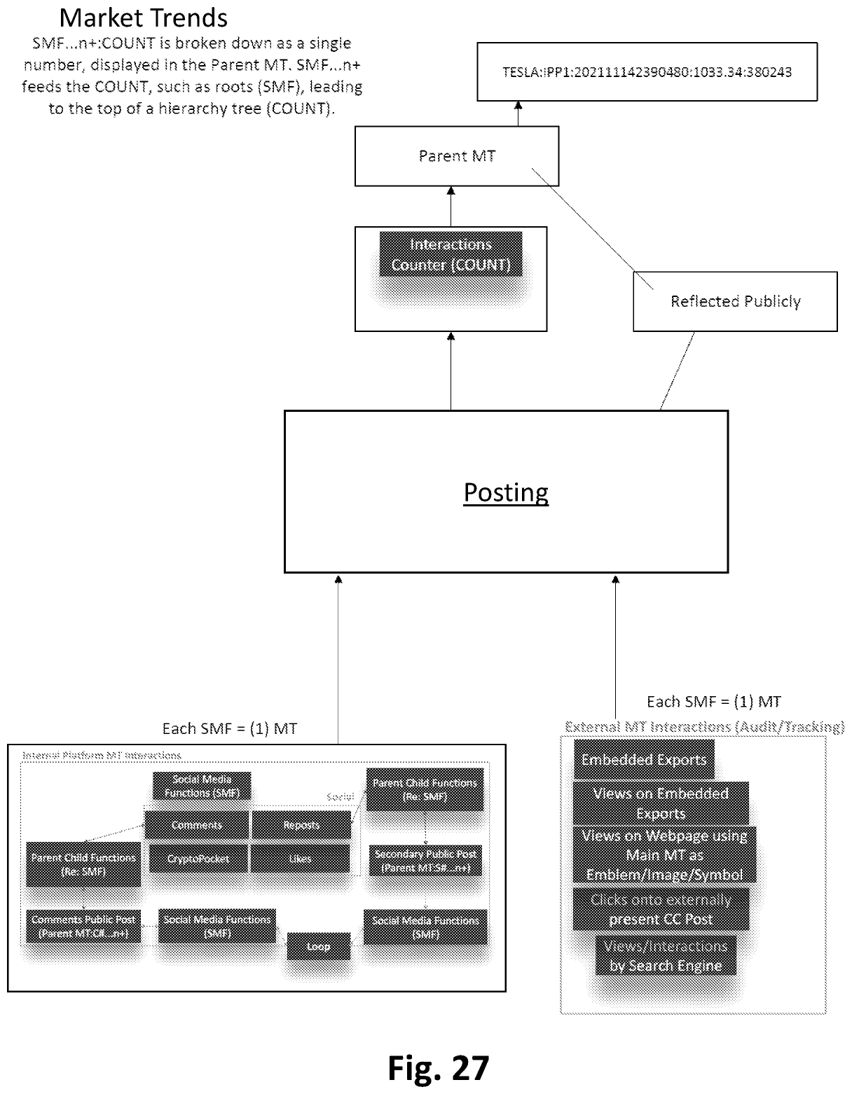

Exemplary embodiments of exemplary disclosed user interaction features are illustrated in FIGS. 26 and 27. For example as illustrated in FIGS. 26 and 27, SMF . . . n+:COUNT may be broken down as a single number, and displayed in the exemplary disclosed Parent MT feature. SMF . . . n+may feed the COUNT, such as for example roots (SMF), which may lead to the top of a hierarchy tree (COUNT).

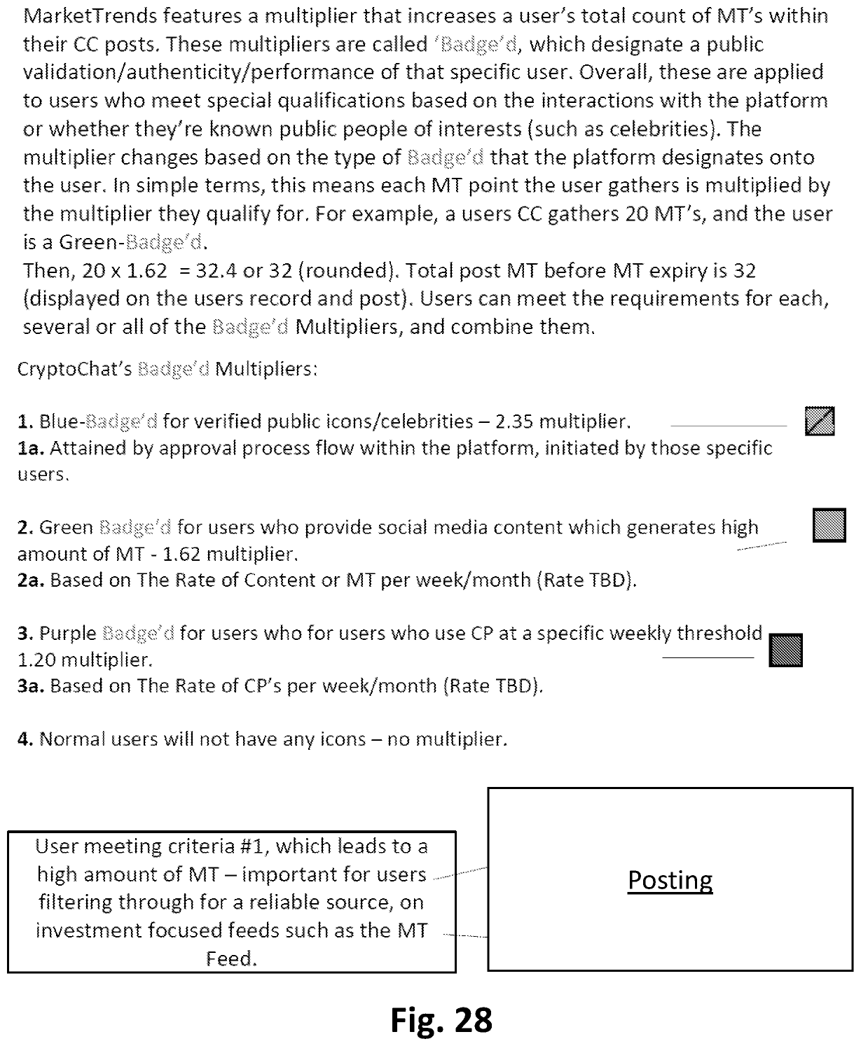

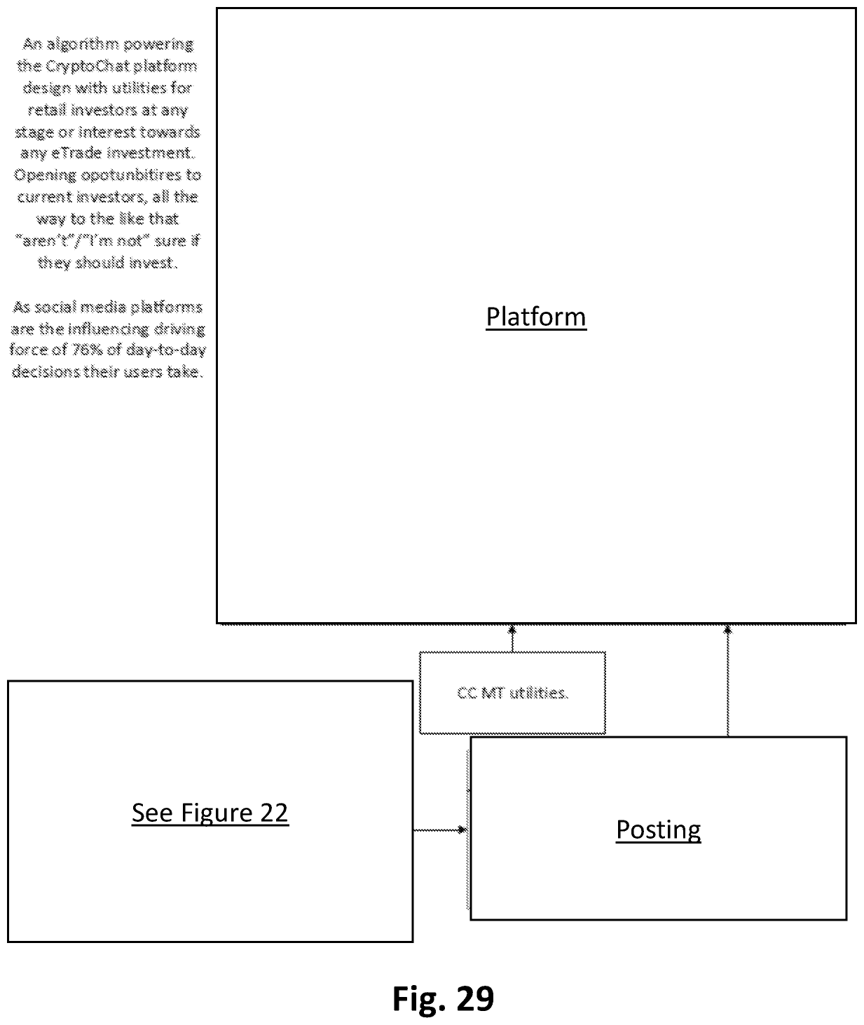

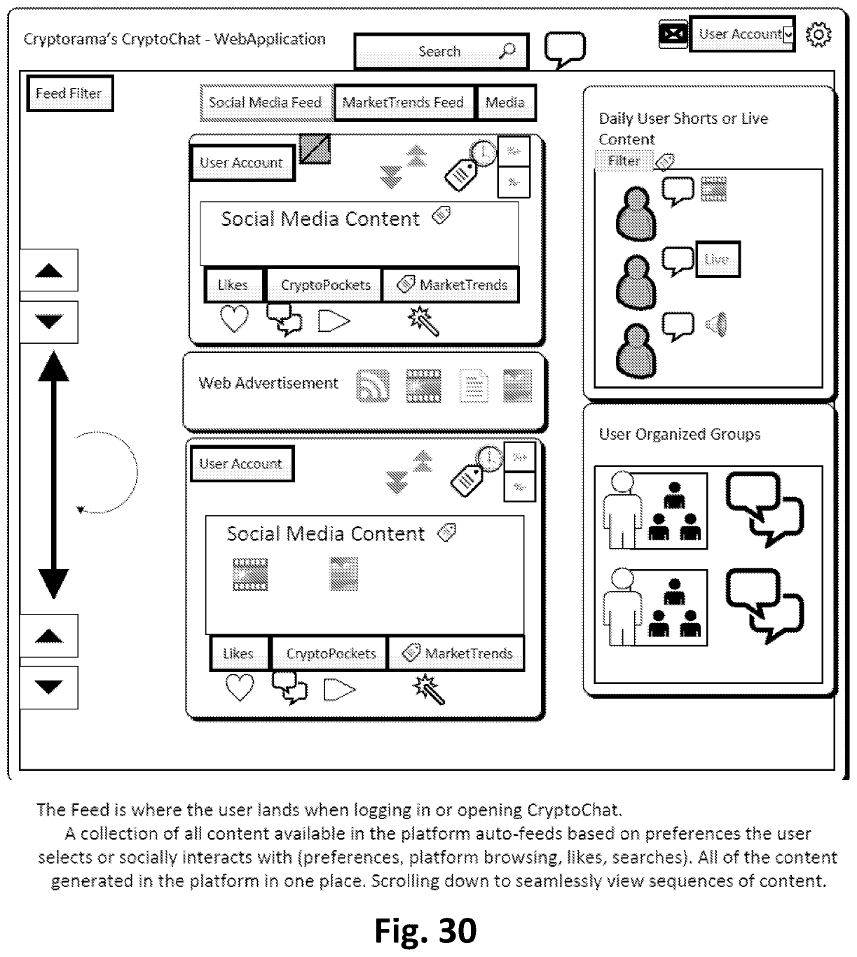

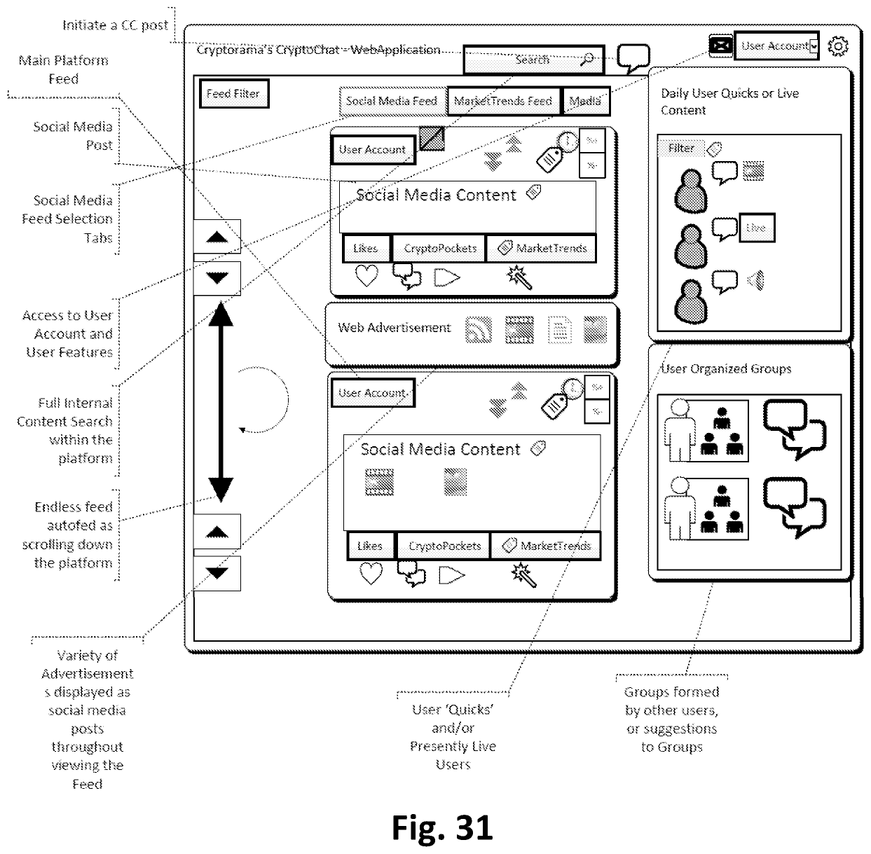

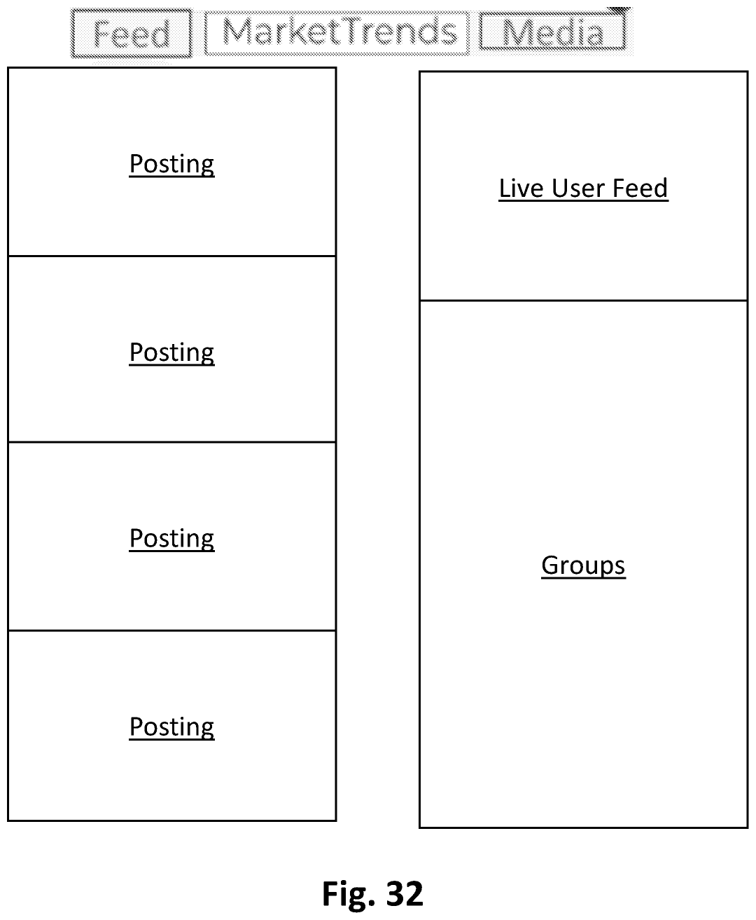

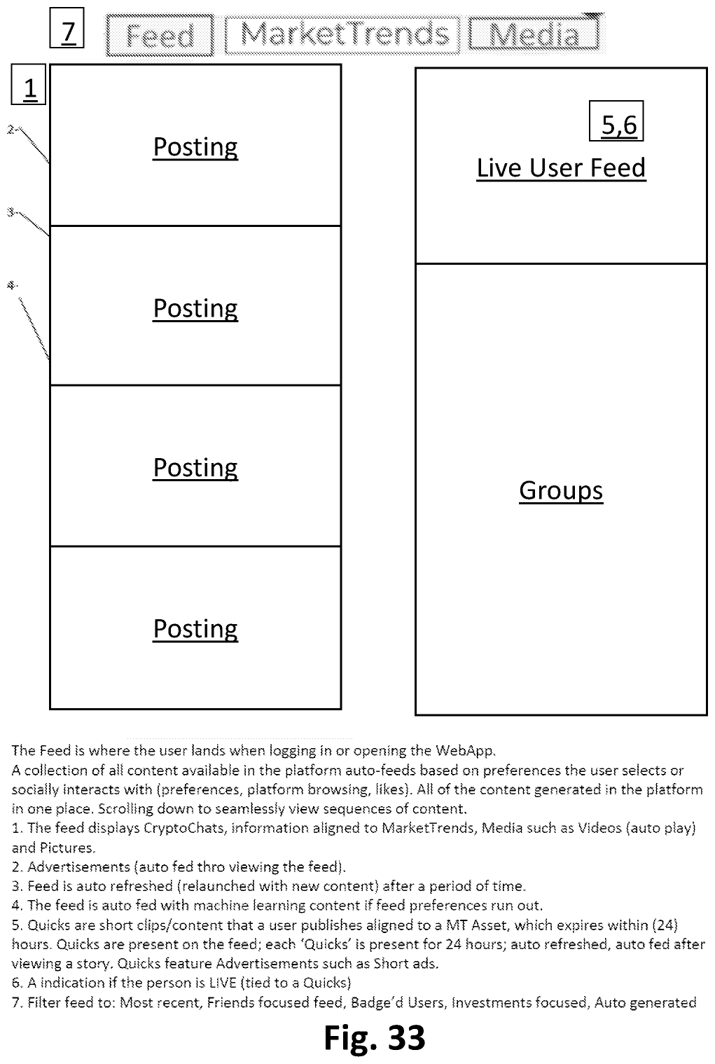

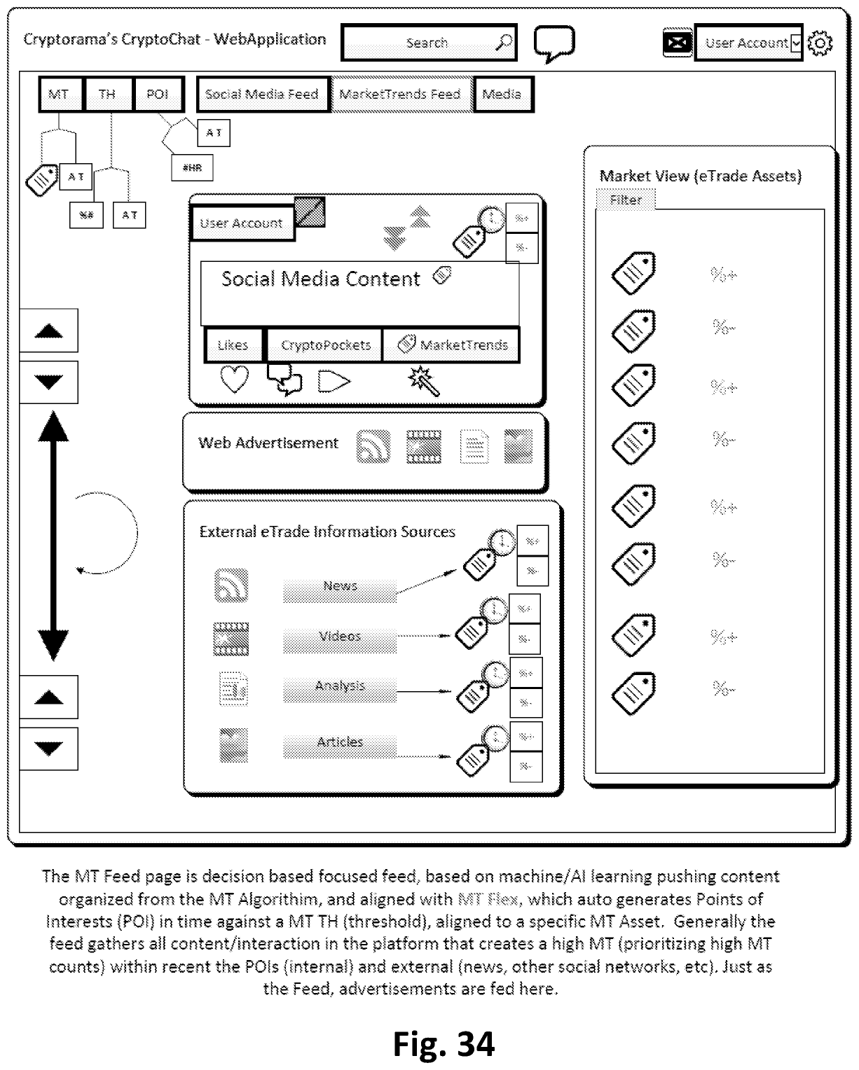

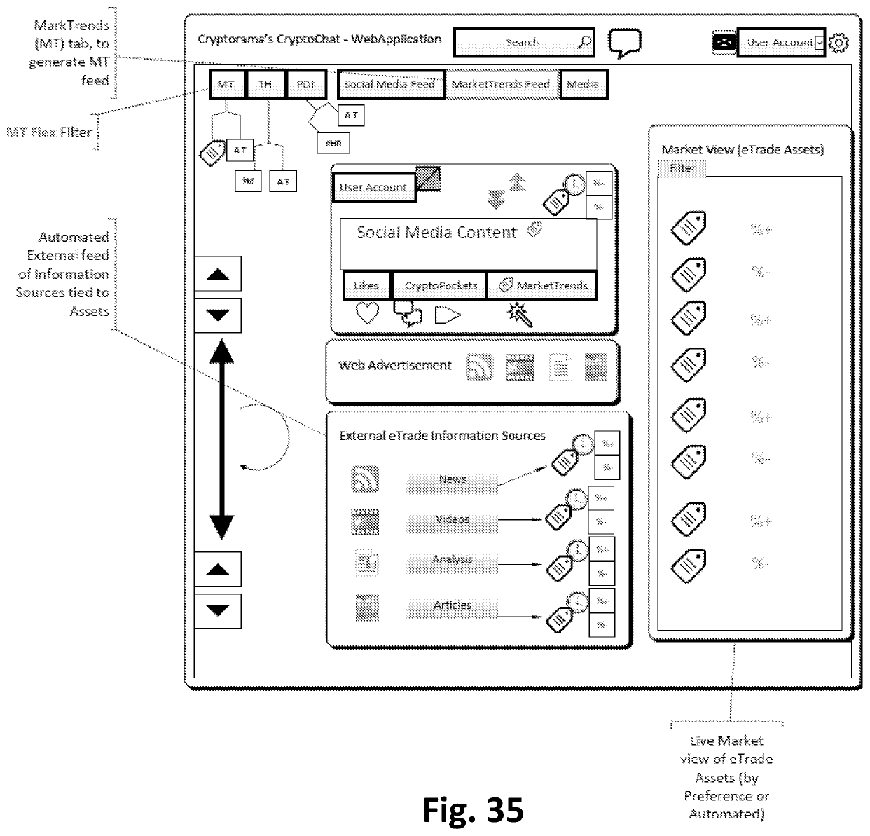

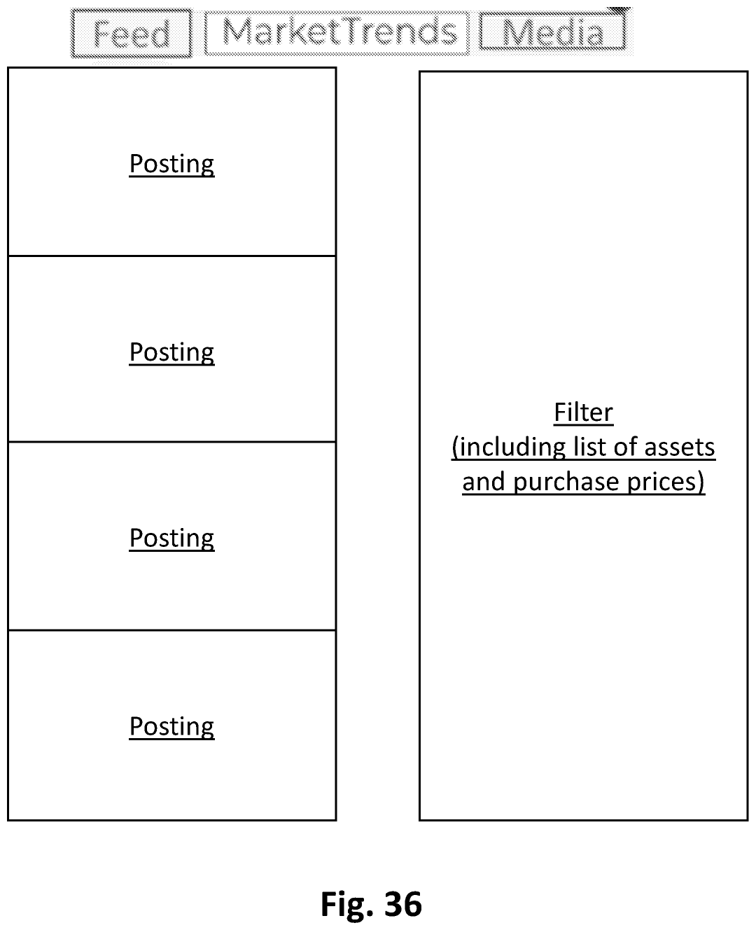

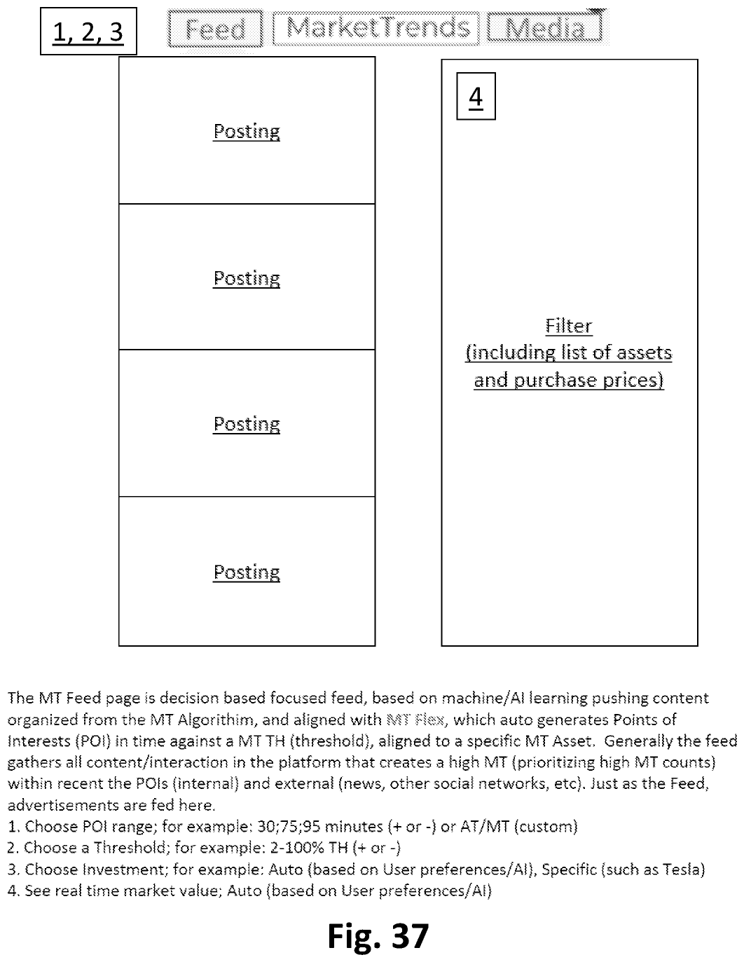

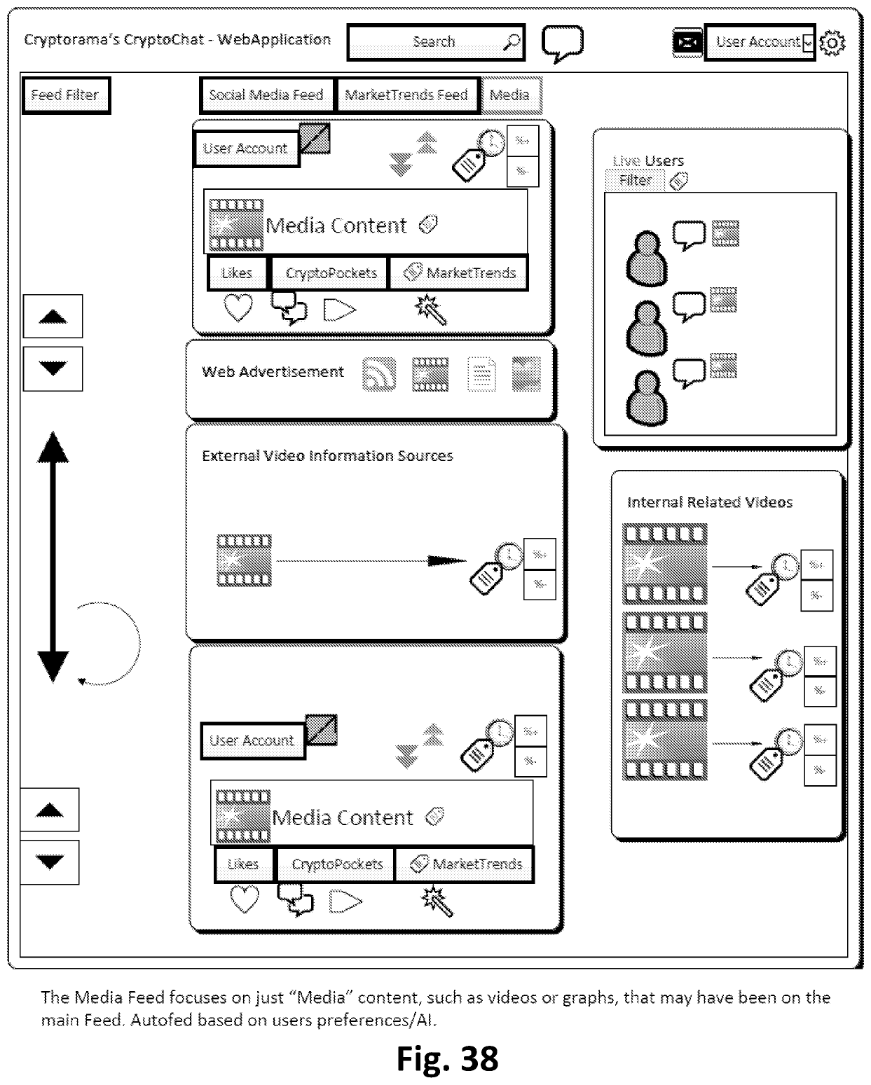

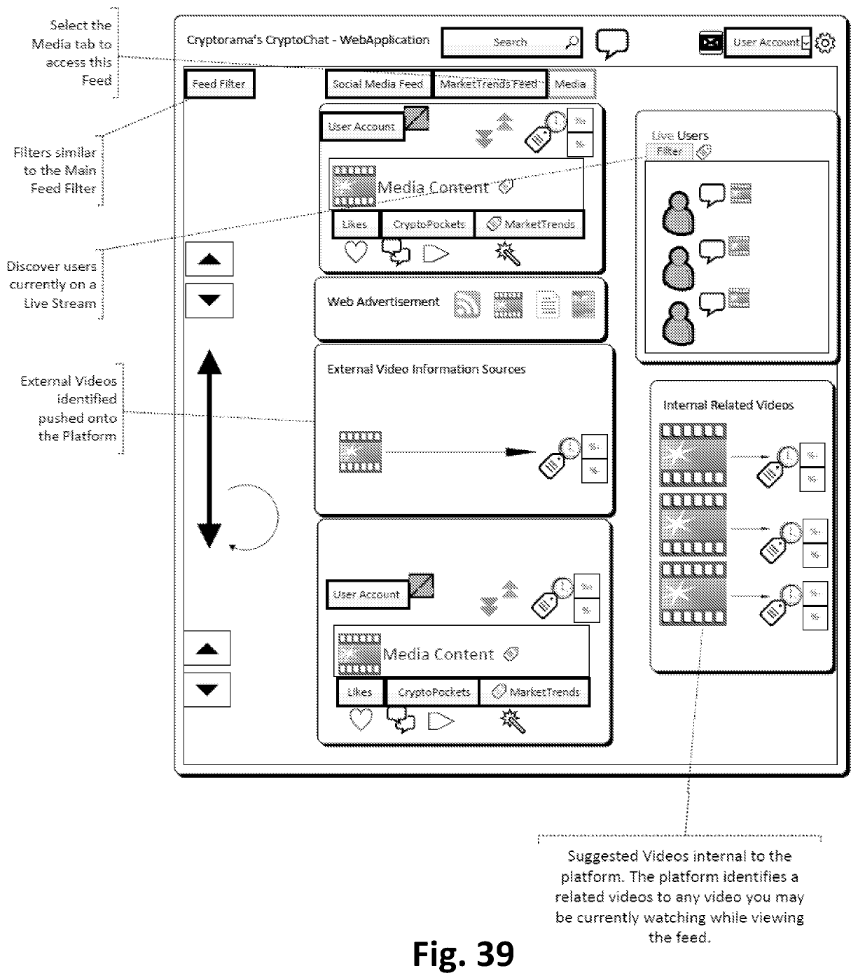

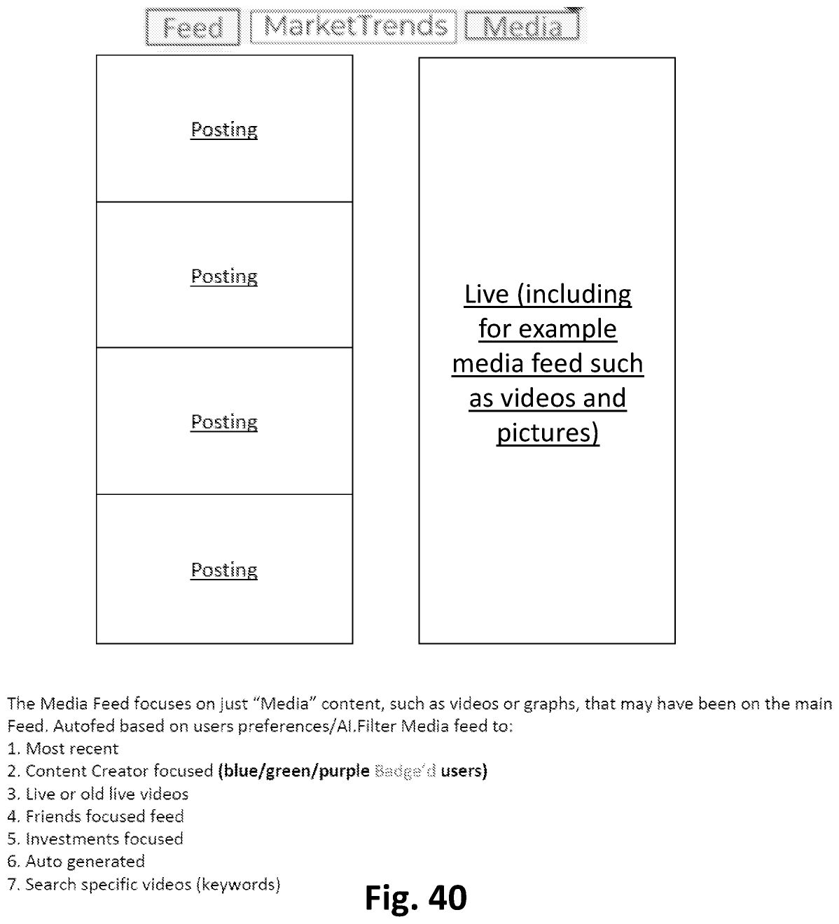

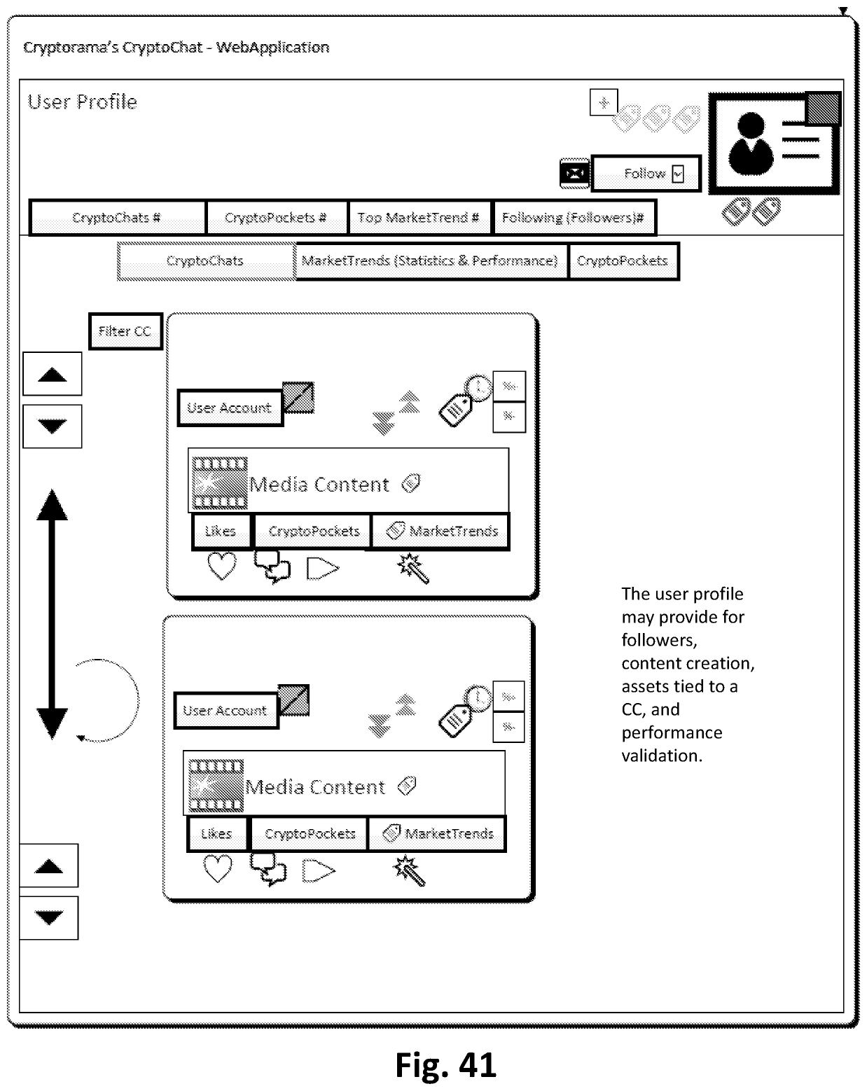

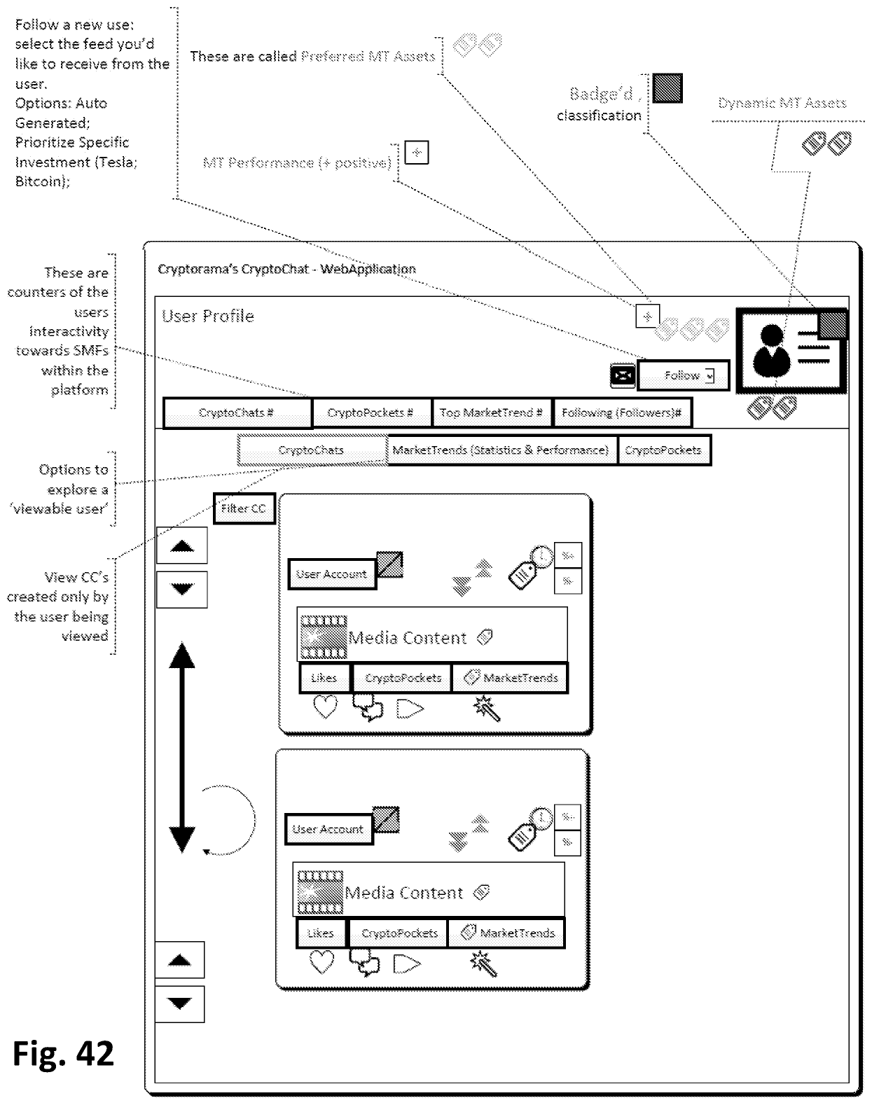

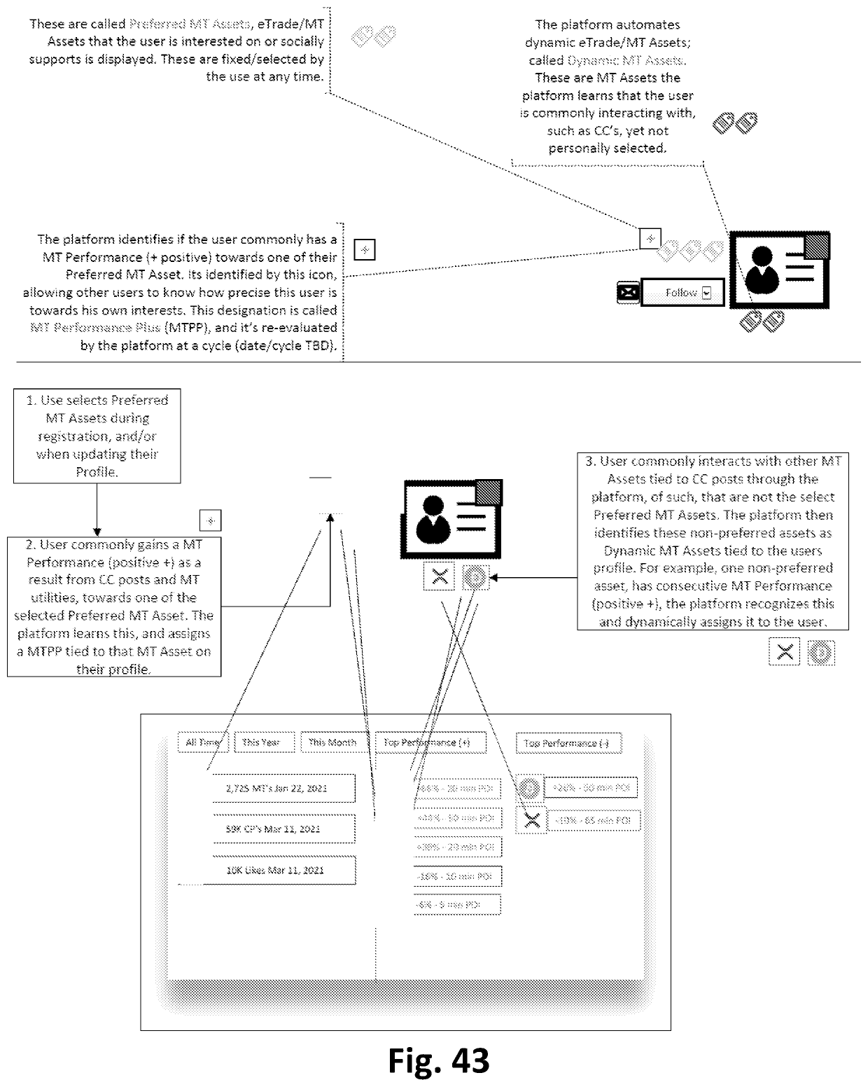

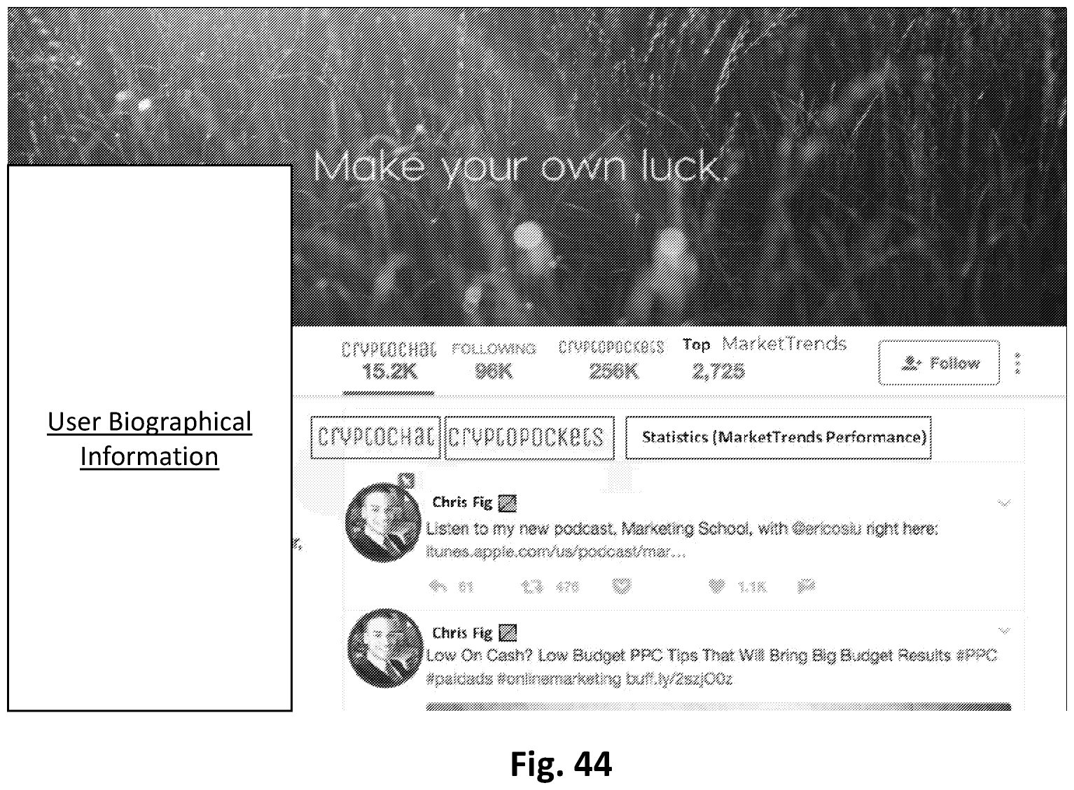

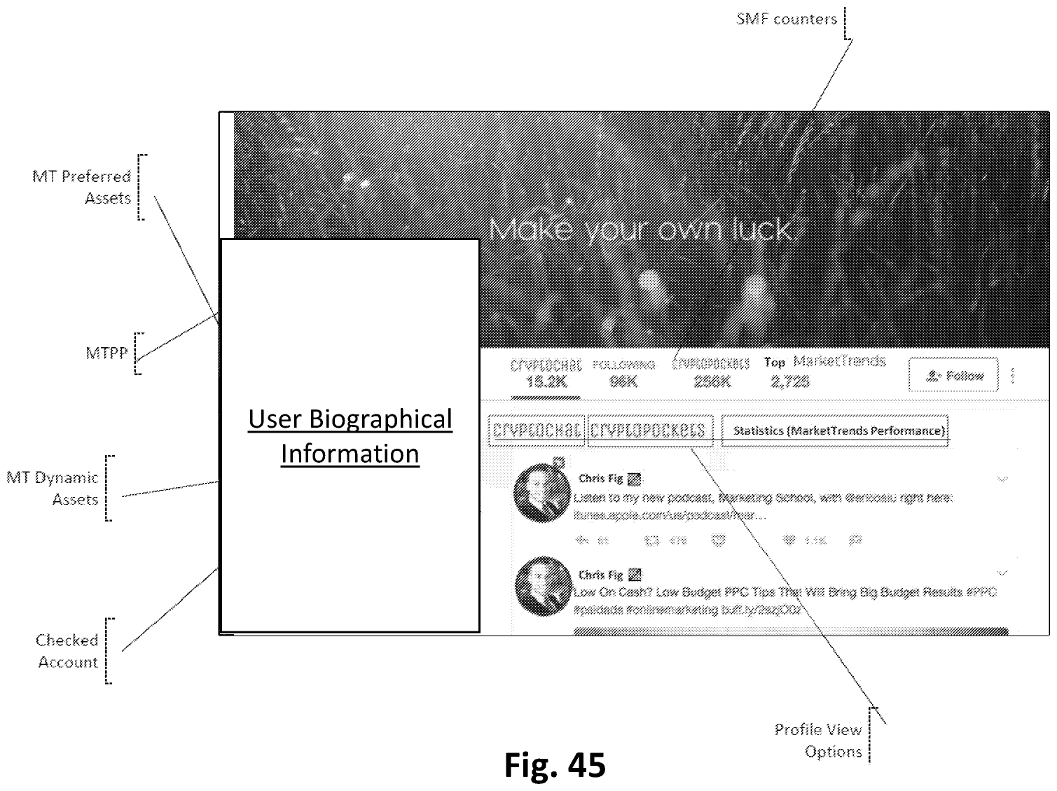

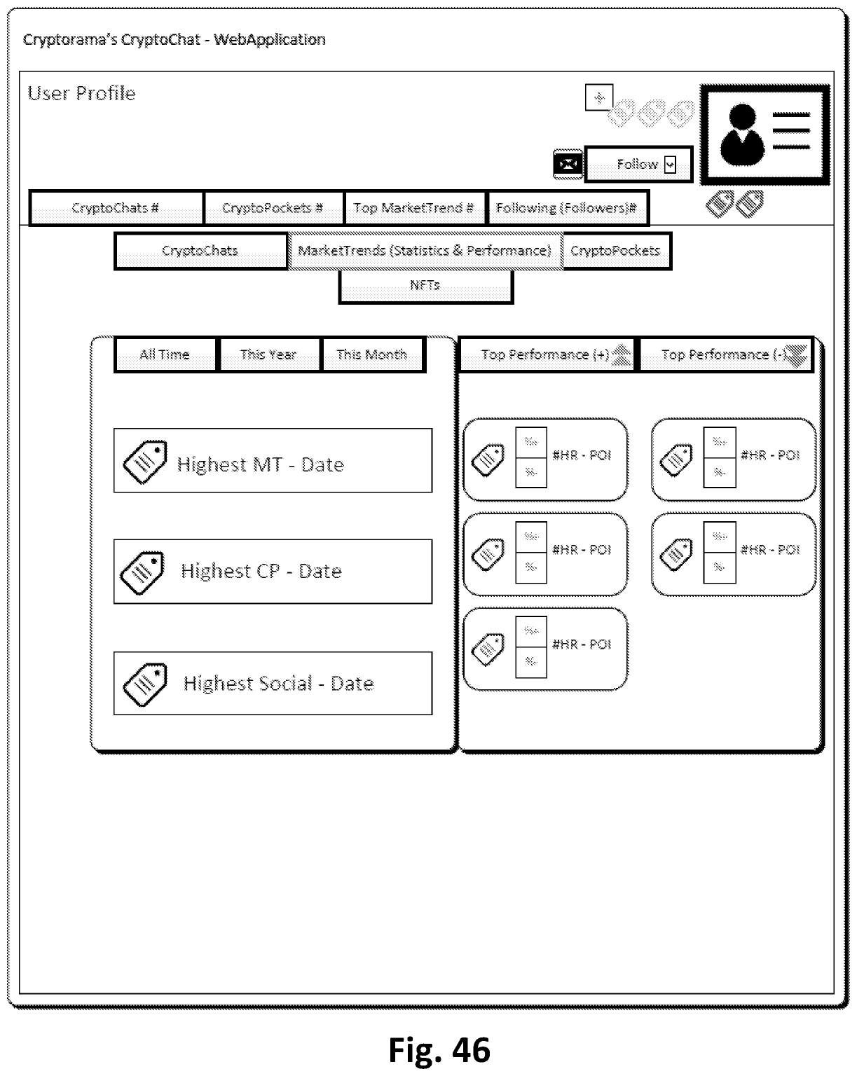

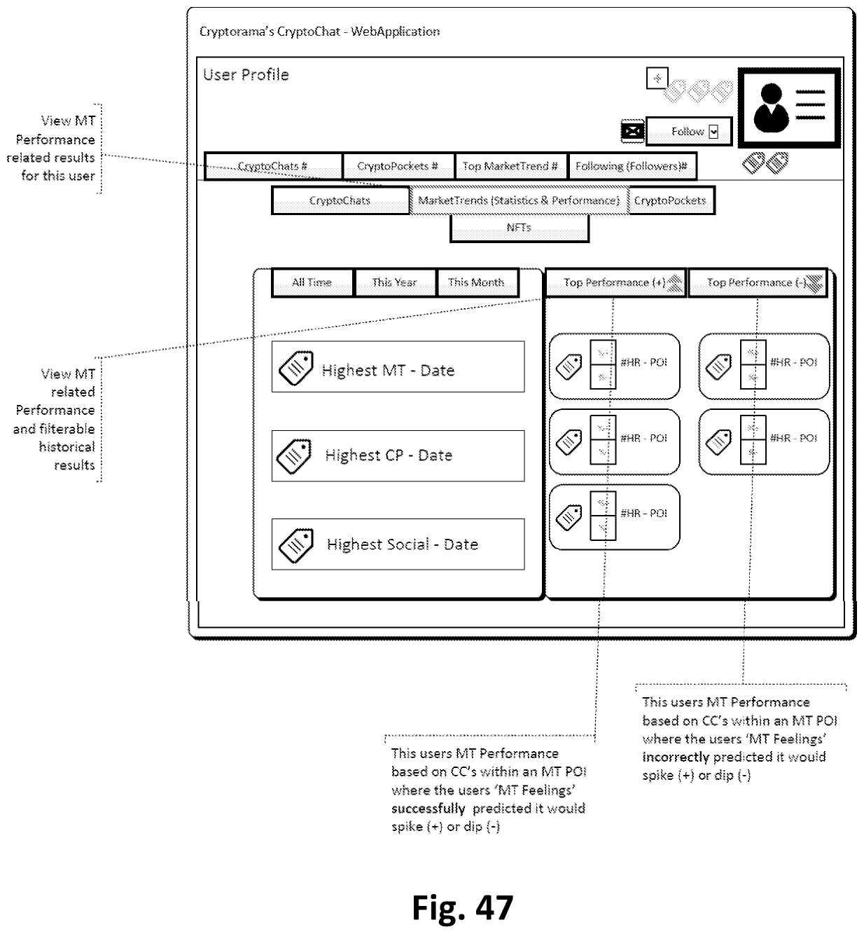

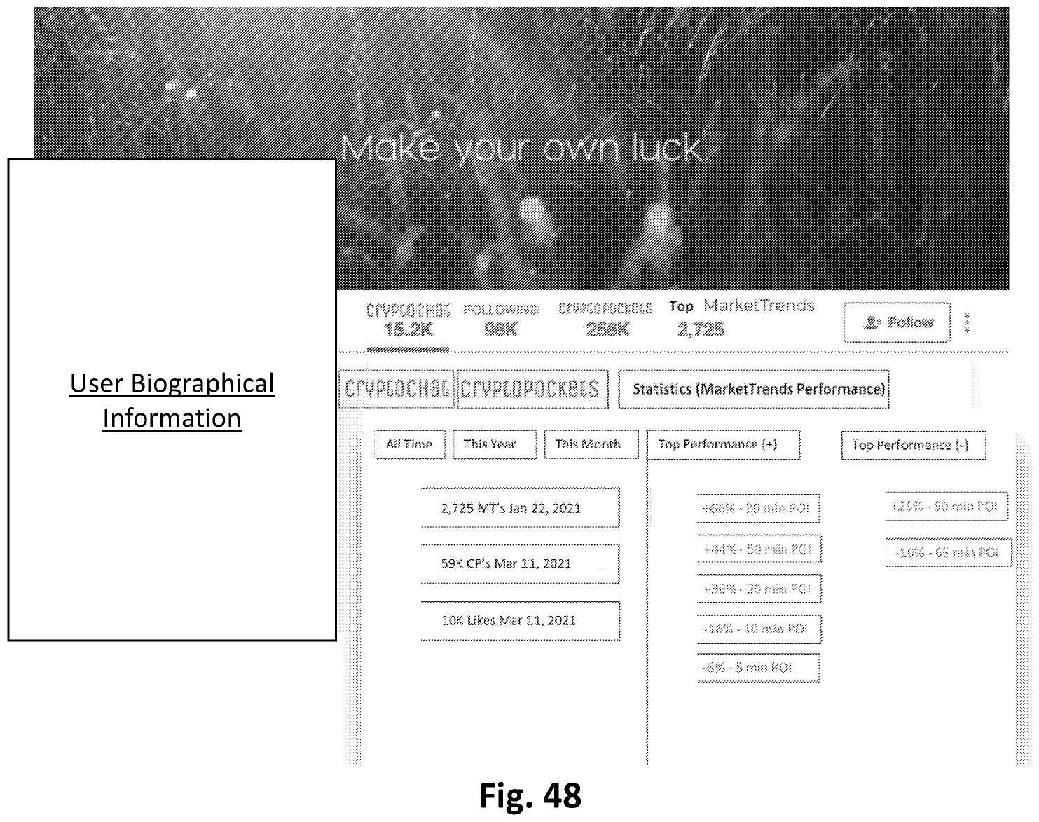

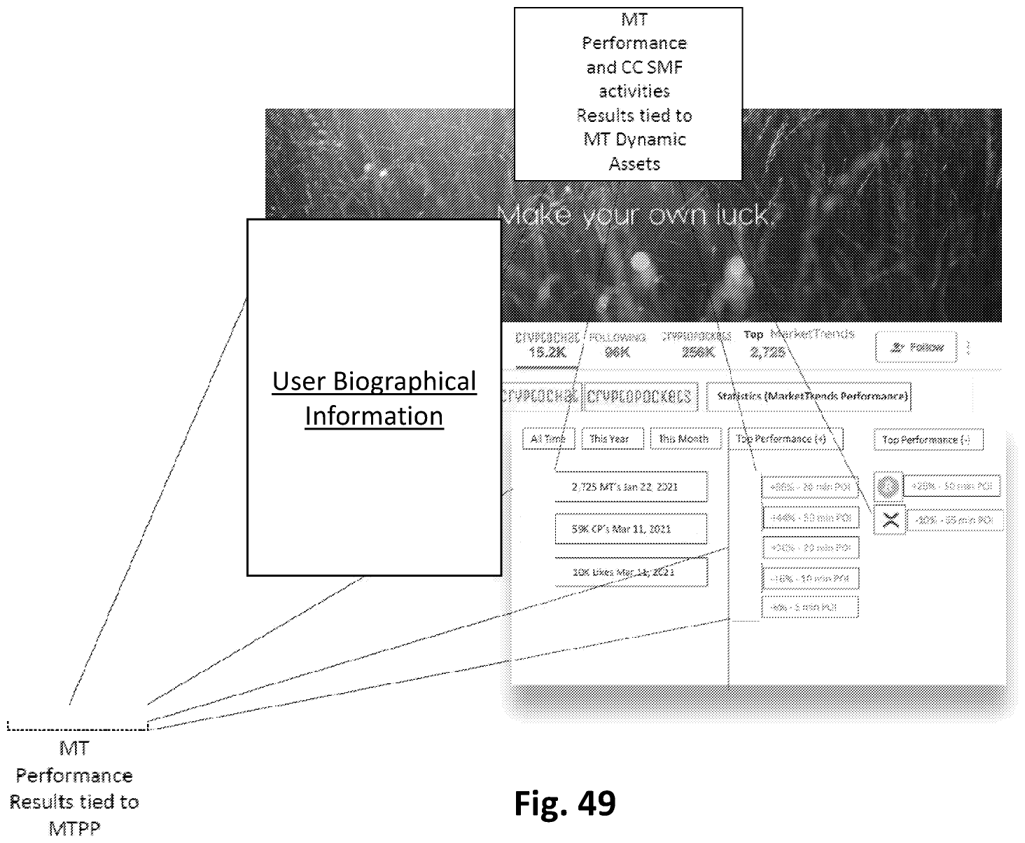

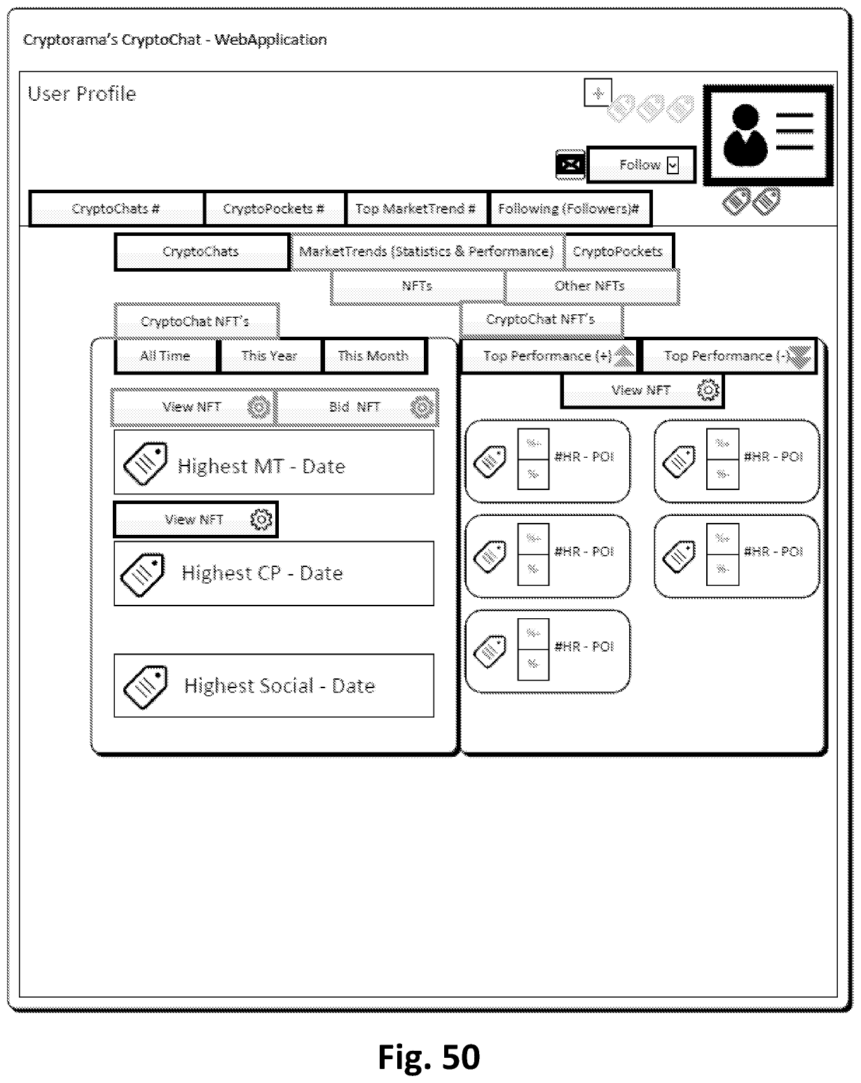

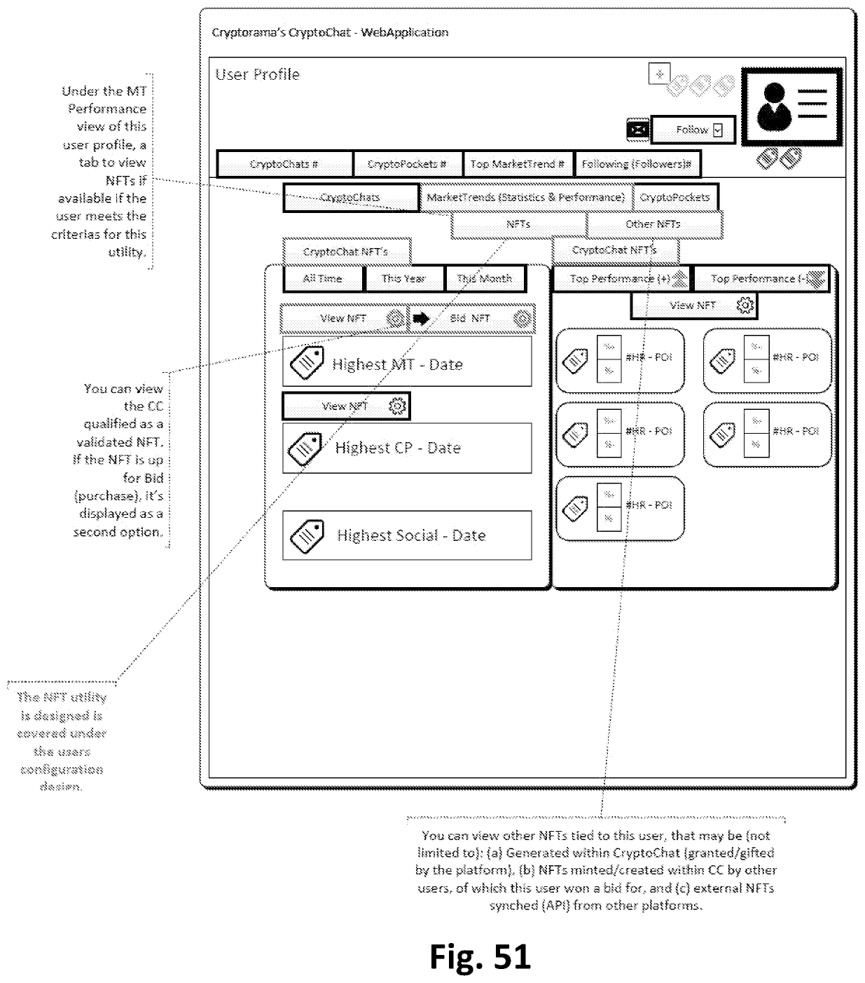

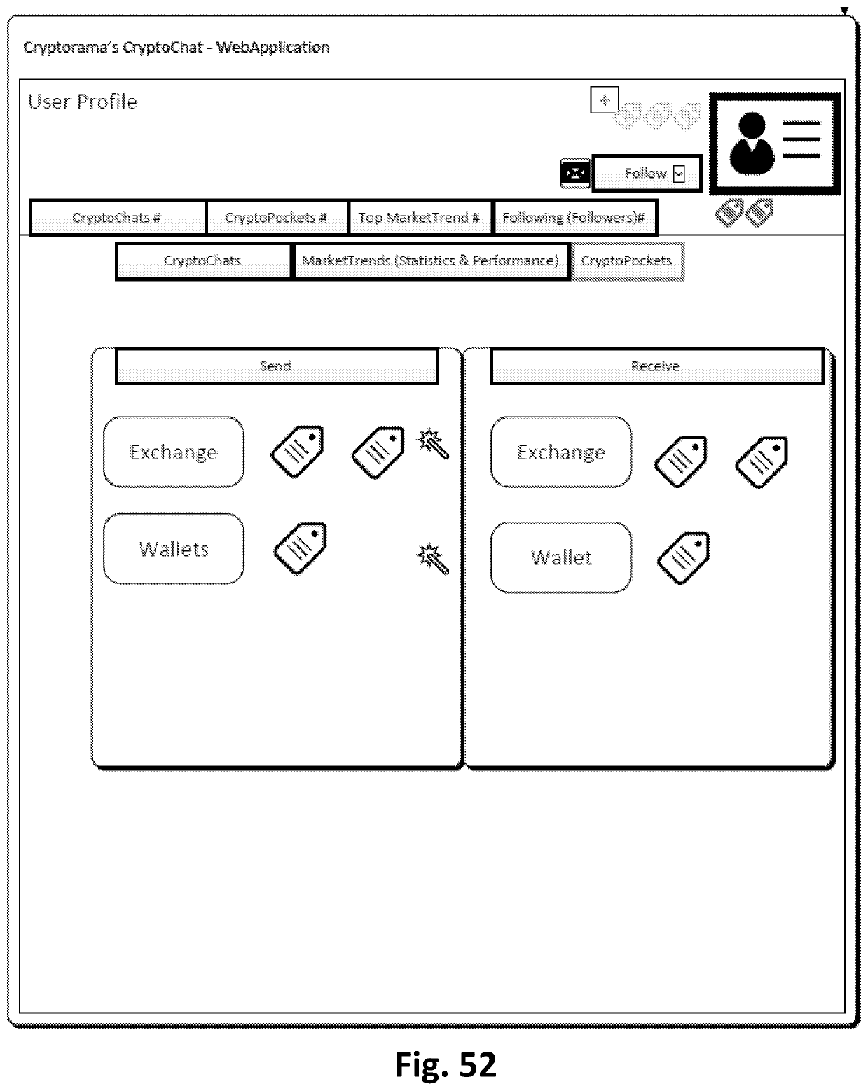

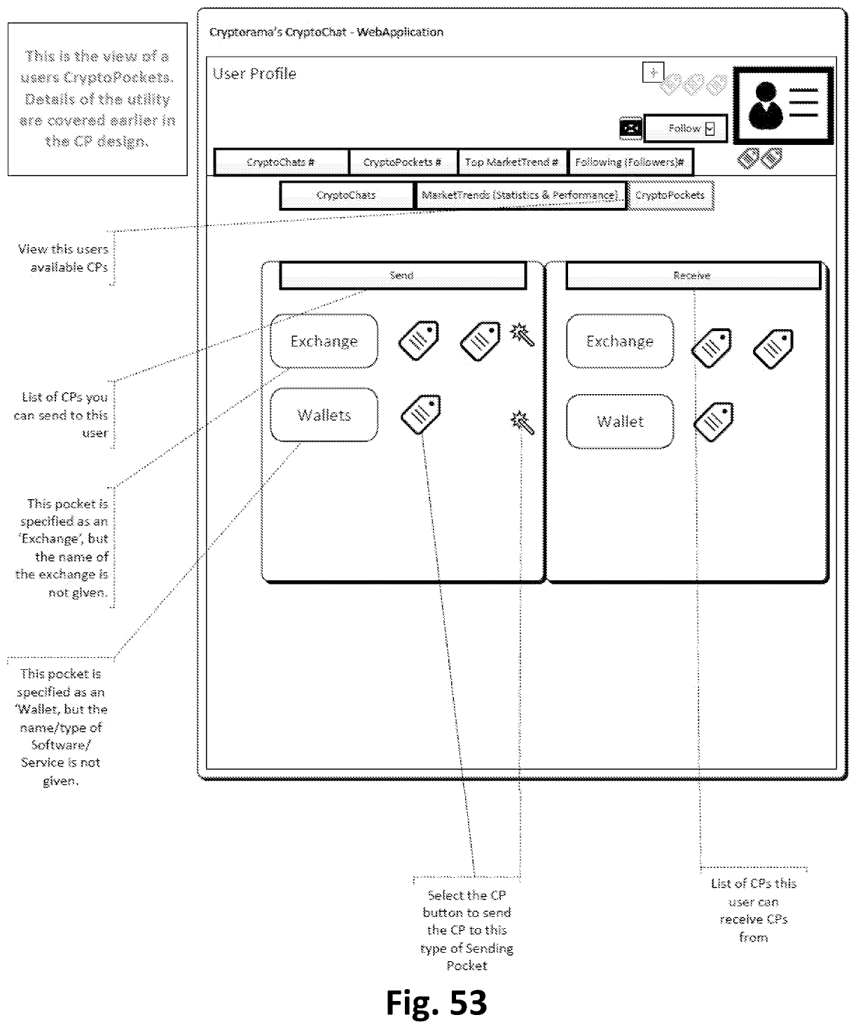

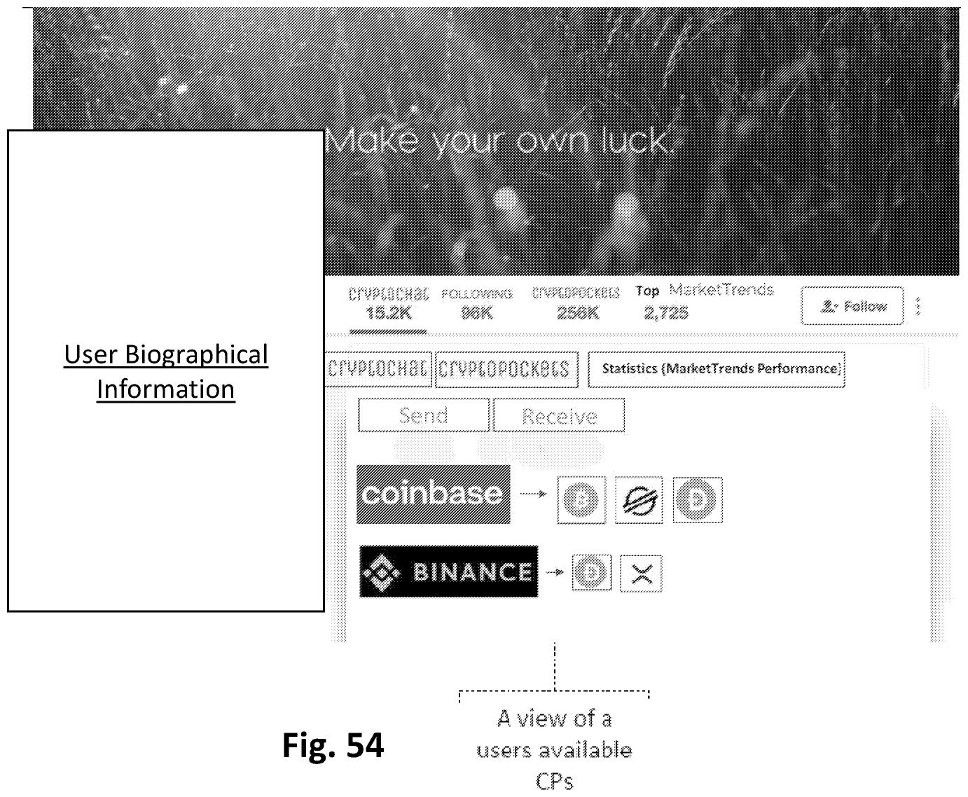

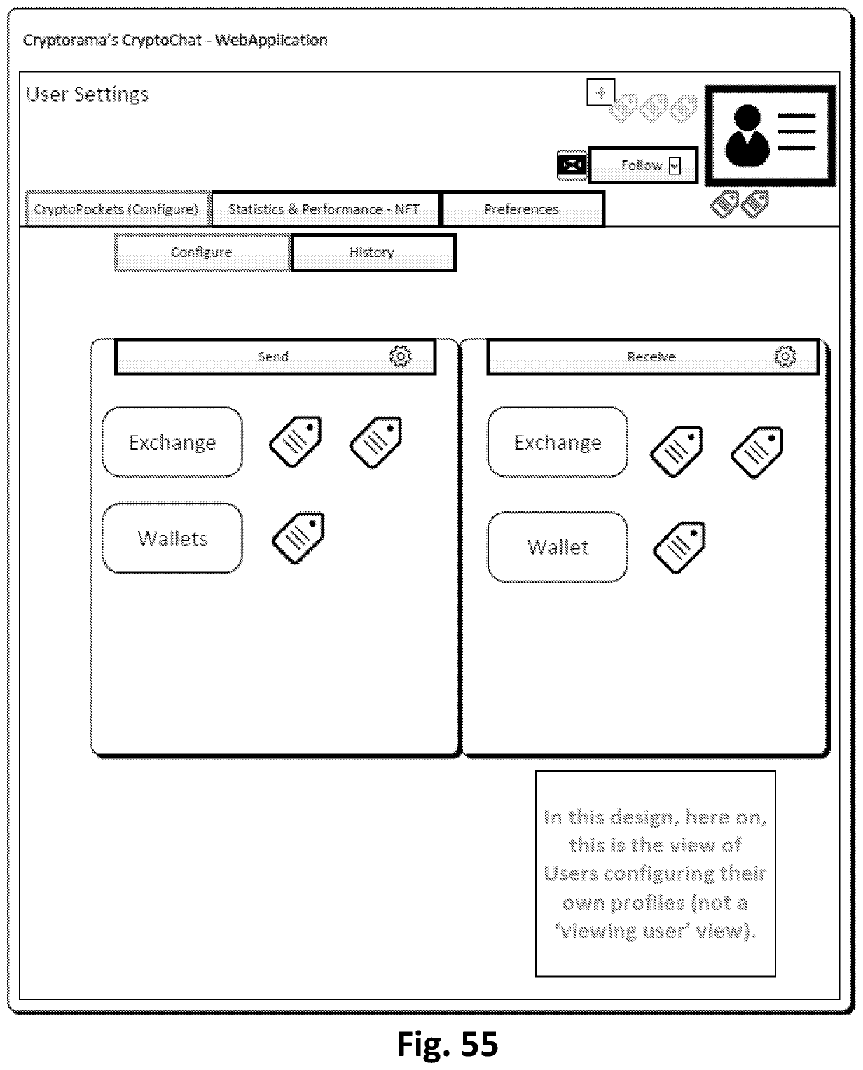

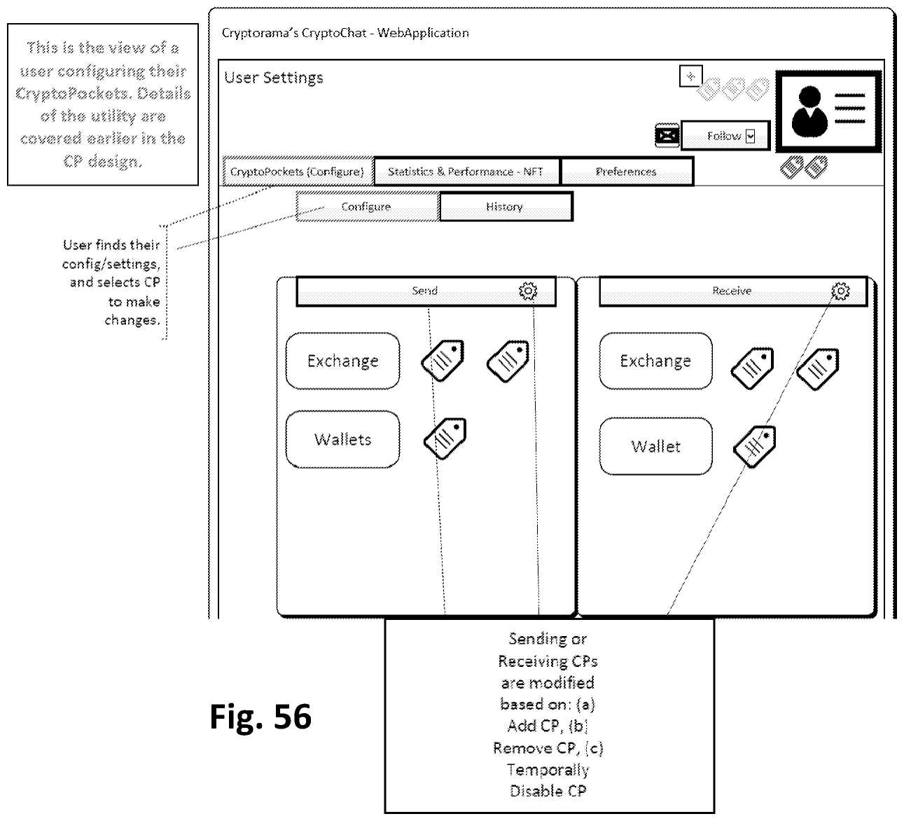

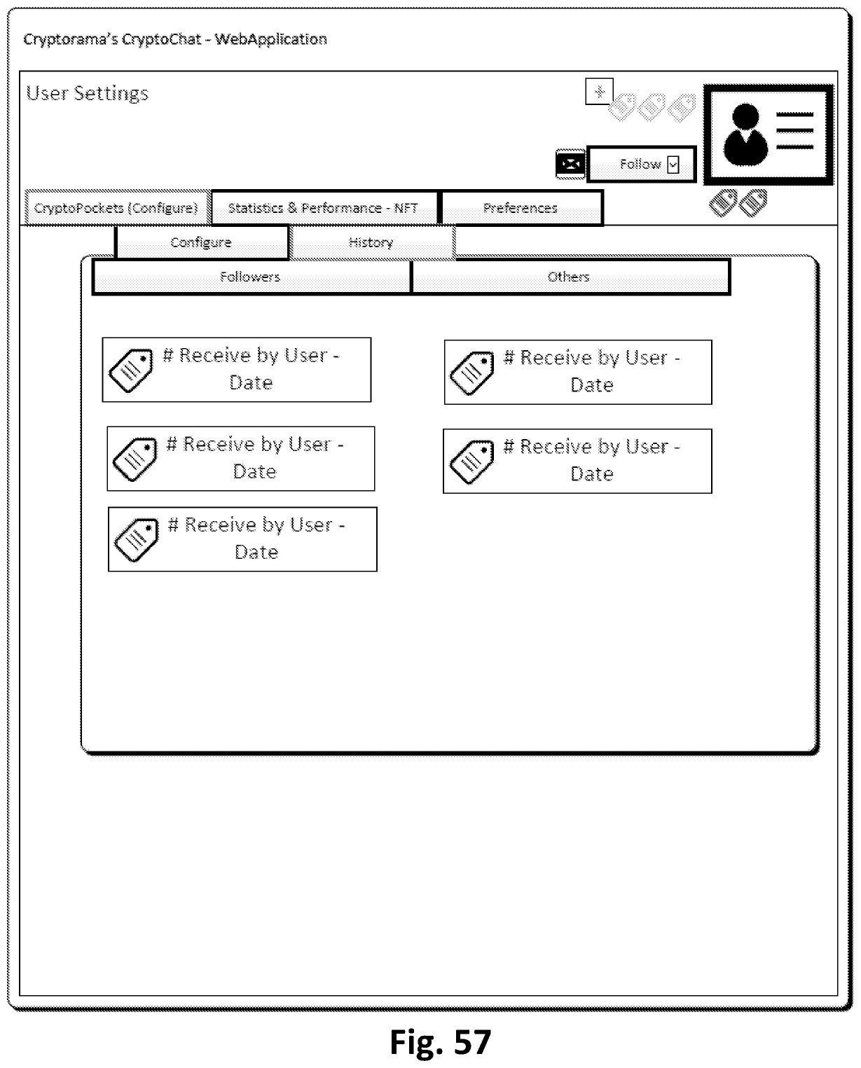

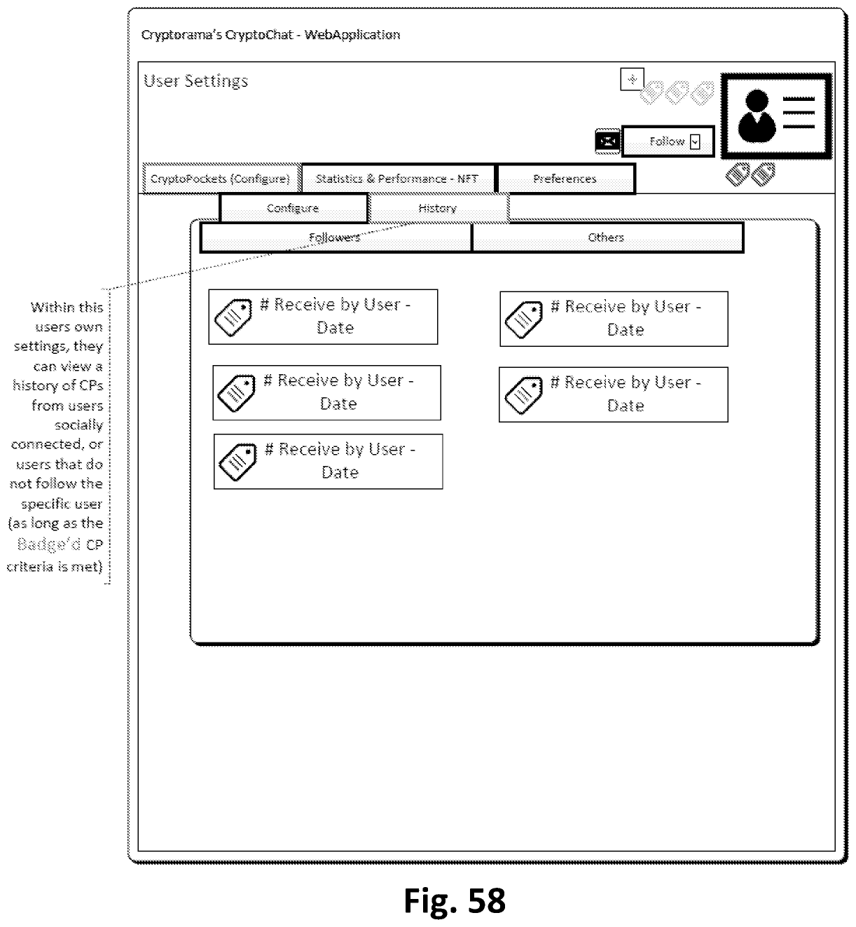

FIGS. 28-58 illustrate exemplary embodiments of graphical user interfaces and schematic depictions of the exemplary disclosed system and method.

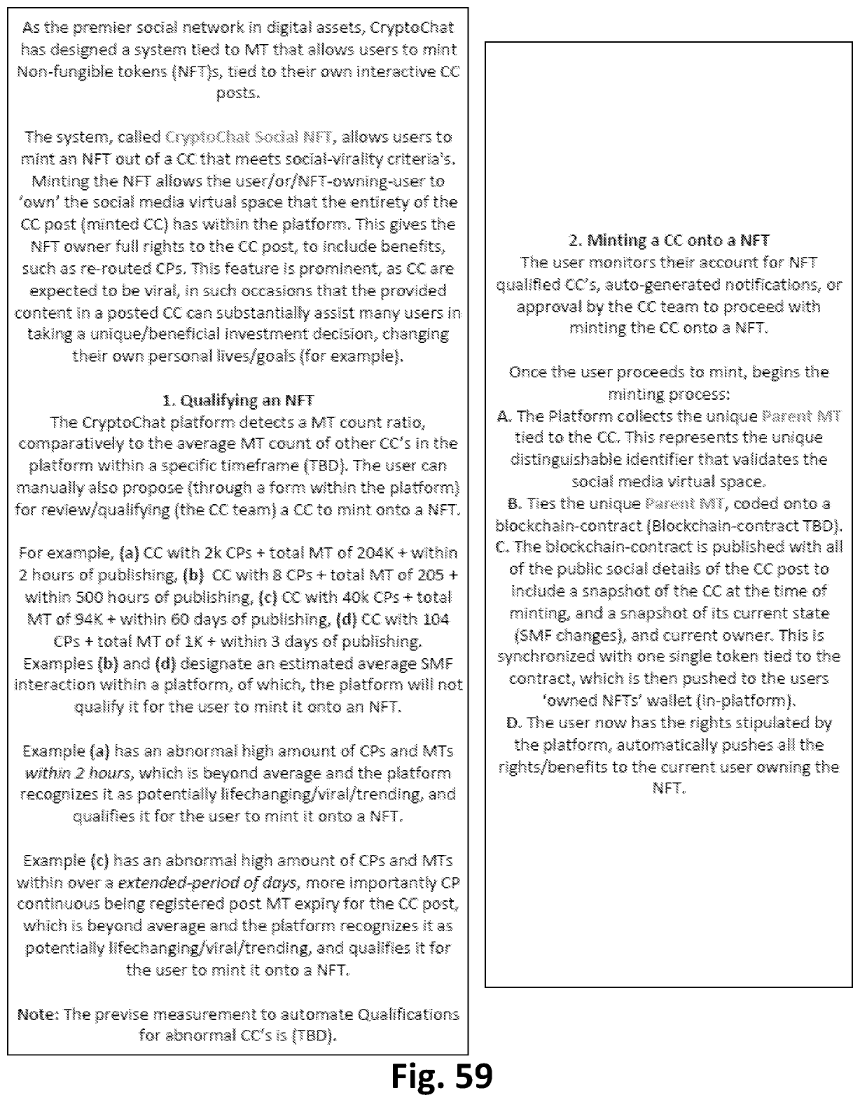

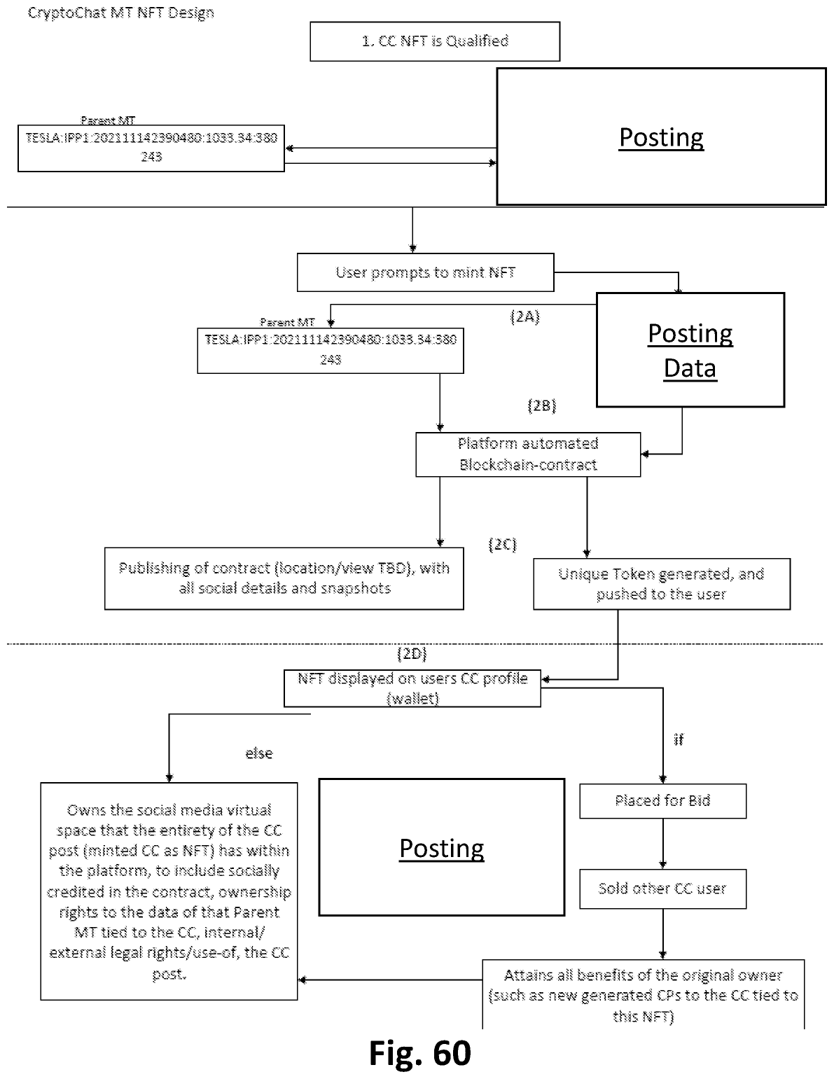

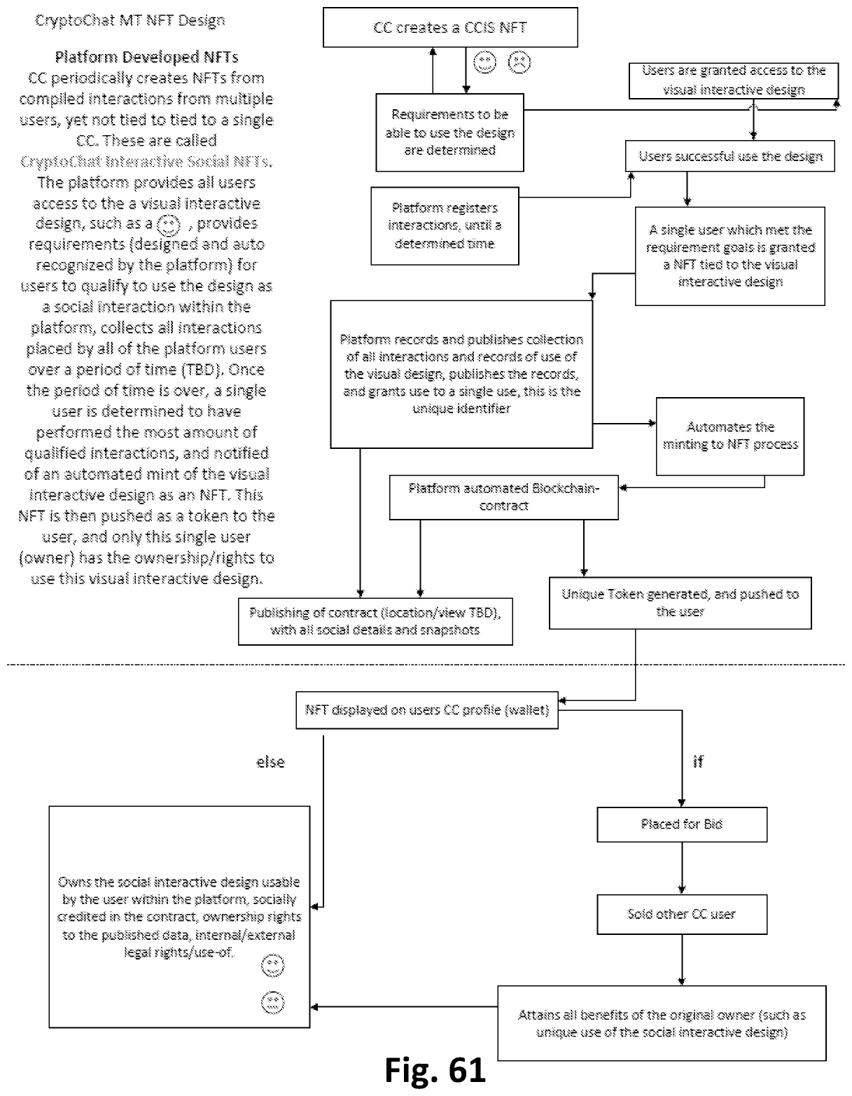

In at least some exemplary embodiments and as illustrated in FIGS. 59-61, the exemplary disclosed system and method may allow users to mint non-fungible tokens (NFT) that may be tied to their own interactive CC posts. The feature (e.g., CryptoChat Social NFT) may allow users to mint an NFT out of a CC (e.g., CC post) that meets social-virality criteria. Minting the NFT may allow the user and/or NFT-owning-user to ‘own’ the social media virtual space that the entirety of the CC post (e.g., CC minted as an NFT) has within the platform. This may give the NFT owner rights (e.g., substantially full rights) to the CC post, to include benefits such as re-routed CPs. For example if a CC is viral (e.g., goes viral), the provided content in the posted CC may substantially assist many users in making a unique and beneficial investment, which may change personal lives and/or goals of the users.

As illustrated in FIGS. 59-61, the exemplary disclosed system and method may qualify an NFT. The CryptoChat platform may detect a MT count ratio, for example relative (e.g., comparatively) to the average MT count of other CCs in the platform within a specific timeframe. The user may also manually also propose (e.g., through a form within the platform for example to a CC team) reviewing or qualifying a CC to mint onto a NFT. For example, the following may be minted: (a) CC with 2k CPs+total MT of 204K+within 2 hours of publishing, (b) CC with 8 CPs+total MT of 205+within 500 hours of publishing, (c) CC with 40k CPs+total MT of 94K +within 60 days of publishing, or (d) CC with 104 CPs+total MT of 1K+within 3 days of publishing. Examples (b) and (d) may designate an estimated average SMF interaction within the system, of which the system may not qualify the CC for the user to mint it onto an NFT. Example (a) may have an abnormally high amount of CPs and MTs within 2 hours, which is beyond average, and the platform may recognize it as significant (e.g., potentially life-changing, viral, and/or trending), and may qualify it for the user to mint onto a NFT. Example (c) may have a high (e.g., an abnormally high) amount of CPs and MTs over an extended period of days (e.g., CP continuous being registered post MT expiry for the CC post), which may be beyond average and the platform recognizes it as significant (e.g., potentially life-changing, viral, and/or trending), and may qualify it for the user to mint onto a NFT.

Also as illustrated in FIGS. 59-61, the exemplary disclosed system and method may mint a CC (e.g., a qualified CC) onto an NFT. Users may monitor their accounts for NFT-qualified CCs, auto-generated notifications, and/or approval (e.g., by a CC team of operators of the system) to proceed with minting a CC onto an NFT. The minting process may begin with the system collecting a unique Parent MT tied to the CC. This may represent a unique distinguishable identifier that may validate the social media virtual space. The exemplary disclosed system and method may tie (e.g., tie to) the unique Parent MT, which may be coded onto any suitable blockchain-contract. The blockchain-contract may be published with some or substantially all of the public social details of a CC post, which may include a snapshot of the CC at the time of minting, a snapshot of its current state (SMF changes), and data of the current owner. This step may be synchronized with one single token tied to the contract, which may then be pushed to a user's “owned NFTs” wallet (e.g., in-platform). The user may at that point possess ownership rights stipulated by the platform of the system (e.g., based on a user agreement), and the exemplary disclosed system and method may automatically push some or substantially all associated rights and benefits to the current user owning the NFT.

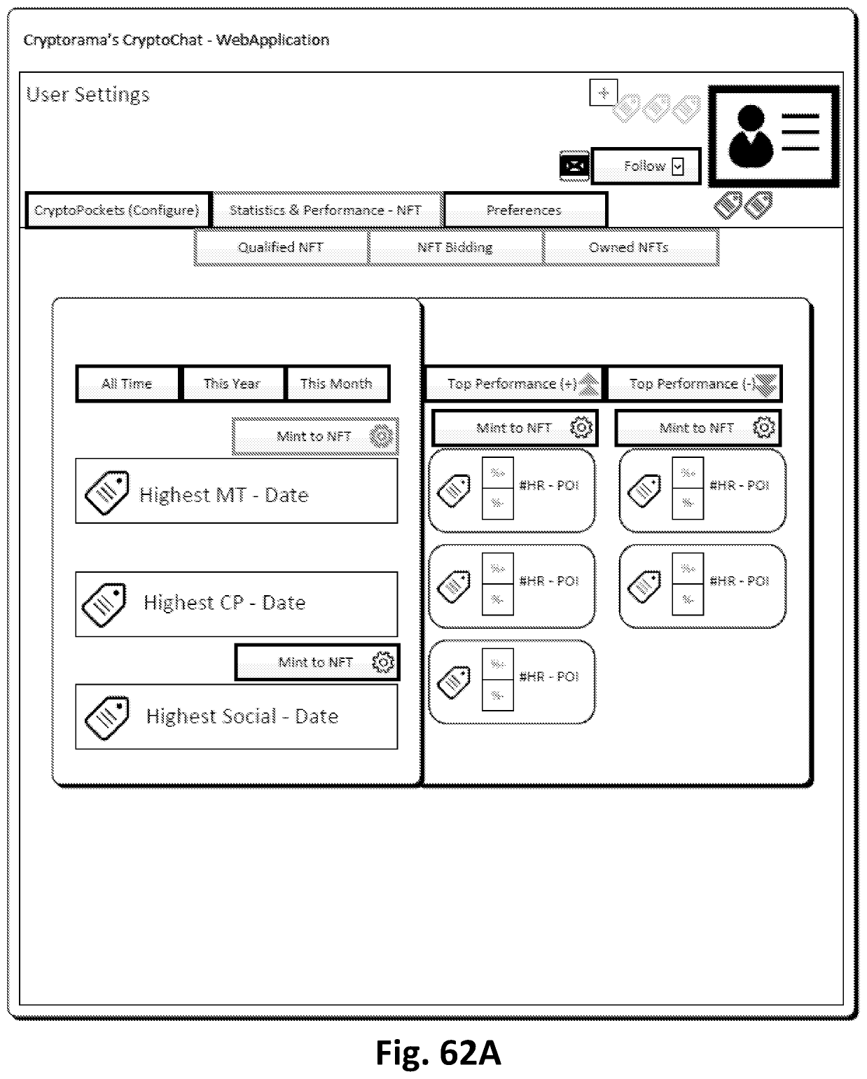

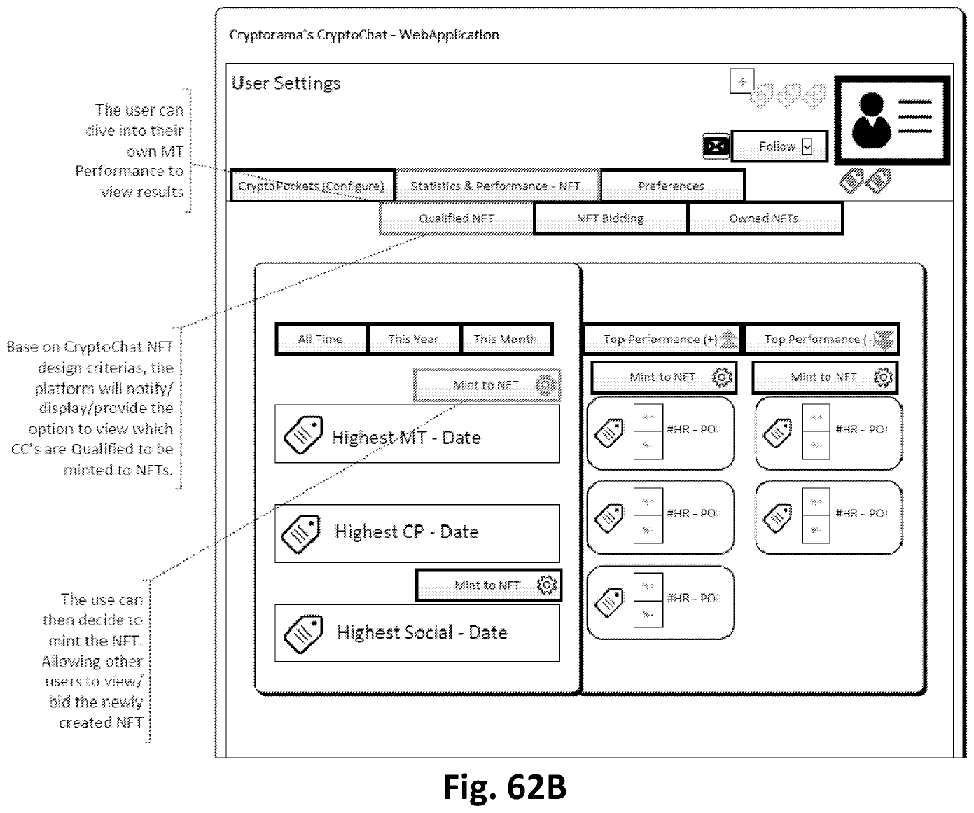

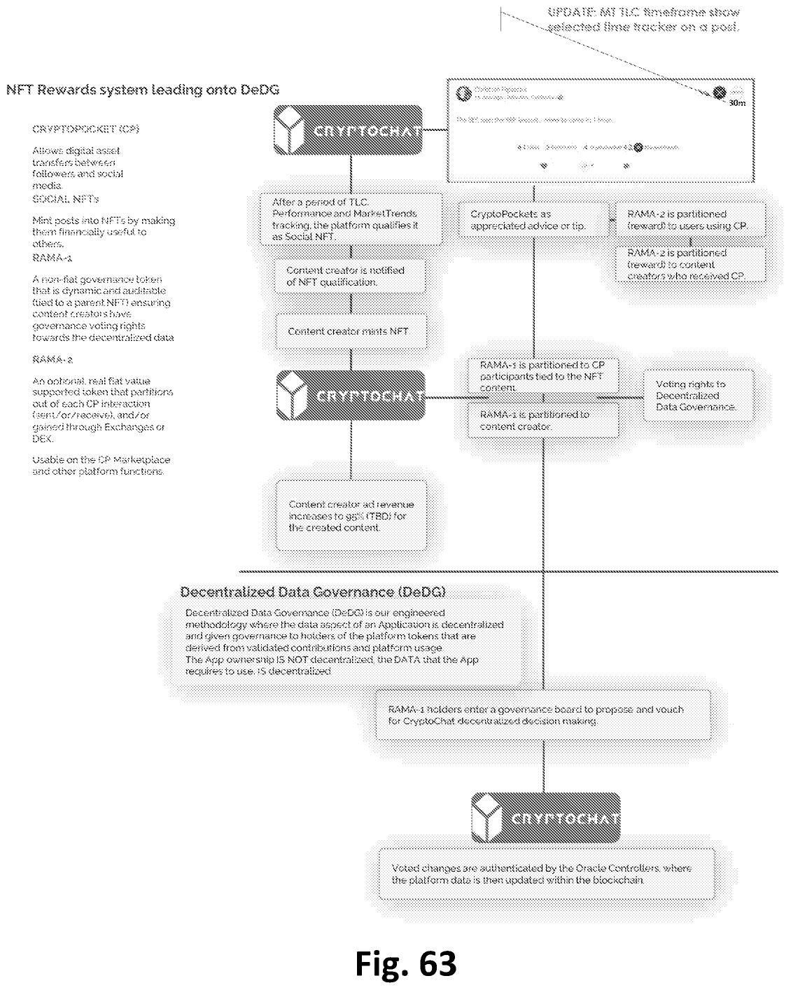

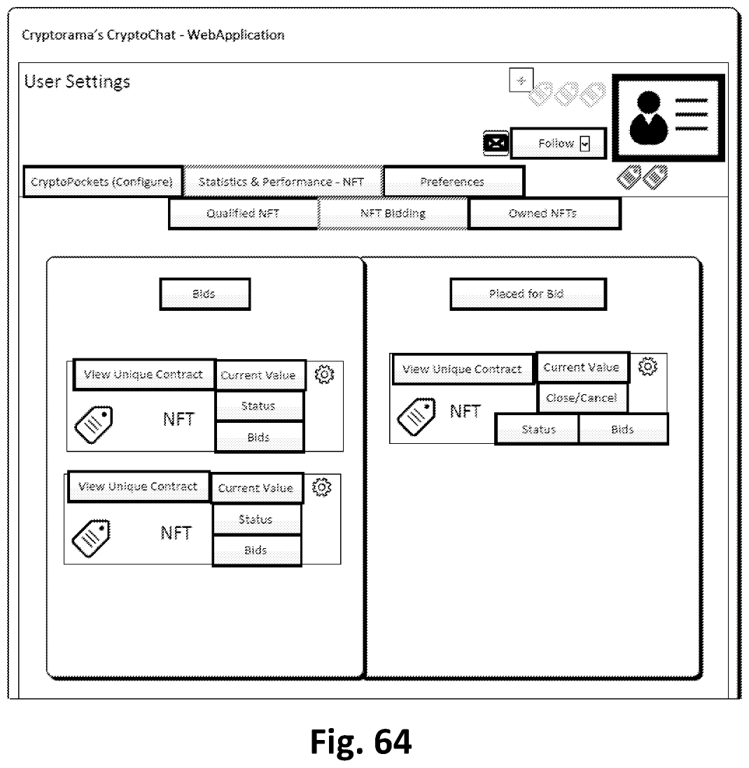

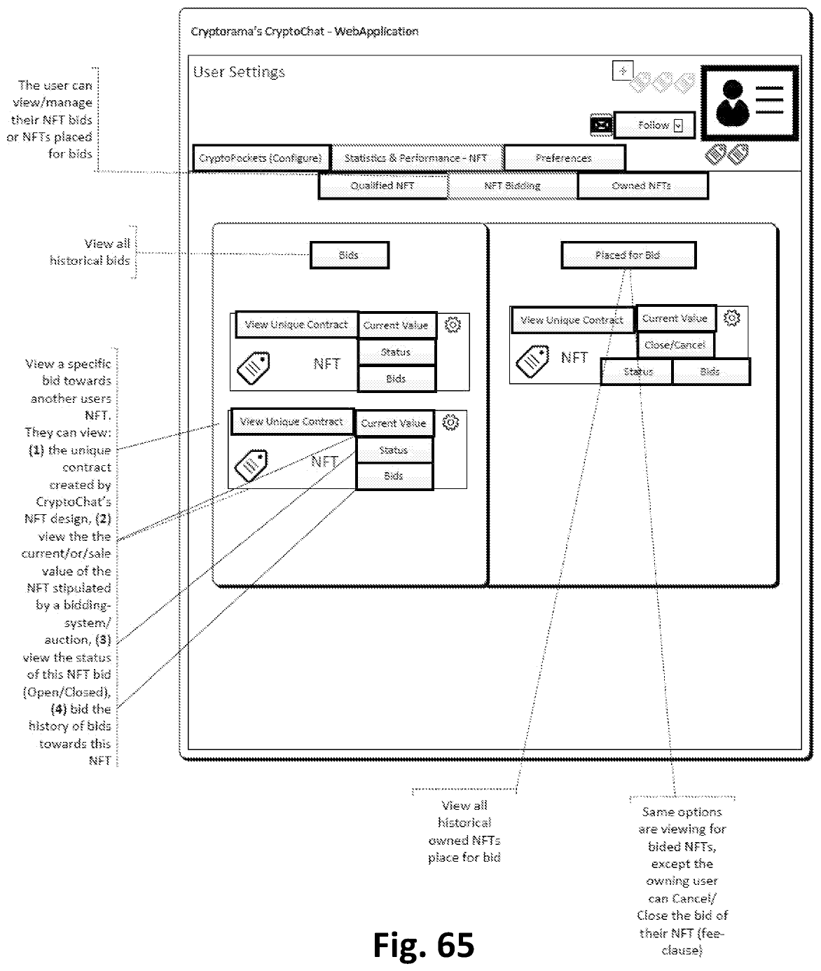

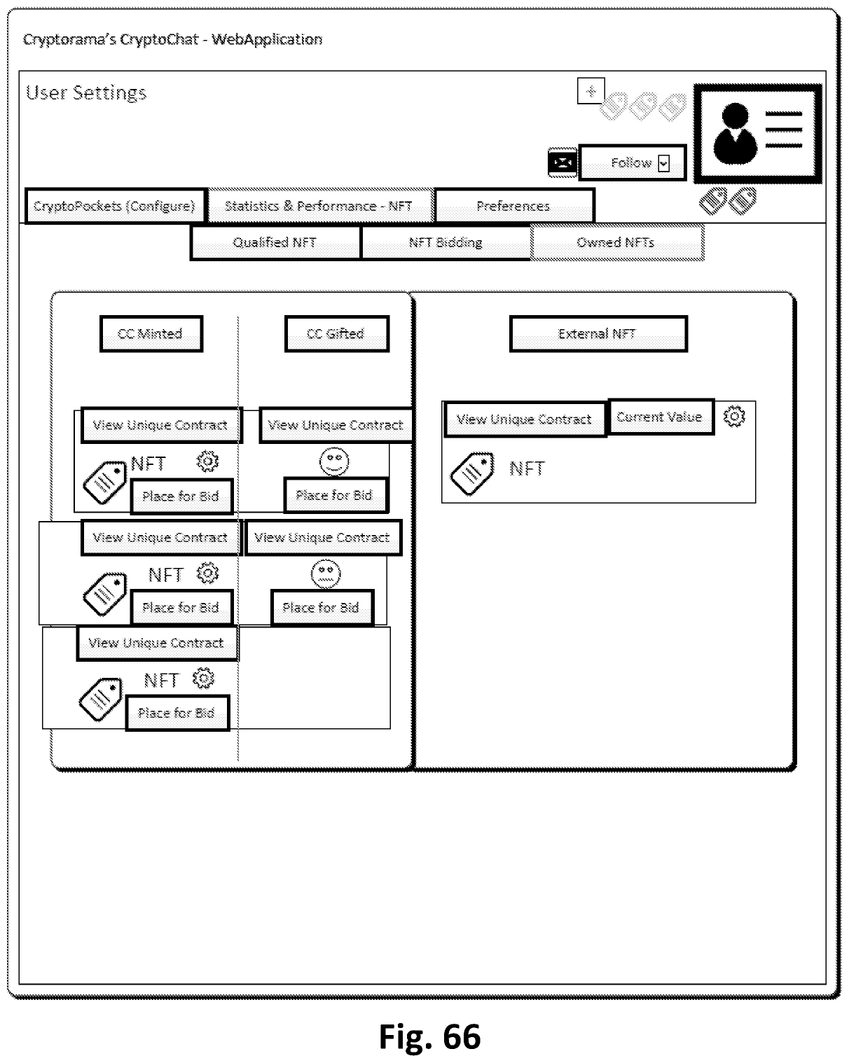

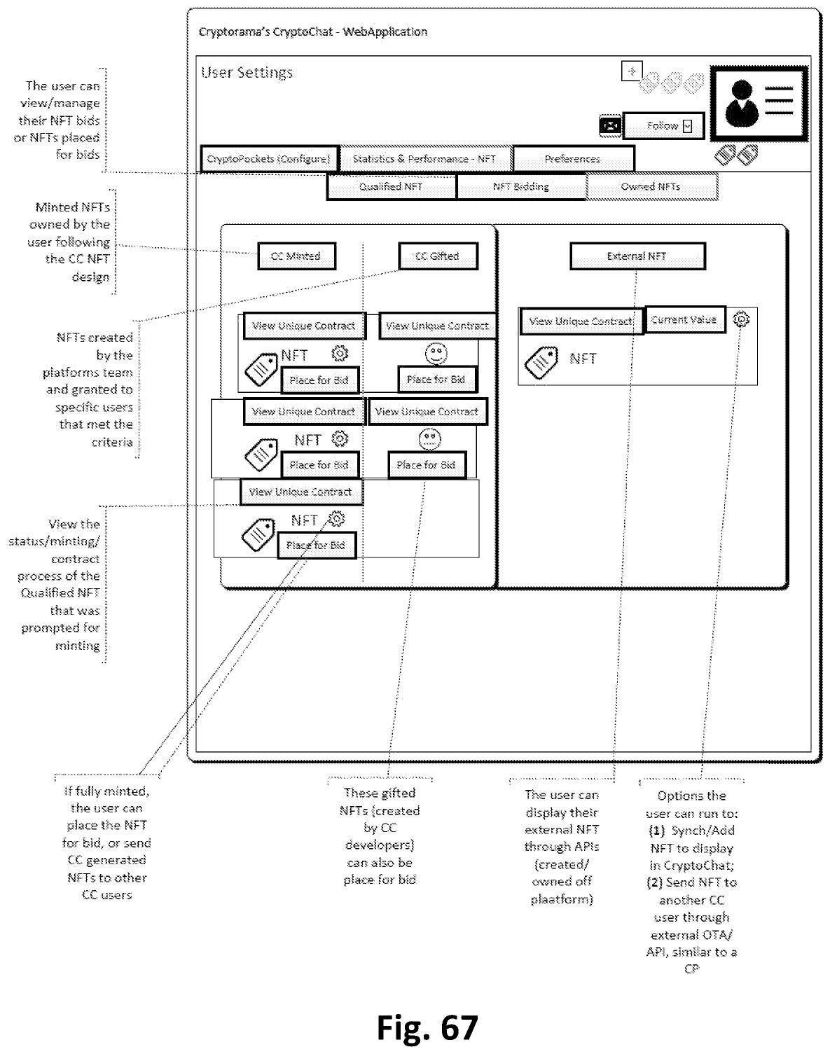

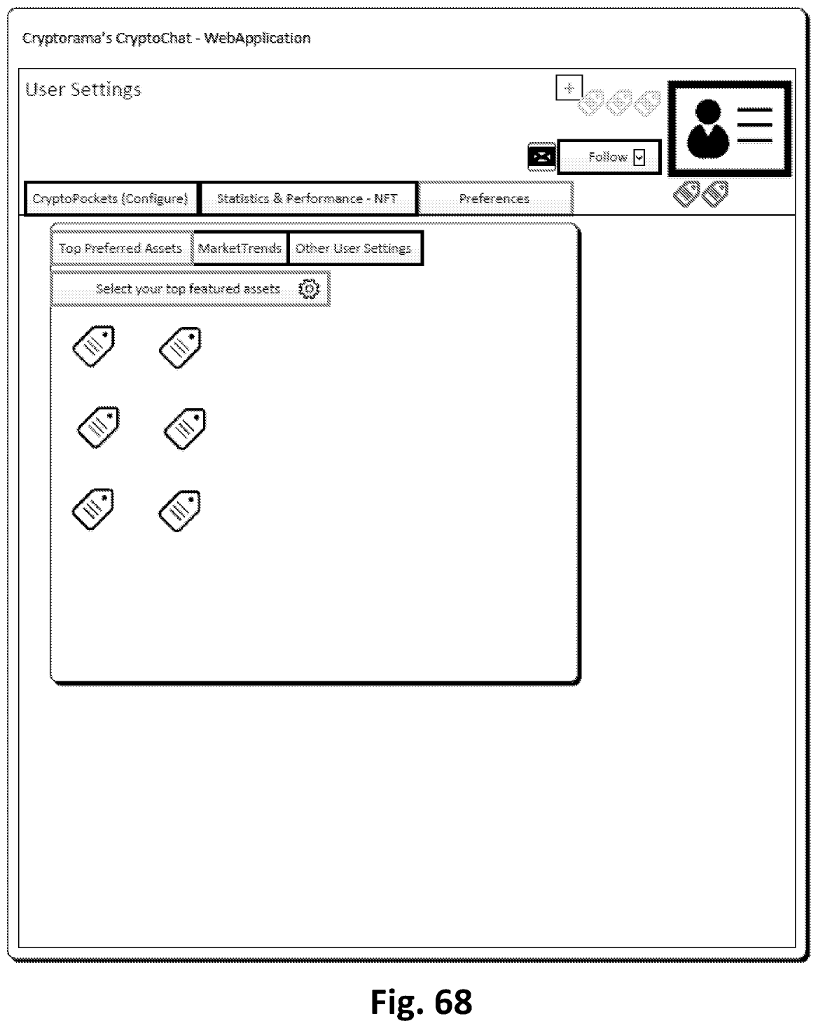

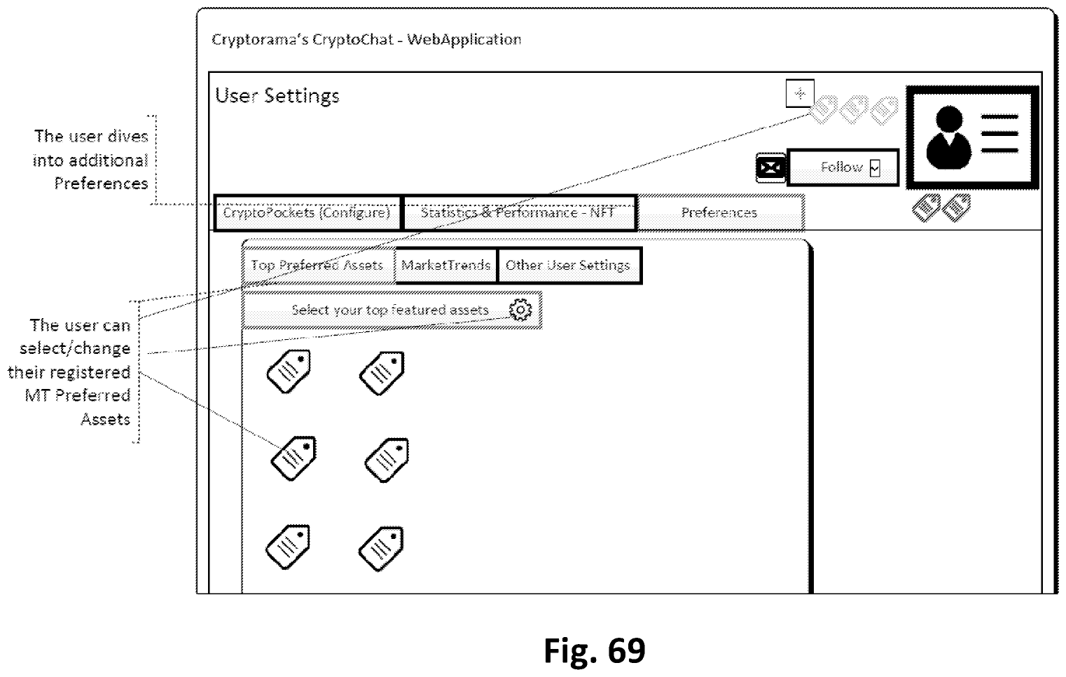

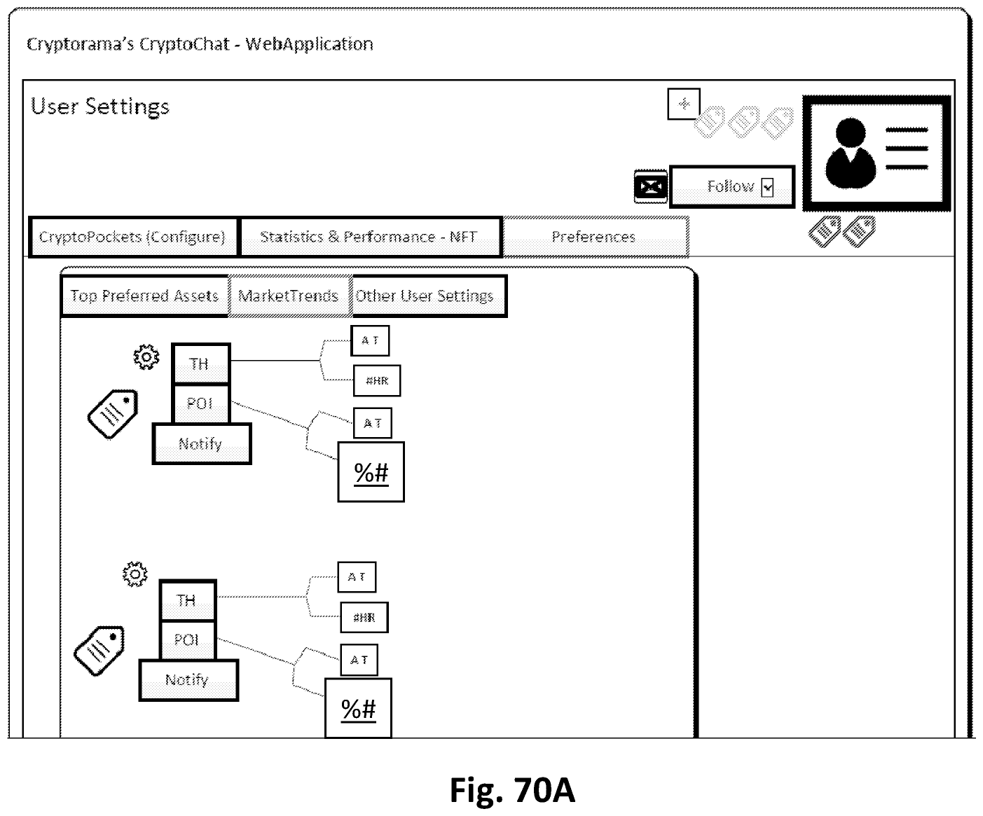

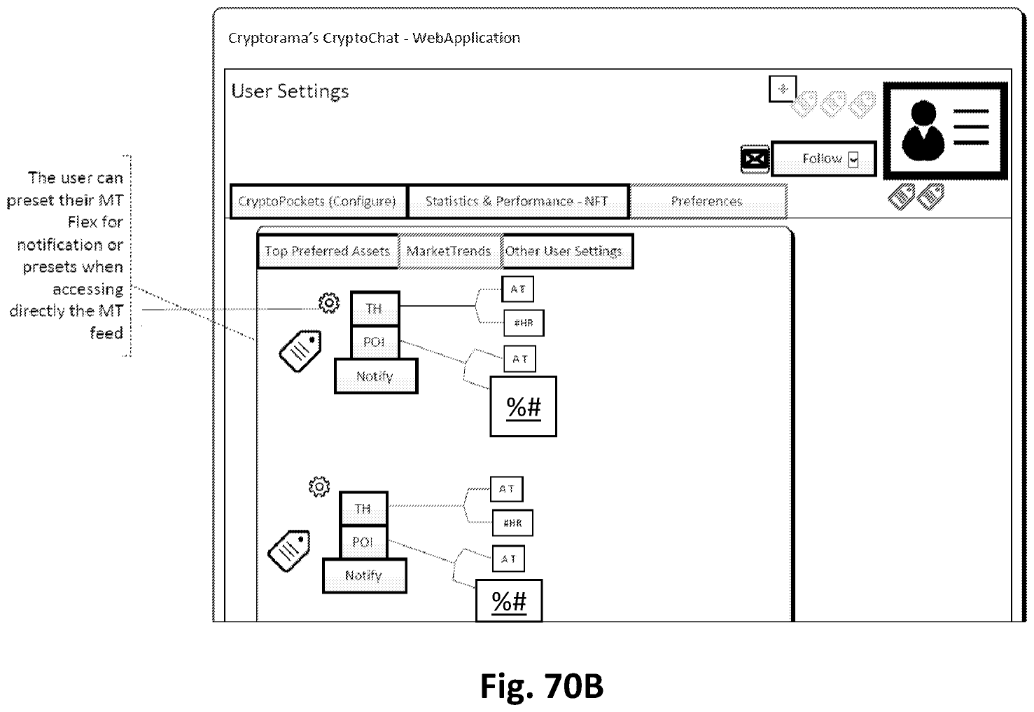

FIGS. 62A, 62B, and 64-69, 70A and 70B illustrate exemplary embodiments of graphical user interfaces of the exemplary disclosed system and method. FIG. 63 illustrates an exemplary reward system that may be associated with the exemplary disclosed graphical user interfaces.

In least some exemplary embodiments, the exemplary disclosed system and method (e.g., including CryptoChat or CC) may provide social media interactions using a MarketTrends Asset (e.g., eTrade Assets or Investments).

In least some exemplary embodiments, the exemplary disclosed system and method (e.g., including MarketTrends or MT) may provide a comprehensive algorithm tied to eTrade Assets or Investments, which may generate various utilities to enhance user experience, investment decisions, and/or social alignments to a user's investments (e.g., interests). The exemplary disclosed system and method may provide a unique social media feed tied between social interactions and eTrade Assets or Investments.

In least some exemplary embodiments, the exemplary disclosed system and method (e.g., including MarketTrends Performance) may provide a distinctive technique for socially validating whether the social-to-investment data (e.g., information) a user is providing is valid (e.g., “trustable”) based on previous CC public posts by that user.

In least some exemplary embodiments, the exemplary disclosed system and method (e.g., including CryptoPockets) may provide a technique to socially “hand over” digital assets toward a user within the platform (a user's pocket). For example, an exemplary disclosed CP may provide a deposit onto a Public portion of a given user's wallet (e.g., Direct Layer 1 Public Key or Layer 2 Networks Public Keys). Such a process may popularize the platform of the exemplary disclosed system as a utility to socially provide (e.g., perform) digital assets deposits between “followers,” or special accounts (e.g., but may not be strictly tied to a single digital asset, blockchain network, or Exchange). This utility function may be for any suitable digital asset.

In least some exemplary embodiments, the exemplary disclosed system and method (e.g., including CryptoChat Social NFT) may provide users with a technique to mint a non-fungible token (NFT) out of a CC that may meets social-virality criteria. The system minting of the NFT may allow the user or NFT-owning-user to “own” a social media virtual space (e.g., that some or substantially the entirety of the CC post, for example a minted CC) has within the exemplary disclosed platform of the system, which may include information of an extent to which a CC has socially changed decisions and/or goals of other users.

In least some exemplary embodiments, the exemplary disclosed system and method (e.g., including CryptoChat Interactive Social NFT) may periodically (e.g., at any suitable time or frequency) create NFTs from compiled interactions from multiple users (e.g., but may not be tied to a single CC). The exemplary disclosed platform may provide some or all users access to a visual interactive design, provide criteria (e.g., designed and auto recognized by the platform) for users to qualify to use the design as a social interaction within the platform, and/or collect data of some or substantially all interactions placed by some or substantially all of the platform users over any suitable period of time (e.g., with the goal of granting unique ownership of a visual interactive design to a single user through a minted NFT).

In least some exemplary embodiments, the exemplary disclosed system and method (e.g., including CryptoChat or CC) may provide functions including social media posts. The exemplary disclosed system and method may work in correlation with MT to provide an eTrade Investment or Asset of choice, while allowing the user to choose other utilities (e.g., MT utilities), in order to create and provide a unique social interaction. These selections may allow for automatic social alignment of users with their own investments and/or interested investments. The platform of the exemplary disclosed system may also provide an MT Performance feature or utility for potential content creators or for users who value their public interactions. For example, such a feature or utility may be used by users who may follow other users and who use precision when deciding on users and/or posts (e.g., socially aligning their use of the system with their own investments and/or interested investments). The exemplary disclosed system and method may thereby provide factors (e.g., a deciding factor) to other users to follow a specific user having a desired performance value.

In least some exemplary embodiments, the exemplary disclosed system and method may be used for utilizing image data of a picture and/or video (e.g., Instagram), sending image data of a picture and/or video (e.g., with limited viewing such as SnapChat), interacting with image data of a preset audio and/or video (e.g., TikTok), and/or utilizing data of a professional workforce profile (e.g., LinkedIn). The exemplary disclosed system and method may also provide a plurality of techniques for applying the exemplary disclosed utilities or features (e.g., CryptoPockets) through different layers of transactions (e.g., not merely a single network or a single third party provider).

In least some exemplary embodiments, the exemplary disclosed system may include an investment data module, comprising computer-executable code stored in non-volatile memory, a processor, and a user device. The investment data module, the processor, and the user device may be configured to receive an asset data of a user, the asset data including an identification of an investment asset, receive a time data of the user, the time data including a time period, receive an asset prediction data of the user, the asset prediction data including an asset prediction of whether the investment asset will increase in value or decrease in value between a start of the time period and an end of the time period, receive an actual asset data including a first actual asset value of the investment asset at the start of the time period and a second actual asset value of the investment asset at the end of the time period, and determine and assign a performance data to the user based on comparing the asset prediction data and the actual asset data. The investment data module, the processor, and the user device may be further configured to display a timer on a posting of the user displayed on a graphical user interface of the user device between the start of the time period and the end of the time period, and remove the timer from the posting when the time period elapses. The investment data module, the processor, and the user device may be further configured to display the asset prediction and a percentage relating the asset prediction to the second actual asset value on a posting of the user displayed on a graphical user interface for an entire lifetime of the posting when the time period elapses. The investment data module, the processor, and the user device may be further configured to display the asset prediction and a percentage relating the asset prediction to a real-time actual asset value of the investment asset on a posting of the user displayed on a graphical user interface during the time period. Determining the performance data based on comparing the asset prediction data and the actual asset data may include comparing a predicted amount of increase or decrease of value of the investment asset with the second actual asset value of the investment asset at the end of the time period. The investment data module, the processor, and the user device may be further configured to provide a performance value of the user to other users of a platform, the performance value based on a plurality of performance data. The investment data module, the processor, and the user device may be further configured to display a posting of the user on a graphical user interface of the user device, the posting displaying the asset prediction. The investment data module, the processor, and the user device may be further configured to mint the posting onto a non-fungible token having ownership assigned to the user based on the performance data meeting a predetermined criteria. The ownership may be assigned based on a unique distinguishable identifier of the posting being coded onto a blockchain. The investment data module, the processor, and the user device may be further configured to mint the posting onto a non-fungible token having ownership assigned to the user based on an amount of interaction with the posting by other users of a platform on which the user posted the posting.

In least some exemplary embodiments, the exemplary disclosed method may include receiving an asset data of a user, the asset data including an identification of an investment asset, receiving a time data of the user, the time data including a time period, receiving an asset prediction data of the user, the asset prediction data including an asset prediction of whether the investment asset will increase in value or decrease in value between a start of the time period and an end of the time period, receiving an actual asset data including a first actual asset value of the investment asset at the start of the time period and a second actual asset value of the investment asset at the end of the time period, and determining and assigning a performance data to the user based on comparing the asset prediction data and the actual asset data. The exemplary disclosed method may also include displaying the asset prediction and a real-time percentage relating the asset prediction to a real-time actual asset value of the investment asset on a posting of the user displayed on a graphical user interface of a user device during the time period, and displaying the asset prediction and a final percentage relating the asset prediction to the second actual asset value on the posting of the user displayed on the graphical user interface for an entire lifetime of the posting when the time period elapses. The exemplary disclosed method may further include displaying a timer on a posting of the user displayed on a graphical user interface of a user device between the start of the time period and the end of the time period, and removing the timer from the posting when the time period elapses. Determining the performance data based on comparing the asset prediction data and the actual asset data may include comparing a predicted amount of increase or decrease of value of the investment asset with the second actual asset value of the investment asset at the end of the time period. The exemplary disclosed method may also include providing a performance value of the user to other users of a platform, the performance value based on a plurality of performance data. The exemplary disclosed method may further include displaying a posting of the user on a graphical user interface of a user device, the posting displaying the asset prediction, and minting the posting onto a non-fungible token having ownership assigned to the user based on the performance data meeting a predetermined criteria. The exemplary disclosed method may also include displaying a posting of the user on a graphical user interface of a user device, the posting displaying the asset prediction, and minting the posting onto a non-fungible token having ownership assigned to the user based on an amount of interaction with the posting by other users of a platform on which the user posted the posting.

In least some exemplary embodiments, the exemplary disclosed system may include an investment data module, comprising computer-executable code stored in non-volatile memory, a processor, and a user device. The investment data module, the processor, and the user device may be configured to receive an asset data of a user, the asset data including an identification of an investment asset, receive a time data of the user, the time data including a time period, receive an asset prediction data of the user, the asset prediction data including an asset prediction of whether the investment asset will increase in value or decrease in value between a start of the time period and an end of the time period, receive an actual asset data including a first actual asset value of the investment asset at the start of the time period and a second actual asset value of the investment asset at the end of the time period, and determine and assign a performance data to the user based on comparing the asset prediction data and the actual asset data. The investment data module, the processor, and the user device may also be configured to display a posting of the user on a graphical user interface of the user device, the posting displaying the asset prediction, and mint the posting onto a non-fungible token having ownership assigned to the user based on at least one of the performance data meeting a first predetermined criteria or an amount of interaction with the posting by other users of a platform on which the user posted the posting meeting a second predetermined criteria. The first predetermined criteria may be a percentage relating the asset prediction to the second actual asset value, and the second predetermined criteria may be a number of views by the other users of the platform. The investment data module, the processor, and the user device may be further configured to display the asset prediction and a real-time percentage relating the asset prediction to a real-time actual asset value of the investment asset on the posting of the user displayed on the graphical user interface during the time period, and display the asset prediction and a final percentage relating the asset prediction to the second actual asset value on the posting of the user displayed on the graphical user interface for an entire lifetime of the posting when the time period elapses.

The exemplary disclosed system and method may be used in any suitable application for using and/or managing investment data. The exemplary disclosed system and method may be used in any suitable application for investment data management such as, for example, retail investment data management.

The exemplary disclosed system and method may provide an efficient and effective technique for managing investment data. For example, the exemplary disclosed system and method may substantially prevent investors from being overwhelmed due to the significant amount of information involved with investment and may allow investors to manage this information.

An illustrative representation of a computing device appropriate for use with embodiments of the system of the present disclosure is shown in FIG. 71. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms.

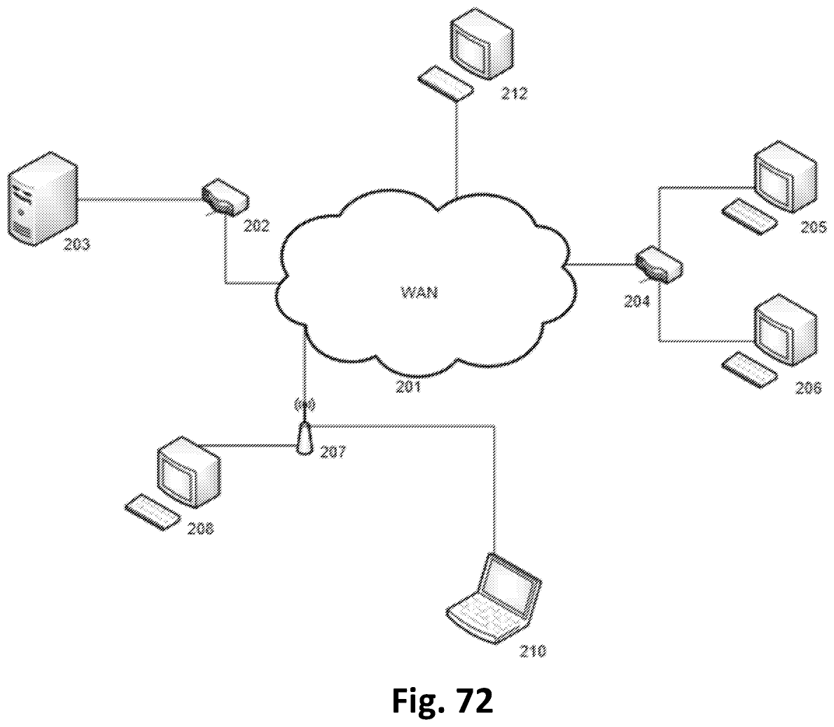

Various examples of such general-purpose multi-unit computer networks suitable for embodiments of the disclosure, their typical configuration and many standardized communication links are well known to one skilled in the art, as explained in more detail and illustrated by FIG. 72, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 72, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 72, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device via a wireless connection (e.g., CDMA, GMS, 3G, 4G, 5G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

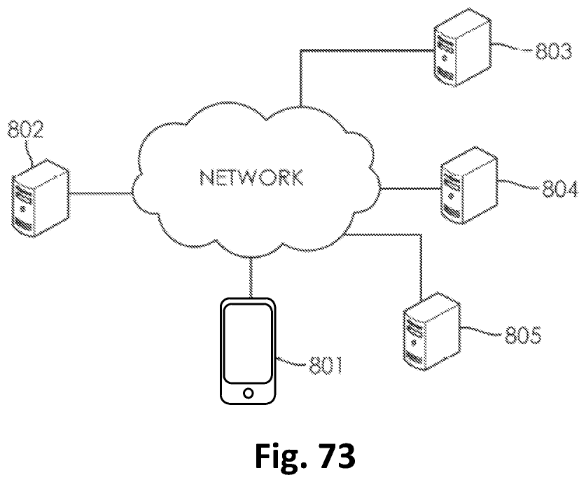

Turning now to FIG. 73, a continued schematic overview of a cloud-based system in accordance with an embodiment of the present invention is shown. In FIG. 73, the cloud-based system is shown as it may interact with users and other third party networks or APIs. For instance, a user of a mobile device 801 may be able to connect to application server 802. Application server 802 may be able to enhance or otherwise provide additional services to the user by requesting and receiving information from one or more of an external content provider API/website or other third party system 803, a constituent data service 804, one or more additional data services 805 or any combination thereof. Additionally, application server 802 may be able to enhance or otherwise provide additional services to an external content provider API/website or other third party system 803, a constituent data service 804, one or more additional data services 805 by providing information to those entities that is stored on a database that is connected to the application server 802. One of ordinary skill in the art would appreciate how accessing one or more third-party systems could augment the ability of the system described herein, and embodiments of the present invention are contemplated for use with any third-party system.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. The data store may also be a non-relational database. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

In at least some exemplary embodiments, the exemplary disclosed system may utilize sophisticated machine learning and/or artificial intelligence techniques to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary neural network may include a plurality of input nodes that may be interconnected and/or networked with a plurality of additional and/or other processing nodes to determine a predicted result. Exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. The exemplary disclosed system may utilize prediction algorithms and approach that may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on — any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

What is claimed is:

1. A system, comprising:
an investment data module, comprising computer-executable code stored in non-volatile memory;
a processor; and
a user device;
wherein the investment data module, the processor, and the user device are configured to:
receive an asset data of a user, the asset data including an identification of an investment asset;
receive a time data of the user, the time data including a time period;
receive an asset prediction data of the user, the asset prediction data including an asset prediction of whether the investment asset will increase in value or decrease in value between a start of the time period and an end of the time period;
receive an actual asset data including a first actual asset value of the investment asset at the start of the time period and a second actual asset value of the investment asset at the end of the time period; and
determine and assign a performance data to the user based on comparing the asset prediction data and the actual asset data.

2. The system of claim 1, wherein the investment data module, the processor, and the user device are further configured to display a timer on a posting of the user displayed on a graphical user interface of the user device between the start of the time period and the end of the time period, and remove the timer from the posting when the time period elapses.

3. The system of claim 1, wherein the investment data module, the processor, and the user device are further configured to display the asset prediction and a percentage relating the asset prediction to the second actual asset value on a posting of the user displayed on a graphical user interface for an entire lifetime of the posting when the time period elapses.

4. The system of claim 1, wherein the investment data module, the processor, and the user device are further configured to display the asset prediction and a percentage relating the asset prediction to a real-time actual asset value of the investment asset on a posting of the user displayed on a graphical user interface during the time period.

5. The system of claim 1, wherein determining the performance data based on comparing the asset prediction data and the actual asset data includes comparing a predicted amount of increase or decrease of value of the investment asset with the second actual asset value of the investment asset at the end of the time period.

6. The system of claim 1, wherein the investment data module, the processor, and the user device are further configured to provide a performance value of the user to other users of a platform, the performance value based on a plurality of performance data.

7. The system of claim 1, wherein the investment data module, the processor, and the user device are further configured to display a posting of the user on a graphical user interface of the user device, the posting displaying the asset prediction.

8. The system of claim 7, wherein the investment data module, the processor, and the user device are further configured to mint the posting onto a non-fungible token having ownership assigned to the user based on the performance data meeting a predetermined criteria.

9. The system of claim 8, wherein the ownership is assigned based on a unique distinguishable identifier of the posting being coded onto a blockchain.

10. The system of claim 7, wherein the investment data module, the processor, and the user device are further configured to mint the posting onto a non-fungible token having ownership assigned to the user based on an amount of interaction with the posting by other users of a platform on which the user posted the posting.

11. A method, comprising:
receiving an asset data of a user, the asset data including an identification of an investment asset;
receiving a time data of the user, the time data including a time period;
receiving an asset prediction data of the user, the asset prediction data including an asset prediction of whether the investment asset will increase in value or decrease in value between a start of the time period and an end of the time period;
receiving an actual asset data including a first actual asset value of the investment asset at the start of the time period and a second actual asset value of the investment asset at the end of the time period; and
determining and assigning a performance data to the user based on comparing the asset prediction data and the actual asset data.

12. The method of claim 11, further comprising:
displaying the asset prediction and a real-time percentage relating the asset prediction to a real-time actual asset value of the investment asset on a posting of the user displayed on a graphical user interface of a user device during the time period; and
displaying the asset prediction and a final percentage relating the asset prediction to the second actual asset value on the posting of the user displayed on the graphical user interface for an entire lifetime of the posting when the time period elapses.

13. The method of claim 11, further comprising displaying a timer on a posting of the user displayed on a graphical user interface of a user device between the start of the time period and the end of the time period, and removing the timer from the posting when the time period elapses.

14. The method of claim 11, wherein determining the performance data based on comparing the asset prediction data and the actual asset data includes comparing a predicted amount of increase or decrease of value of the investment asset with the second actual asset value of the investment asset at the end of the time period.

15. The method of claim 11, further comprising providing a performance value of the user to other users of a platform, the performance value based on a plurality of performance data.

16. The method of claim 11, further comprising:
displaying a posting of the user on a graphical user interface of a user device, the posting displaying the asset prediction; and
minting the posting onto a non-fungible token having ownership assigned to the user based on the performance data meeting a predetermined criteria.

17. The method of claim 11, further comprising:
displaying a posting of the user on a graphical user interface of a user device, the posting displaying the asset prediction; and
minting the posting onto a non-fungible token having ownership assigned to the user based on an amount of interaction with the posting by other users of a platform on which the user posted the posting.

18. A system, comprising:
an investment data module, comprising computer-executable code stored in non-volatile memory;
a processor; and
a user device;
wherein the investment data module, the processor, and the user device are configured to:
receive an asset data of a user, the asset data including an identification of an investment asset;
receive a time data of the user, the time data including a time period;
receive an asset prediction data of the user, the asset prediction data including an asset prediction of whether the investment asset will increase in value or decrease in value between a start of the time period and an end of the time period;
receive an actual asset data including a first actual asset value of the investment asset at the start of the time period and a second actual asset value of the investment asset at the end of the time period;
determine and assign a performance data to the user based on comparing the asset prediction data and the actual asset data;
display a posting of the user on a graphical user interface of the user device, the posting displaying the asset prediction; and
mint the posting onto a non-fungible token having ownership assigned to the user based on at least one of the performance data meeting a first predetermined criteria or an amount of interaction with the posting by other users of a platform on which the user posted the posting meeting a second predetermined criteria.

19. The system of claim 18, wherein the first predetermined criteria is a percentage relating the asset prediction to the second actual asset value, and the second predetermined criteria is a number of views by the other users of the platform.

20. The system of claim 18, wherein the investment data module, the processor, and the user device are further configured to:
display the asset prediction and a real-time percentage relating the asset prediction to a real-time actual asset value of the investment asset on the posting of the user displayed on the graphical user interface during the time period; and
display the asset prediction and a final percentage relating the asset prediction to the second actual asset value on the posting of the user displayed on the graphical user interface for an entire lifetime of the posting when the time period elapses.
